(19) United States
(12) Patent Application Publication
(10) Pub. No.: US 2010/0114790 A1
(43) Pub. Date: May 6, 2010

(54) System and Method for Aggregating Delivery of Goods or Services

(76) Inventors: Jon Strimling, Bedford, NH (US); Mark MacLean, Andover, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 12/608,488

(22) Filed: Oct. 29, 2009

Related U.S. Application Data
(60) Provisional application No. 61/109,282, filed on Oct. 29, 2008.

(51) Int. Cl. G06Q 10/00

(52) U.S. Cl. 705/330

(57) ABSTRACT

A system and method for aggregating delivery of goods or services may be implemented using an aggregate delivery coordination system accessed through a computer network by users interested in participating in pooling activities. The coordination system receives inputs from users interested in participating and presents pooling activity information to the users in response to the user inputs. The coordination system also coordinates pooling activities between respective groups of the users to establish pooling activity delivery options aggregating delivery of goods or services for the respective groups. The coordination system further notifies the groups of users of completed pooling activities and the delivery options established for those groups.

### CROSS-REFERENCE TO RELATED APPLICATIONS

This application claims the benefit of the filing date of co-pending U.S. Provisional Patent Application Ser. No. 61/109,282, filed on Oct. 29, 2008, the teachings of which are fully incorporated herein by reference.

### TECHNICAL FIELD

The present invention relates to delivery of goods or services, and to a system and method for aggregating delivery of the goods or services.

### BACKGROUND

In the distribution of goods and services, multi-channel distribution networks may be established. A multi-channel distribution network may provide multiple channels for distribution from a producer to a consumer. Separate distribution channels may, for example, extend through local distributors, retailers, packaging contractors, etc. The cost of delivery of the goods or services through the respective channels in the multi-channel distribution network may vary, thereby resulting in a cost to the consumer that varies depending on the distribution channel through which the goods or services are purchased. Likewise, the revenue obtained through sale of goods or services may vary depending in a multi-channel distribution network, depending on the delivery channel to the consumer.

One disadvantage of known systems is a lack of systemic visibility. Consumers may not be able to obtain visibility into supply sources upstream of their local retailer (e.g. other distribution intermediaries and producers), and producers and distribution intermediaries may not have visibility into demand downstream of their retail affiliates. Another disadvantage of known systems are limitations in responding to local needs, where a host of products and services may be available on a nationwide basis, but consumers, producers and distribution intermediaries may not have visibility to the most appropriate local options for addressing their needs.

### BRIEF DESCRIPTION OF THE DRAWINGS

These and other features and advantages will be better understood by reading the following detailed description, taken together with the drawings wherein:

FIG. 1 is a diagrammatic view of an exemplary system consistent with the present disclosure;

FIG. 2 is a diagrammatic view of another exemplary system consistent the present disclosure;

FIG. 3 diagrammatically illustrates one system and method consistent with the present disclosure for facilitating consumer purchase of goods or services in a multi-channel distribution network consistent with the present disclosure;

FIG. 4 diagrammatically illustrates one system and method consistent with the present disclosure for facilitating producer sale of goods or services in a multi-channel distribution network consistent with the present disclosure;

FIG. 5 diagrammatically illustrates one system and method consistent with the present disclosure for facilitating distribution intermediary sale of goods or services in a multi-channel distribution network consistent with the present disclosure;

FIG. 6 diagrammatically illustrates another system and method consistent with the present disclosure for facilitating consumer purchase of goods or services in a multi-channel distribution network consistent with the present disclosure;

FIG. 7 diagrammatically illustrates another system and method consistent with the present disclosure for facilitating producer sale of goods or services in a multi-channel distribution network consistent with the present disclosure;

FIG. 8 diagrammatically illustrates a system consistent with the present disclosure;

FIG. 9 is a screen shot of a portion of a consumer interface consistent with the present disclosure;

FIG. 10 is a screen shot of another portion of a consumer interface consistent with the present disclosure;

FIG. 11 is a screen shot of another portion of a consumer interface consistent with the present disclosure;

FIG. 12 is a screen shot of another portion of a consumer interface consistent with the present disclosure;

FIG. 13 is a screen shot of a portion of a distribution intermediary interface consistent with the present disclosure;

FIG. 14 is a screen shot of a portion of another distribution intermediary interface consistent with the present disclosure;

FIG. 15 is a screen shot of a portion of a producer interface consistent with the present disclosure;

FIG. 16 is a block flow diagram illustrating an exemplary consumer transaction consistent with the present disclosure;

FIG. 17 is a block flow diagram illustrating another exemplary consumer transaction consistent with the present disclosure;

FIG. 18 is a block flow diagram illustrating another exemplary consumer transaction consistent with the present disclosure;

FIG. 19 is a block flow diagram illustrating another exemplary consumer transaction consistent with the present disclosure;

FIG. 20 is a block flow diagram illustrating another exemplary consumer transaction consistent with the present disclosure;

FIGS. 21A, 21B and 21C illustrate an exemplary method involving regional minimum quantities and auto-acceptance quantities consistent with the present disclosure;

FIG. 22 is a block flow diagram illustrating another exemplary consumer transaction consistent with the present disclosure;

FIG. 23 is a block flow diagram illustrating another exemplary consumer transaction consistent with the present disclosure;

FIG. 24 is a block flow diagram illustrating another exemplary consumer transaction consistent with the present disclosure;

FIG. 25 is a block flow diagram illustrating another exemplary consumer transaction consistent with the present disclosure;

FIG. 26 is a block flow diagram illustrating an exemplary producer transaction consistent with the present disclosure;

FIG. 27 is a block flow diagram illustrating an exemplary distributor transaction consistent with the present disclosure;

FIG. 28 is a block flow diagram illustrating an exemplary consumer transaction consistent with the present disclosure involving a widget;

FIG. 29 is a block flow diagram illustrating another exemplary consumer transaction consistent with the present disclosure involving a widget;

FIG. 30 is a block flow diagram illustrating another exemplary consumer transaction consistent with the present disclosure involving a widget;

FIG. 31 is a block flow diagram illustrating an exemplary consumer transaction consistent with the present disclosure involving purchase of an product consuming device;

FIG. 32 is a block flow diagram illustrating another exemplary consumer transaction consistent with the present disclosure involving purchase of an product consuming device; and

FIG. 33 is a block flow diagram illustrating another exemplary consumer transaction consistent with the present disclosure involving purchase of a product consuming device.

FIG. 34 diagrammatically illustrates a pooled shipping site map, consistent with an embodiment of the present disclosure.

FIG. 35 is a screen shot of a consumer interface consistent with the present disclosure.

FIG. 36 is another screen shot of a consumer interface consistent with the present disclosure.

FIG. 37 is another screen shot of a consumer interface consistent with the present disclosure.

FIG. 38 is another screen shot of a consumer interface consistent with the present disclosure.

FIG. 39 is another screen shot of a consumer interface consistent with the present disclosure.

FIG. 40 is another screen shot of a consumer interface consistent with the present disclosure.

FIG. 41 is another screen shot of a consumer interface consistent with the present disclosure.

FIG. 42 is an illustration of an example of a screen flow consistent with the present disclosure.

FIG. 43 is a screen shot of a consumer interface for participating in a pooling activity.

FIG. 44 is a screen shot of a consumer interface for joining a truckload.

FIG. 45 is another screen shot of a consumer interface for joining a truckload.

FIG. 46 is yet another screen shot of a consumer interface for joining a truckload.

FIG. 47 is another screen shot of a consumer interface for joining a truckload.

FIG. 48 is a screen shot of a consumer interface for starting a truckload.

FIG. 49 is a screen shot of another consumer interface for starting a truckload.

FIG. 50 is a screen shot of yet another consumer interface for starting a truckload.

FIG. 51 is a screen shot of another consumer interface for starting a truckload.

FIG. 52 is a screen shot of yet another consumer interface for starting a truckload.

FIG. 53 is a screen shot of another consumer interface for starting a truckload.

FIG. 54 is a screen shot of yet another consumer interface for starting a truckload.

FIG. 55 is a screen shot of a consumer interface for managing a truck.

FIG. 56 is a screen shot of another consumer interface for managing a truck.

FIG. 57 is a screen shot of yet another consumer interface for managing a truck.

FIG. 58 is a screen shot of another consumer interface for managing a truck.

FIG. 59 is a screen shot of a consumer interface for managing a truck.

FIG. 60 is a screen shot of a consumer interface for establishing a new drop location.

FIG. 61 is a screen shot of another consumer interface for establishing a new drop location.

FIG. 62 is a screen shot of yet another consumer interface for establishing a new drop location.

FIG. 63 is a flow chart corresponding to an exemplary embodiment consistent with the present disclosure.

FIG. 64 is a screen shot of a consumer interface consistent with the present disclosure.

FIG. 65 is another screen shot of a consumer interface consistent with the present disclosure.

FIG. 66 is yet another screen shot of a consumer interface consistent with the present disclosure.

FIG. 67 is another screen shot of a consumer interface consistent with the present disclosure.

FIG. 68 is a screen shot of a consumer interface consistent with the present disclosure.

FIG. 69 is a screen shot of another consumer interface consistent with the present disclosure.

FIG. 70 is a screen shot of yet another consumer interface consistent with the present disclosure.

FIG. 71 is a screen shot of another consumer interface consistent with the present disclosure.

FIG. 72 is a screen shot of yet another consumer interface consistent with the present disclosure.

FIG. 73 is a screen shot of another consumer interface consistent with the present disclosure.

FIG. 74 is a screen shot of yet another consumer interface consistent with the present disclosure.

FIG. 75 is a screen shot of a consumer interface consistent with the present disclosure.

FIG. 76 is a screen shot of another consumer interface consistent with the present disclosure.

FIG. 77 is a screen shot of yet another consumer interface consistent with the present disclosure.

FIG. 78 is a screen shot of another consumer interface consistent with the present disclosure.

FIG. 79 is a screen shot of a consumer interface consistent with the present disclosure.

FIG. 80 is a flow chart of a method for aggregating delivery of goods or services.

### DETAILED DESCRIPTION

Aspects of the present disclosure may relate to facilitating business transactions in a multi-channel distribution network.

A “multi-channel distribution network” as used herein refers to a network including a plurality of at least partially separate channels of distribution from a producer of goods or services to a consumer. A distribution channel in a multi-channel distribution network may be at least partially separate from another distribution channel in the multi-channel distribution network if it includes at least one distribution intermediary not present in the other distribution channel. A “distribution intermediary” as used herein refers to a person or entity other than the producer or consumer that sells, distributes, or contracts for sale or distribution of goods or services in the multi-channel distribution network, and includes, for example, agents selling directly on behalf of a producer, packagers that package goods received from producers, distributors or wholesalers that sell to retailers, storage and handling locations, contract shipping entities, financial agents that agree to contracts to purchase and/or sell at a future date and retailers or dealers that sell to consumers. One or more channels in a multi-channel distribution network may be a multi-level channel. A “multi-level channel” as used herein refers to a distribution channel including at least two distribution intermediaries. A distribution network may be a “multi-level distribution network” if the distribution network includes sales to both end-consumers and redistributors, for example including both wholesale and retail sales.

For simplicity of explanation, the various exemplary embodiments disclosed herein may be described in the context of a multi-channel distribution network associated with specific goods. In particular, exemplary embodiments may be described in connection with goods, such as heating fuels, bulk landscaping products, building materials, etc., where delivery costs may be considered as a factor in the purchase decision, or where specialized equipment may be necessary for delivery of the product. It is to be understood, however, that the embodiments described herein are presented by way of illustration, not of limitation. For example, a system and method consistent with the present disclosure is not limited to any specific goods or distribution networks for distributing goods alone, and may be equally useful in connection with moving a service from a producer to consumer.

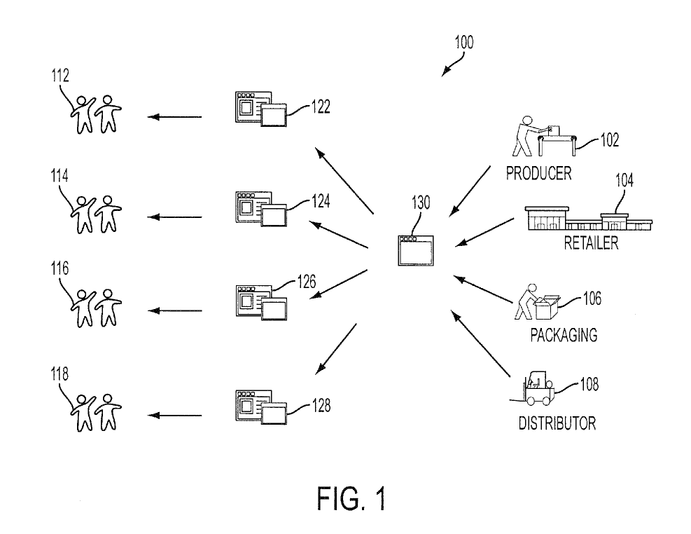

Referring to FIG. 1, a system facilitating transactions in a multi-channel distribution network 100 consistent with the present disclosure may connect a producers of goods and/or services 102 and/or distribution intermediaries such as retailers 104, packaging facilities 106, distributors 108, etc., with consumers 112, 114, 116, 118 via web sites 122, 124, 126, 128 that provide access to an analysis tool 130. The third party suppliers and/or distribution intermediaries may provide supply and distribution parameters for offering goods and/or services to consumers through the system. The consumers may provide demand parameters to the analysis tool for inquiring as to the delivered cost of the goods or services.

The analysis tool may thus connect a wide range of consumers, producers and distribution intermediaries for streamlining the sale and/or distribution of goods by analyzing a distribution network to generate and present a set of options to a user. For example, the system may allow consumers to obtain visibility to both regional product availability and delivery charges to that consumer's specific location from a plurality of at least partially separate distribution channels in a multi-channel distribution network. The system may also or alternatively allow producers and distribution intermediaries in a multi-channel distribution network to gain visibility to demand distributions in a distribution system in order to increase the value obtained for a fixed supply of a delivered product.

The analysis tool may provide a valuable benefit of prioritizing and filtering solutions sets presented to a user. A consumer wishing to buy product may be presented with a set of options representing the lowest cost set of product or service options available in the consumer's location and/or a set of options representing the most readily available options. A producer may be presented with a set of options representing the subset of consumers that will net the producer the highest value for his products or services, net of costs of distributing the products or services. A distribution intermediary may be presented with a set of options for connecting a subset of producers with a subset of consumers through paths that may include a subset of other distribution intermediaries, in a manner that meets the specified goals of the distribution intermediary acting as a user of the system, for example in a manner that maximizes his profitability.

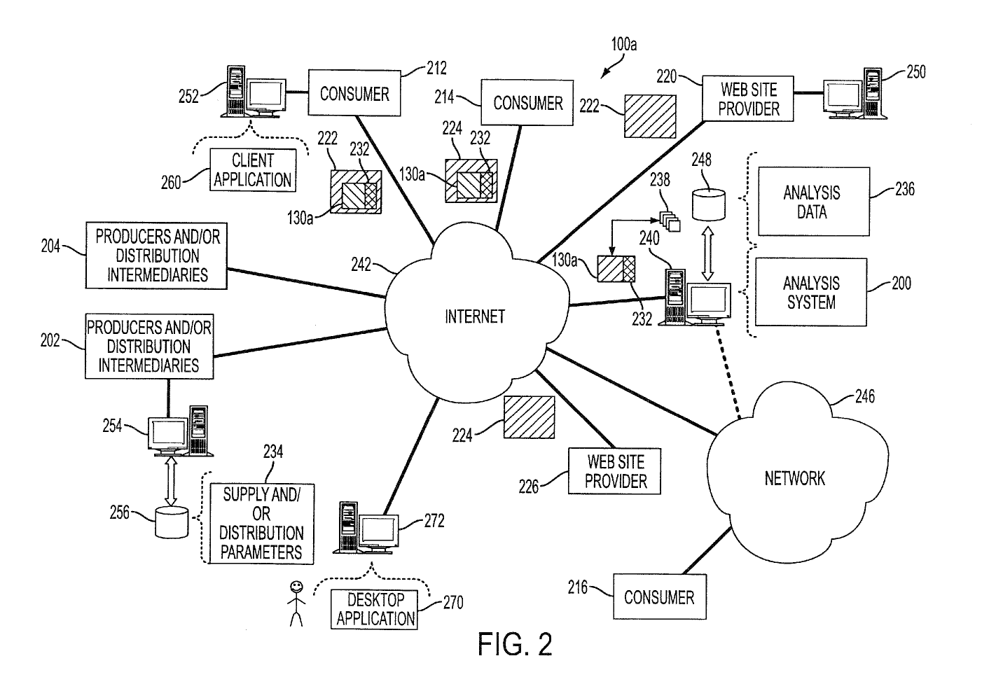

FIG. 2 diagrammatically illustrates one exemplary embodiment of a system 100a consistent with the present disclosure that may be used to facilitate transactions between producers and/or distribution intermediaries 202, 204 in a multilevel distribution network and consumers 212, 214, 216. An analysis system 200 may provide access to an analysis tool 130a to be used by consumers, producers and/or distribution intermediaries for facilitating business opportunities, e.g. business transactions, related to goods and/or services 232 available from the producers and/or distribution intermediaries 202, 204. The product/services 232 may be associated with supply and distribution parameters 234 provided by the producers and/or distribution intermediaries 202, 204. The consumers 212, 214, 216 may access the analysis tool to obtain delivered cost quotations for the goods and/or services 232 from a plurality of separate distribution channels in a multi-channel distribution network via one or more web sites 222, 224 hosted by web site providers 220, 226. Producers and/or distribution intermediaries 202,204 may also access the analysis tool to determine sales opportunities to consumers allowing maximum associated revenue.

The analysis tool 130a may be used to generate one or solution sets 238 (e.g. price quotations or sales opportunity lists) for a consumer or a producer or distribution intermediary using supply parameter and distribution parameters provided by producers and/or distribution intermediaries and consumer inquiry information provided by consumers. The solution sets 238 may be accessed via any one or more of the web sites 222, 224 that provide access to the analysis tool 130a. In connection with generating solution sets using the analysis tool 130a, the analysis system 200 may use stored analysis data 236, such as stored consumer inquires, supply parameters, distribution parameters, etc., as will be described in greater detail below.

The system 200 may reside on and may be executed by a computer 240 that is connected to computer network 242 (e.g., a global computer network, such as the Internet). Computer 240 may be a web server running a network operating system, such as Microsoft Windows XP Server™, Novell Netware™, or Redhat Linux™. Computer 240 may also execute a web server application, such as Microsoft IIS™, Novell Webserver™, or Apache Webserver™, that allows for HTTP (i.e., HyperText Transfer Protocol) access to computer 240 via network 242. The system 200 may also use the Microsoft .NET™ Framework as the overall technology platform. Network 242 may be connected to one or more secondary networks (e.g., network 246), such as a local area network, a wide area network, or an intranet.

The instruction sets and subroutines of the of the analysis system 200 may be stored on a storage device (e.g., a storage device 248 coupled to computer 240) and may be executed by one or more processors (not shown) and one or more memory architectures (not shown) incorporated into computer 240. Analysis data 236 generated by and/or used by the analysis system 200 may also be stored on a storage device (e.g., storage device 248 coupled to computer 240). The storage device may be, for example, a hard disk drive, a tape drive, an optical drive, a RAID array, a random access memory (RAM), or a read-only memory (ROM). A relational database management system (not shown), such as Microsoft SQL Server 2005, may be used to manage the analysis data 236.

An Application Service Provider (ASP) may host one or more application components of the system 200 and the analysis data 236. The ASP may thus handle application support and storage of data such as usernames, passwords, etc. The ASP may also handle reporting of certain data such as new registered users and contact information (e.g., email addresses), saved solution sets, user information, etc. One of the web site providers 220, 226 may also host the analysis system 200 and the analysis data 236.

All or a portion of the analysis system 200 may also reside on and/or be executed other computers such as web site provider computers 250, consumer computers 252 and/or producer and/or distribution intermediary computers 254. At least a portion of the analysis tool 130a, for example, may be executed on the consumer computers 252, for example, as an Active X™ control, a Java™ Applet, or a Adobe™ Flash file, as the consumer uses the 130a. All or a portion of the analysis data 236 may also be stored on other storage devices, for example, coupled to web site provider computers 250, consumer computers 252 and/or producer and/or distribution intermediary computers 254.

A storage device 256 may also be coupled to a producer and/or distribution intermediary computer 254 for storing product and/or service data 234 for the producer and/or distribution intermediary 202, for example, in product catalog database. The analysis system 200 may pull real-time product data from the product catalog database (e.g., using XML calls) and integrate that product data into the analysis tool 130a. Changes to the catalog data may thus be reflected in the analysis tool when the changes are made to the catalog database. The product and/or service data 234 may also be stored with the analysis data 236 on the storage device 248 (e.g., hosted by an ASP).

Consumers 212, 214, 216 may access the system 200 directly through network 242 or through secondary computer network (e.g., network 246). The computer 240 (i.e., the computer that executes the analysis system 200) may be connected to network 242 through a secondary network (e.g., network 246). Consumers 212, 214, 216 may access the analysis system 200 through a computer (e.g., computer 252) that is connected to network 242 (or network 246) and executes a desktop application 260 (e.g., Microsoft Internet Explorer®, Netscape Navigator®, or a specialized interface). The computer 252 may be the consumer's PC or MAC® computer or may be a computer terminal located at a location of a producer and/or distribution intermediary or web site provider.

An administrator may access and administer the analysis system 200 through a desktop application 270 (e.g., Microsoft Internet Explorer®, Netscape Navigator®, or a specialized interface) running on an administrative computer 272 that is also connected to the network 242 (or network 246). The administrative computer 272 may be located at the same location as the analysis system 200 or remotely.

In one embodiment, a consumer may use an analysis tool 130 to generate a consumer inquiry to the analysis system 200. The analysis system 200 may be configured to generate a solution set 238 based on, at least in part, one or more of supply parameters and distribution parameters provided by producers and/or distribution intermediaries. The analysis system may be configured to generate the solution set presenting reduced or minimized cost or time to delivery of a product to the consumer. For example, the analysis system 200 may generate several options for purchase of product and delivery services including information on both product and delivery parameters, which may include cost, quality, timing of availability and combinations thereof. In one example involving fuel transactions, the options may include a display of information on the cost per energy content, e.g. cost/BTU. As will be discussed in greater detail below, the set of options (i.e. the solution set) presented to the consumer may be filtered based on one or more user definable criteria and/or parameters (e.g., only the optimal channel as defined by the user), a set of options that are nearly optimal, or the entire set of potential options for supply and distribution channels.

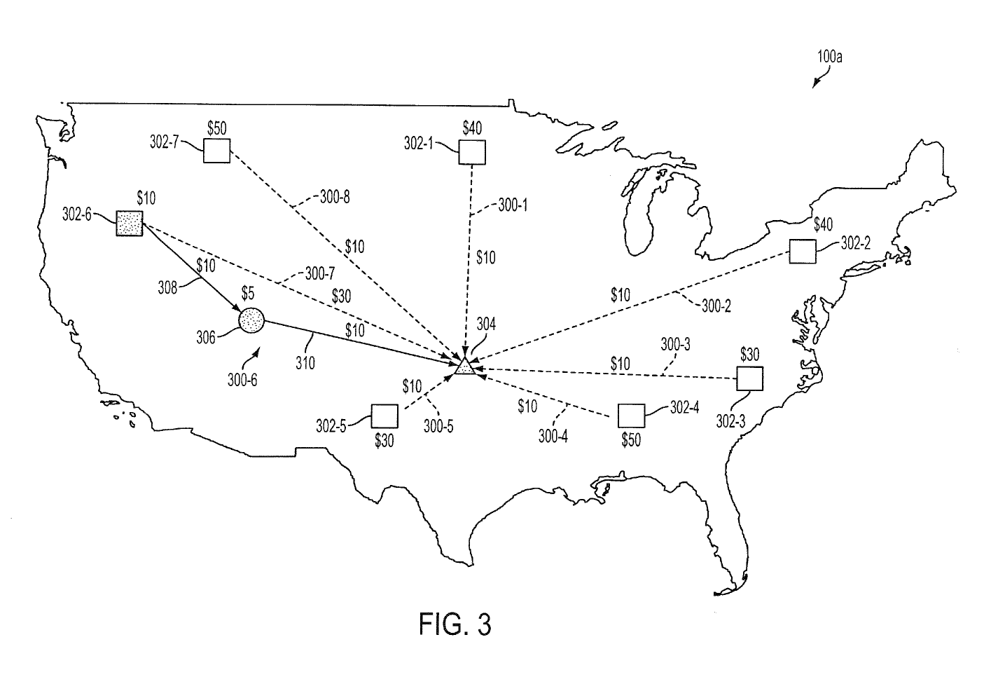

FIG. 3 diagrammatically illustrates one example of operation of a system consistent with the present disclosure for presenting a solution set to a consumer. As shown, a distribution network 100a may include multiple separate distribution channels 300-1, 300-2, 300-3, 300-4, 300-5, 300-6, 300-7, 300-8 for delivering a product from one or more producers 302-1, 302-2, 302-3, 302-4, 302-5, 302-6, 302-7 to a consumer 304. For example, channels to the consumer 304 may include direct channels 300-1, 300-2, 300-3, 300-4, 300-5, 300-7, 300-8 or multi-level channel 300-6 including distribution intermediary 306. In the illustrated exemplary embodiment, multi-level channel 300-6 includes a distribution intermediary for delivering goods or services along path 308 from producer 302-6 to distribution intermediary 306 and a path 310 from the distribution intermediary 306 to the consumer 304.

The dollar figures adjacent producers 302-1, 302-2, 302-3, 302-4, 302-5, 302-6, 302-7 and distribution intermediary 306 represent the cost of the product at the associated producer or distribution intermediary, and the dollar figures along the distribution channels 300-1, 300-2, 300-3, 300-4, 300-5, 300-7, 300-8 and paths 308 and 310 represent delivery costs along the distribution channel or path. In the illustrated exemplary embodiment, product may flow along multi-level channel 300-6 from the producer 302-6 to consumer 304, with a $10 product cost at the producer 302-6 and along path 308 to distribution intermediary 306 with a $10 delivery cost. The product cost at the distribution intermediary may be $5 and the cost of delivery along path 310 to the consumer 304 may be $10. The resulting total delivered cost the consumer along path 300-6 may be $35, which includes at total of $10 in product costs and a total of $25 in delivery costs.

The option of purchasing the product through multi-level channel 300-6 at a total delivered cost of $35 may be presented to the consumer option in a solution set along with the option of purchasing product through distribution channels 300-3, 300-5 and 300-7 which may each have total delivered product costs of $40. In one embodiment, product delivered through distribution channels 300-1, 300-2, 300-4 and 300-8 may not be presented as part of a solution set to the consumer 304 due to their relatively higher delivered cost. Advantageously, a system and method according to the present disclosure may allow a consumer to be presented a solution set including a plurality of delivery options that analyze multiple distribution channels from producer to consumer in a multi-channel distribution network and choose among those options. Although the illustrated embodiment is described as presenting a solution set involving cost minimization within a multi-channel distribution network, selection of product and distribution channels may determined based on, at least in part, the timing of delivery or other factors of concern to the specific consumer 304, or by a weighted objective function driven by multiple factors such as cost, timing and product quality.

According to another embodiment of the present disclosure the distribution network 100a configured to generate a solution set based on, at least in part, an aggregate demand from multiple consumers located at geographically different locations wherein a plurality of producers may bid for the right to supply product to that group of consumers in an auction format. The analysis system may determine time and/or costs associated with moving the product from producers to these consumers based on, at least in part, one or more of the analysis tool inputs representing the aggregate demand from multiple consumers, the set of distribution parameters and the set of producer bids. For example, if the consumer 304 is considered to be an aggregate group of geographically dispersed consumers desiring to minimize cost, the analysis system may provide a solution set identifying the lowest net average delivered cost to the aggregated group.

The plurality of consumers may also be geographically partitioned into two or more groups in which a set of solutions may be generated for each group. It may also be useful in some instances to generate a set of solutions 3 for the groups utilizing an iterative process based on successive trials at regional grouping strategies before selecting a grouping strategy that provides the optimal distribution scenario for a given set of aggregated consumers. A similar aggregation strategy may be performed for producers, such that the selling price (net of distribution costs) to the aggregated group of producer's facilities may be maximized.

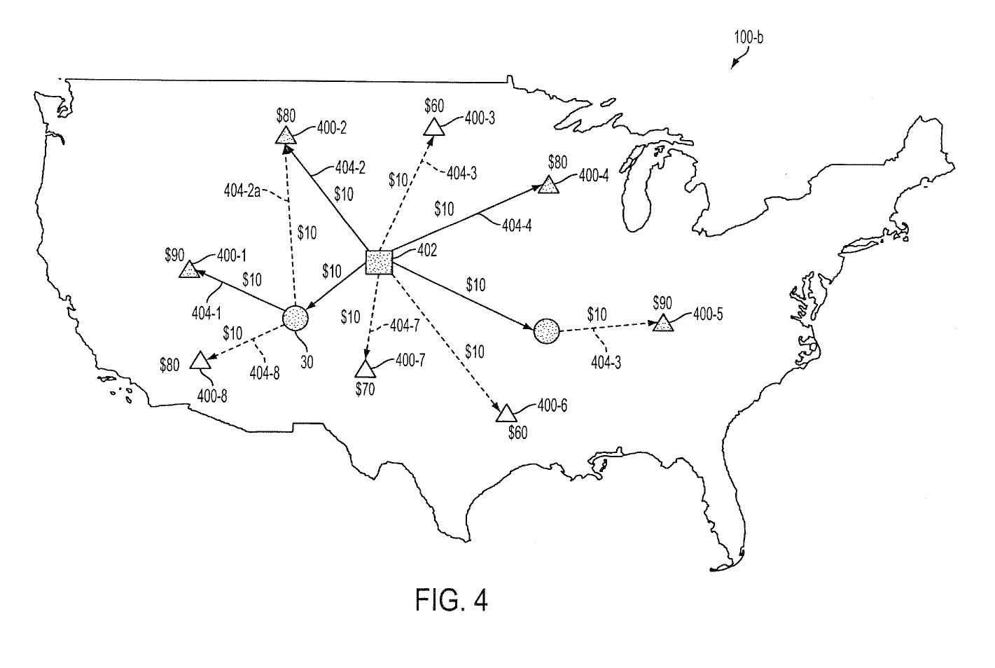

Turning now to FIG. 4, a system and method according to the present disclosure may also or alternatively be utilized for the benefit of a producer seeking to reduce its downstream distribution costs and connect according to a more direct and profitable channels to its consumers. In the illustrated exemplary embodiment, a distribution network 100b may include a plurality of consumers 400-1, 400-2, 400-3, 400-4, 400-5, 400-6, 400-7, 400-8 that are willing to pay a specific associated price for a product as noted in dollars adjacent each consumer. To provide product from the producer 402 to the consumers 400-1, 400-2, 400-3, 400-4, 400-5, 400-6, 400-7, 400-8, the product may travel along associated distribution channels 404-1, 404-2, 404-2a, 404-3, 404-4, 404-5, 404-6, 404-7, 404-8. The delivery cost to the producer along the distribution channels is noted in dollars adjacent each channel or distribution path associated therewith. The analysis system 200 may be configured to determine which of the plurality of available distribution channels may result in the maximum profit for the producer 402.

For example, the analysis system 200 may be configured to subtract the distribution costs from the prices consumers 400-1, 400-2, 400-3, 400-4, 400-5, 400-6, 400-7, 400-8 are willing to pay to determine which of the plurality of available distribution channels 404-1, 404-2, 404-2a, 404-3, 404-4, 404-5, 404-6, 404-7, 404-8 may result in the maximum profit for the producer 402. In the illustrated embodiment, the analysis system 200 may determine that the producer 402 may realize at least $70 in net revenues after accounting for distribution costs from consumers 400-1, 400-2, 400-4 and 400-5 and may present such options as a solution set to the producer 402. Additionally or alternatively, a producer desiring to move product quickly may utilize a distribution system and method consistent with the present disclosure to determine which consumers could rapidly take delivery through the distribution network.

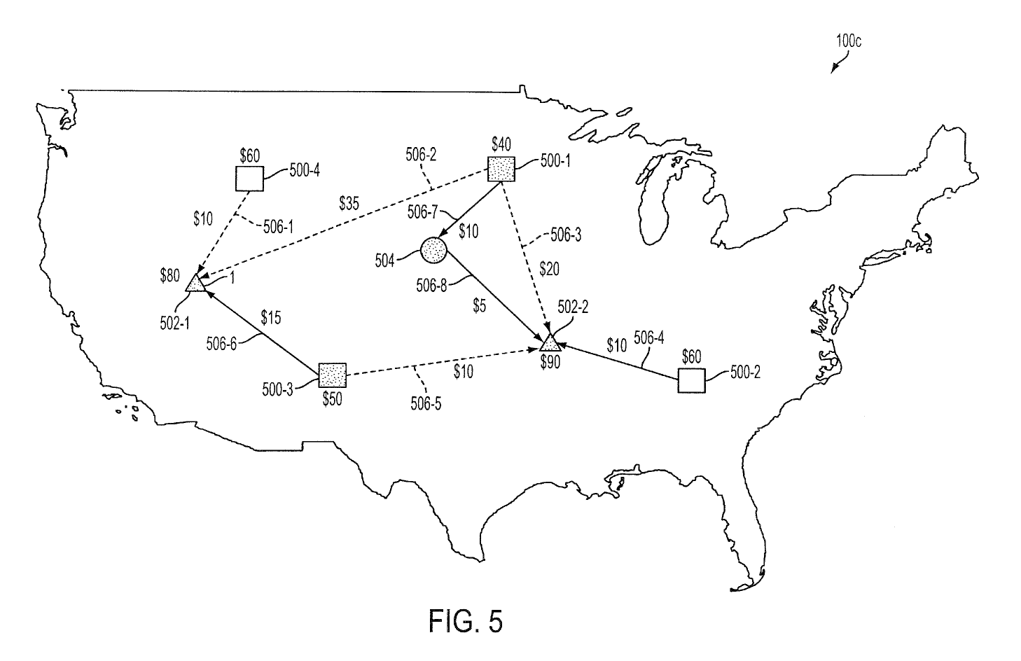

As illustrated in FIG. 5, a system and method according to the present disclosure may also or alternatively be utilized by a distribution intermediary to profitably connect supply and demand according to profitable channels. For example, a distributor may calculate optimal product flow channels to maximize distributor profitability and/or present purchase opportunities to consumers or sales opportunities to producers or other distribution intermediaries in such a manner that the distribution channels between the consumers and producers or other third party intermediaries have been independently considered.

As shown, distribution network 100c may include a distribution intermediary 504, plurality of potential producers 500-1, 500-2, 500-3, 500-4 of product and a plurality of consumers 502-1, 502-2. The product cost associated with each producer is noted in dollar figures adjacent each producer and the price each consumer is willing to pay for the product is noted in dollars adjacent each consumer. The delivery cost to the consumer or distributor along each of a plurality of distribution channels 506-1, 506-2, 506-3, 506-4, 506-5, 505-6, 505-7, 505-8 is noted in dollars adjacent each channel.

In the illustrated exemplary embodiment, it may be possible for the distribution intermediary 504 to arrange delivery of product to the consumer 502-1 from producers 500-1, 500-3 or 500-4 through distribution channels 506-2, 506-6 and 506-1, respectively, with delivered product cost to the consumer of $75, $65 and $70, respectively. The distributor may choose to provide product from producer 500-3 to maximize the distributor profit of the $80 price the consumer 502-1 is willing to pay. Similarly, consumer 502-2 may be provided product from producer 500-1 along distribution channel 506-3 or distribution channels 506-7 and 506-8 through the distribution intermediary 504, or directly from producers 500-2 and 500-3. In illustrated embodiment, the lowest delivered cost channel is via channels 506-7 and 506-8 through the distribution intermediary 504, so choosing this distribution channel may result in maximum profit to the distributor.

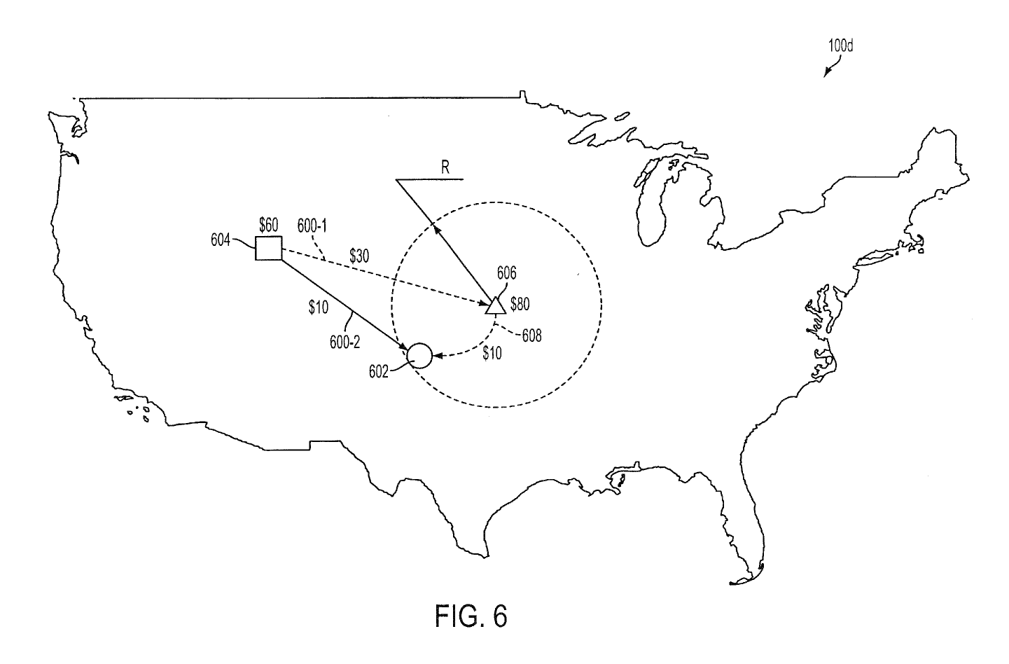

FIG. 6 illustrates another exemplary embodiment of a system and method according to the present disclosure wherein a consumer may be provided an option to pick up a product at a location within some geographic radius R, or alternatively may be offered the option of delivery to a desired location. As shown, a distribution network 100d may include a distribution intermediary 602, a producer 604, and a consumer 606. The product cost associated with the producer is noted in dollar figures adjacent the producer and the price the consumer is willing to pay for the product is noted in dollars adjacent the consumer. The delivery cost to the consumer or distributor along each of a plurality of distribution channels 600-1, 600-2 is noted in dollars adjacent each channel.

As shown, a distribution network 100d may include a distribution channel 600-1 directly between the producer and the consumer's location. The consumer 606 may indicate a willingness to travel a distance of no more than radius R as long as he can save $10. Based on these demand parameters, a distribution system and method according to the present disclosure may determine that the product may be delivered directly to the consumer via channel 600-1 for a cost of $30. Additionally or alternatively, the distribution system may determine that the product maybe delivered to distribution intermediary 602 (which may be located within the radius R) for $10 and that the costs associated with picking up the product at distribution intermediary 602 (as indicated along pickup path 608) may also be $10. The effective net cost to the consumer associated with channel 600-2 and pick-up path 608 $80 as opposed to $90 via channel 600-1. The option of purchasing the product through either of the distribution channels, 600-1 or 600-2 may be presented to the consumer. Given this consumer's preference in this example, the consumer 606 may prefer to pick-up the product at distribution intermediary 602 rather than have it delivered directly to his location through distribution channel 600-1.

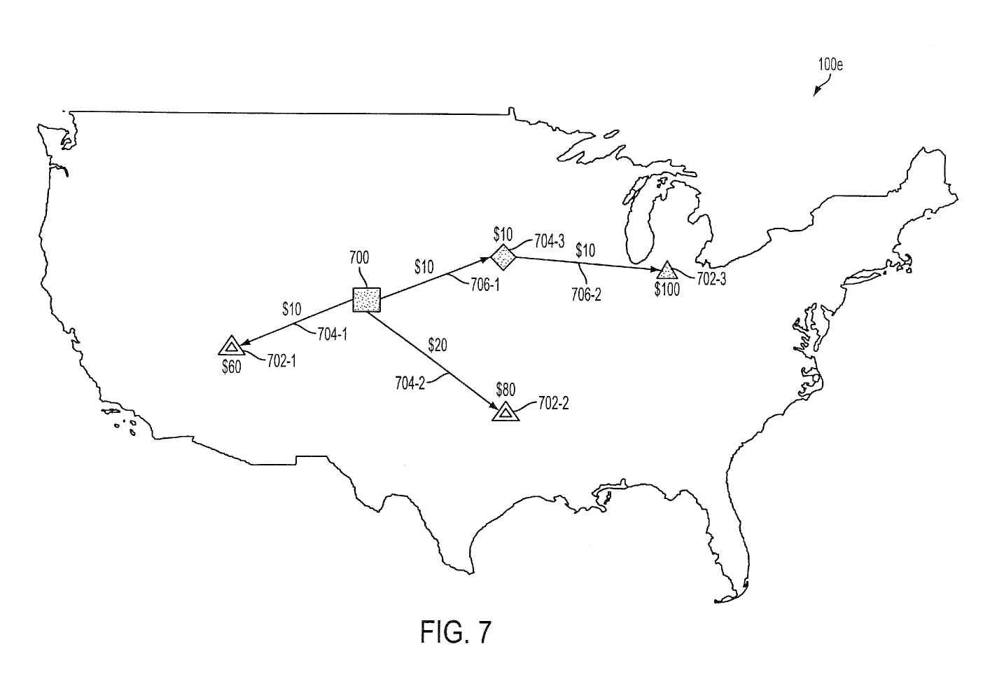

FIG. 7 diagrammatically illustrates an system consistent with the present disclosure wherein a product may change form or grade. As shown, distribution network 100e may include a producer 700 that may supply bulk product to two consumers 702-1 and 702-2, whereas a third consumer 702-3 requires that the product be packaged, e.g. bagged. The consumers 702-1, 702-2, 702-3 may have indicated a willingness to pay $60, $80 and $100, respectively as indicated in dollar figures adjacent the consumers. The costs of distribution to consumers 702-1 and 702-2 may be $10 and $20, respectively, as indicated adjacent associated distribution channels 704-1 and 704-2. In contrast, the costs of distribution to consumer 702-3 may include the cost ($10 in the illustrated example) of packaging the product at a distribution intermediary 706, e.g. a packaging centers, well as delivery costs along distribution channel 704-3, which includes paths 706-1 from the producer to the distribution intermediary ($10 in the illustrated example) and 706-2 and 704-4 from the distribution intermediary to the consumer for a total effective cost of $30. In the illustrated example, the system may determine that the net price from the producer's 700 perspective is highest for a sale to consumer 702-3 and may present this option to the producer 700 exclusively, or along with a subset or complete set of alternative options, each including the net value (whether defined in terms of cost, timing, quality or some combination thereof) to the producer.

It should also be understood that even if the form of the product does not change, the form of transportation provided by distribution intermediaries may change. For example, a transload station may take skids of product off of a railcar and then load them onto trucks for the next leg of distribution. Similarly, the type of trucks appropriate for moving a product from a producer to a distribution center may be of a different size than those appropriate for retail deliveries. A distribution intermediary may perform and be compensated for these handling functions when a form-of-transportation change occurs, even if a product-form change does not occur.

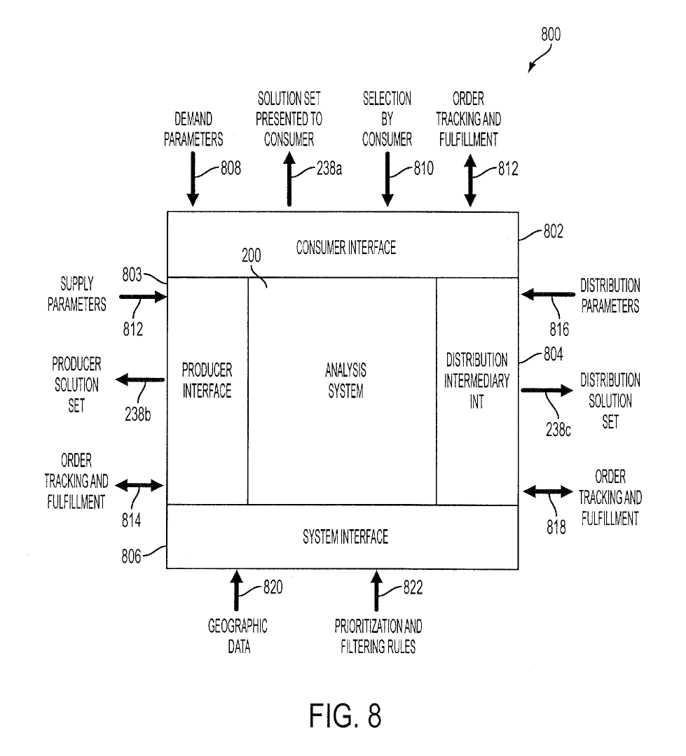

Turning now to FIG. 8, there is illustrated one exemplary embodiment of system 800 consistent with the present disclosure illustrating various exemplary interfaces, e.g. provided by an analysis tool 130, to an analysis system 200. Although the illustrated exemplary embodiment includes consumer, supplier and distributor interfaces it is to be understood that the system may include only one or more of the interfaces. Also, the specific input/output of the system 200 and the illustrated interfaces may vary from the illustrated exemplary embodiment.

As shown the system 800 may be configured to receive a plurality of inputs, e.g. geographic data 820 and prioritization and filtering rules 822, used by the analysis system 200 to generate solution sets 238a, 238b, 238c. For example, system may provide a consumer interface 802, a producer interface 803, a distribution intermediary interface 804, and a system interface 806. A consumer may submit demand parameters 808, and a solution set 238a may be presented to the consumer based on, at least in part, one or more consumer definable criteria and/or parameters. The consumer may input a selection 810 of particular combination of product and delivery services from the interface and the system may interact with the consumer around order fulfillment and tracking 812.

Although the illustration shows these inputs as being directly input into the analysis system by various users of the analysis system, such as consumers, distribution intermediaries, producers and internal system administrators, in some cases it may be preferable to have an internal system administrator enter all or part of the parameters being provided by a producer, consumer or distribution intermediary. For example, this may be the case if a consumer calls and a phone operator enters a consumer's inquiry into the system, or similarly an office staff member may enter producer supply parameters or distribution parameters on behalf of a distribution intermediary.

As used herein, demand parameters 808 may represent broad set of information relating to consumer demand. For example, demand parameters 808 include, but are not limited to: type of demand, which may include: external requests, such as: a consumer request, a reseller request, a commitment to purchase at a fixed price, a commitment to purchase a volume at the best available price, a request for product previously guaranteed to the consumer, an autonomous request based on a level sensor in a storage system, and internal forecasts or virtual requests, such as those based upon heating degree days or weather patterns, historical demand patterns, mailing list data, consumer purchase history, economic data, weather forecasts, historical response rates to quotations, current response rates to quotations; type of product, such as type of materials, classification/certification/grade or quality level, form of product, e.g. bulk solid, bagged solid or liquid, required Storage, cold storage, type of delivery, e.g., the types of trucks that can be accepted or whether rail and/or ship can be accepted; type of consumer, e.g. retail, wholesale or distributor; timing of request, e.g. preference for immediate delivery or at another time; and/or consumer affiliation, e.g. particular consumer groups may be prioritized by the subsequent quoting logic.

The producer interface 803 may allow the producer to pass supply parameters 812 into the system, for example, but not limited to, product supply parameters and the like, which may be used for subsequent analysis by the analysis system As a result of the analysis, a producer solution set 238b, e.g. product orders, may be generated and fed back to the producer, for subsequent order tracking and fulfillment 814.

As used herein, supply parameters 812 may represent broad set of information relating to product supply. Examples of supply parameters provided by a producer 812 include, but are not limited to: type of supply, which may include: external supply signals, such as an offer to sell product from a producer, harvester or primary source, an offer to sell product from a distributor or secondary source, a commitment to sell at a fixed price, a commitment to sell a volume at the best available price, an existing agreement to sell under pre-established terms, an electronic signal from a source carrying any of these parameters; internal forecasts of expected supply, such as those based upon prior supply or production patterns, information on producer inventory, heating degree days or weather patterns, historical supply and demand patterns, mailing list data, economic data, time of year or weather forecasts, historical response rates to requests for product, current response rates to requests for product; type of product; type of materials such as classification/certification or quality level, form of product, e.g. bulk solid, bagged solid or liquid; required storage, e.g. cold storage, means of obtaining product, e.g. the types of trucks that can pick up product; type of producer, e.g. regional or national, single facility or multiple location; timing of request, e.g. preference for immediate delivery or sales or at another time; producer affiliation, e.g. particular producer groups may be prioritized by the subsequent quoting logic; and other producer parameters

The distributor interface 804 may allow the distributor to provide distribution parameters 816 to the system and to receive a distribution solution set 238c, e.g. requests for distribution services, back from the system. Order fulfillment and tracking 818 can then be carried out by the system.

As used herein, distribution parameters 816 may represent broad set of information relating to distribution. Distribution Parameters 16 may include transportation parameters, distribution intermediary parameters and geographic data. Distribution intermediary parameters may be associated with a geographic location. Transportation parameters may be associated with two points or distances between a starting point and a finishing point for any leg of a trip. Examples of transportation parameters may include: the mode of transport (for example truck, rail, ship, etc.), the routes/paths along roads, rail, water, etc., the type of product(s) transportable, the distances or areas serviced, cost parameters (cost per load, cost per mile, etc.), certification parameters, service parameters (relating to reliability, responsiveness, etc.), etc.

A distribution system and method according to the present disclosure may consider that the mode of transport utilized to deliver a product to a first consumer may differ than that which is appropriate to deliver the product to another consumer or location. Furthermore, the distribution system and method may consider that in a multi-channel distribution network, the mode of transport from a producer to a distribution intermediary may differ from the mode of delivery from the distribution intermediary to the consumer. Additionally, the distribution system and method may consider that the mode of distribution may vary based on the type of product being distributed and the form of the product when it is being distributed. The mode of transport may in other cases be driven by the requested timing of the consumer's request.

Examples of distribution intermediary parameters may, therefore include: the type of services provided, which may include storage of product, handling of product, repackaging of product, inspection of product, transloading of product and other operations on product passing through their system; the physical location of the distribution intermediary, which may include as state, county, city, zip code or street address; the operational location of the distribution intermediary, which may include a distance along a rail line from a terminal, proximity to other facilities, etc; the type of goods handled; the service area of the distribution intermediary, e.g. states or regions served; cost parameters; the type of transportation equipment that may enter or leave the facility; parameters associated with services provided such as packaging costs per unit, storage costs per unit, handling fees per unit, costs for allowing consumers to pick up and the parameters associated with services provided; and other parameters uniquely associated with that distribution intermediary. Examples of geographic data that may be included among the distribution parameters may include: the geographic location of specific points; point-to-point distances (via air, road, straight line or other means); travel times between points; travel costs between points (if previously developed); minimum quantity levels by location; auto-acceptance quantity levels by location; and other geographic data.

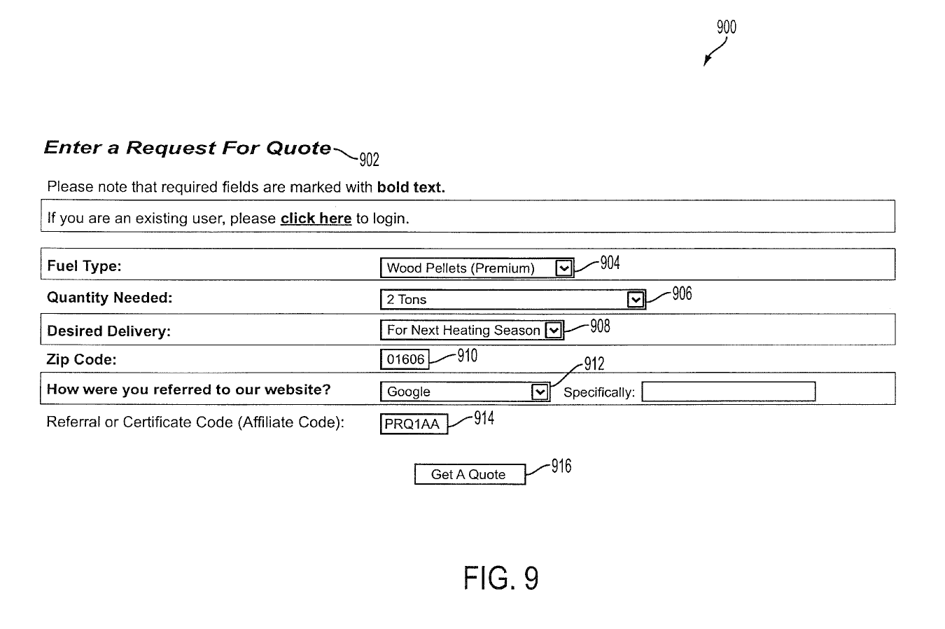

FIG. 9 is a screen shot showing one exemplary embodiment 900 of a portion of a consumer interface 802a configured to receive demand parameters 808. A user may be prompted to request a quote 902 and given the opportunity to describe his needs to the system by selecting from one or more menus (such as, but not limited to, drop-down menus or the like) or input fields. For example, the fields may be provided to allow the user to enter a particular type of good 904, the quantity needed 906, the desired delivery 908, the consumer's geographic location 910, the type of referral 912 and a referral or affiliation code 914. The referral or affiliation code 914 may be used for a variety of purposes, which may include allowing that demand signal to be aggregated with other affiliates, allowing that order to be prioritized or filtered differently, affording discounts, or for other uses. The interface may present a button 916 for actuation by a consumer to obtain a quote on the goods, which in the illustrated exemplary embodiment are wood pellets used as a heating fuel.

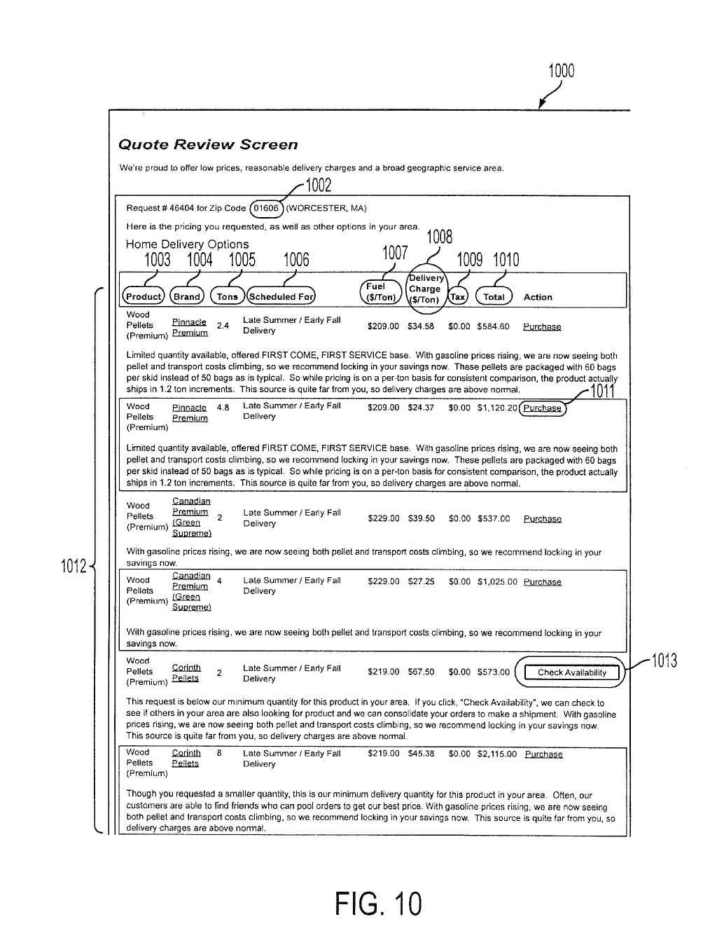

FIG. 10 is a screen shot illustrating one exemplary embodiment 1000 of a portion of a consumer interface 802a for providing a consumer with a solution set 238a. The solution set may be analyzed for a particular location 1002, which in this example shows the zip code for this particular set of options. The set of options may be analyzed for a state, county, region, street address, latitude and longitude pair or any other means of identifying a geographic location. In response to request for a quote from a consumer, the distribution system and method may present a solution set including, each of one or more product options 1012, the type of product 1003, the brand 1004, the quantity available for purchase 1005, the schedule for providing the product 1006, the cost of the product 1007, the delivery charges 1008, localized taxes 1009, and/or the total amount due 1010. In one embodiment, the set of options may include a button or link 1011 that allows the consumer to purchase a selected one of the products from the product options 1012 and the associated delivery services.

The presented options may vary depending on geographic location, e.g. a consumer making a request in one geographic location may see different results, e.g. a different set of producers and/or a different set of products or services, than a consumer in another geographic location. In addition, though the user may have requested a particular quantity of product, the distribution system and method may respond with alternative quantity suggestions as discussed below. In the illustrated example, the consumer requested 2 tons, and the system presented a solution set including 2, 2.4, 4, 4.8 and 8 tons, based on the available materials in the area, e.g. as determined from supply parameters provided through a producer interface. A system and method consistent with the present disclosure may provide other alternatives associated with the demand parameters provided by the consumer including, but not limited to, alternative types of product and/or brands as well as alternative schedule parameters.

For example, a consumer requesting the product “Wood Pellets (Premium)” may also be presented with options for the product “Wood Pellets (Super-Premium)” or even alternative goods such as “Clean Dry Corn Fuel”. A consumer requesting a specific product or brand may be presented multiple brands. A consumer requesting immediate delivery may be quoted “Late Summer/Early Fall” or quoted “Fall Delivery” at potentially a different price. Additionally, the distribution system and method may also include a link or button that allows a consumer to check availability of a product and/or delivery service, when the ability to supply is not known instantaneously. In one embodiment, this information may be fed back to a central database where a consumer service team may act on the inquiry and respond to the consumer at a later date.

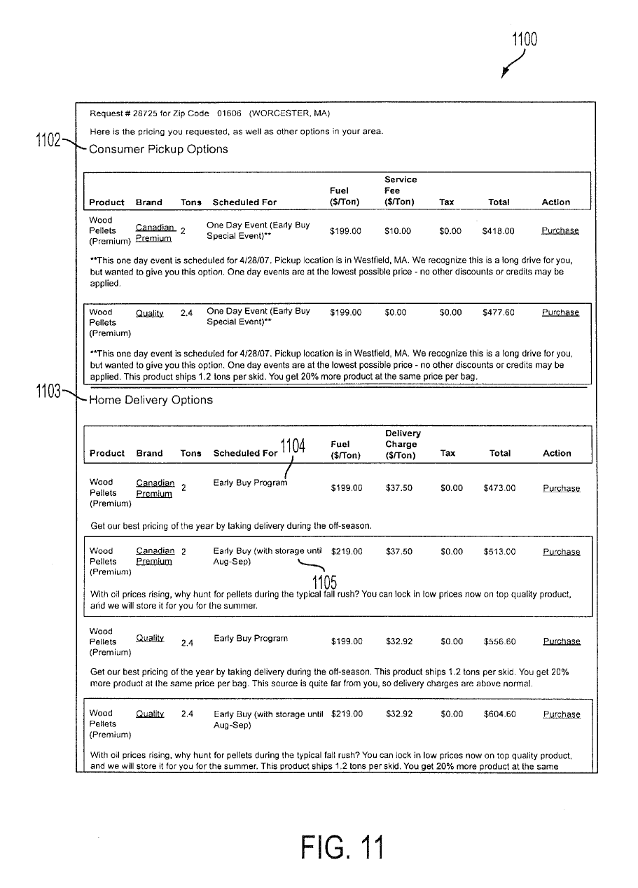

FIG. 11 is a screen shot illustrating another exemplary embodiment 1100 of a portion of a consumer interface 802a for providing a consumer with a solution set 238a. For example, the interface application may provide options for pickup 1102 and options for delivery 1103, as part of the same solution set presented to the consumer. Options for buying early 1104 may also be displayed along with options for buying early and taking delivery at a later date 1105.

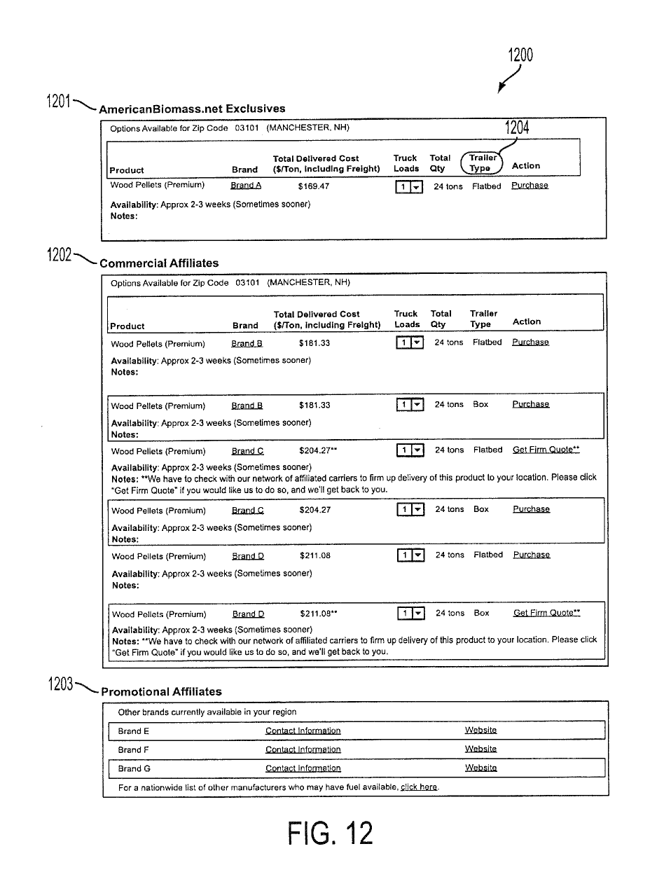

FIG. 12 is a screen shot illustrating another exemplary embodiment 1200 of a portion of a consumer interface 802a for providing a consumer with a solution set 238a. As shown, the set of options may be grouped according to marketing categories such as, but not limited to, exclusive listings 1201, commercial affiliates 1202 and Promotional Affiliates 1203. The type of transport to be utilized 1204 may also be included, along with other supply, demand and distribution parameters, for review and selection by the consumer.

The types of information that may be presented as part of a solution set 238a presented to a consumer may include any appropriate elements of the demand parameters 808, the supply parameters 812, the distribution parameters 816 and other relevant parameters such as data associated with prioritization and filtering rules 822. The data presented in the illustrated exemplary embodiments a provided by way of illustration only. Additional and/or different parameters may be appropriate for display depending on the implementations and/or applications.

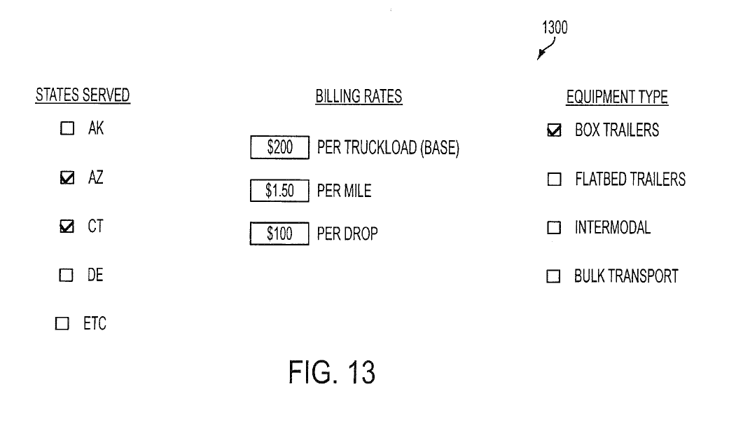

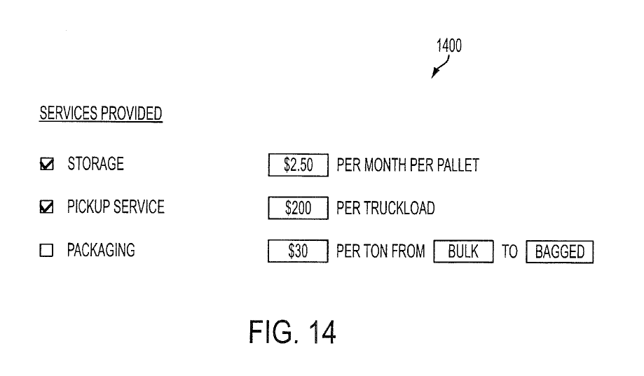

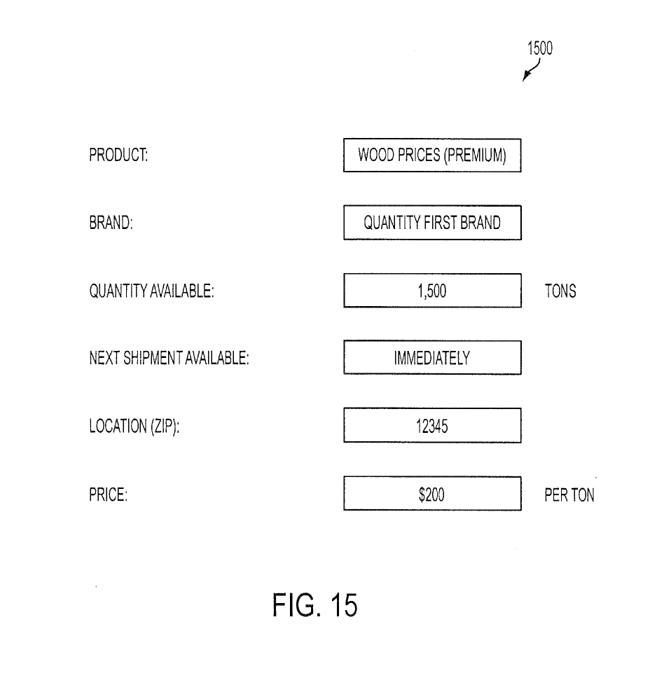

FIG. 13 diagrammatically illustrates an exemplary embodiment 1300 of a portion of a distributor interface 804a for receiving distribution parameters 816 from a transportation provider, and FIG. 14 diagrammatically illustrates an exemplary embodiment 1400 of a portion of a distributor interface 804a for receiving distribution parameters 816 from a distribution center. FIG. 15 diagrammatically illustrates an exemplary embodiment 1500 of a portion of a producer interface 803a for receiving supply parameters 812 from producer.

In FIGS. 13 to 15, the data in the boxes may represent a user's input to the system. For example, as shown in FIG. 13, a distributor interface may provide one or more screens whereby a transportation provider may update a specific subset of the transportation parameters associated with that carrier, such as their pricing parameters. Similarly, as shown in FIG. 14, a distribution center may be able to update a set of distribution parameters associated with the distribution center. As shown FIG. 15, a producer may also have an interface into the system which allows him to supply parameters 812

According to one embodiment of the present disclosure, the interfaces discussed herein may be configured such that a user may manually enter the parameters discussed herein. However, the interfaces may be configured to automatically receive data through electronic data interchange. A system and method according to the present disclosure may allow each party within the overall transaction to individually update their own parameters, and/or may substantially continually refine and update the set of options which may be provided on an automatic and ongoing basis.

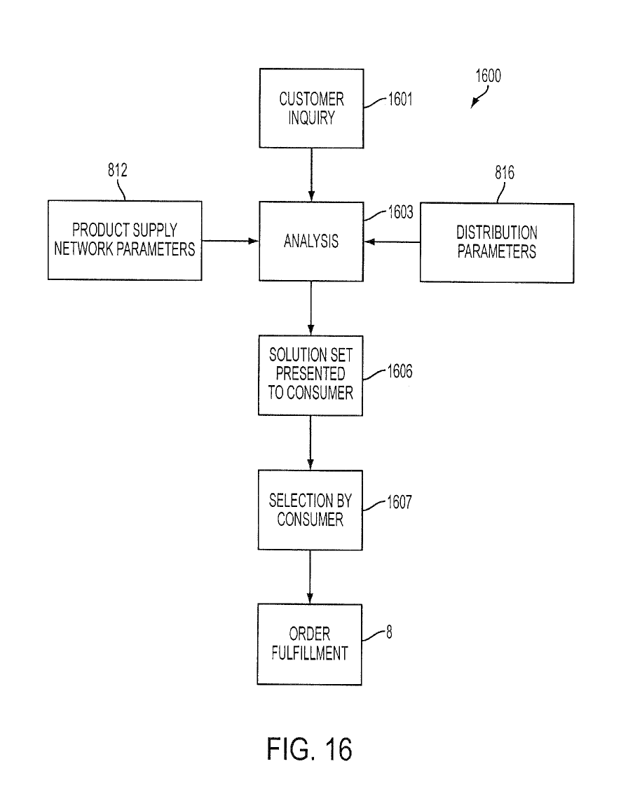

FIG. 16 is a block flow diagram of one exemplary embodiment 1600 of a method consistent to be performed by an analysis system consistent with the present disclosure in which a consumer inquiry may drive the delivery of a solution set review and selection by the consumer. The block flow diagrams used herein to describe various embodiments include particular sequences of steps. It can be appreciated, however, that the sequence of steps merely provides an example of how the general functionality described herein can be implemented. Further, each sequence of steps does not have to be executed in the order presented unless otherwise indicated.

In FIG. 16, a consumer inquiry 1601 may be generated and entered into the system, for example, through a consumer interface 802. The analysis system 200 may perform an analysis 1603 of that inquiry, based on, at least in part, one or more of a set of supply parameters 812 and distribution parameters 816. As a result of that analysis, a solution set including options for purchasing product through a plurality of at least partially separate distribution channels in a multi-channel distribution network may be presented 1606 to the consumer. The consumer may select 1607 one or more of these options, and then the order would proceed to the order fulfillment phase 1608.

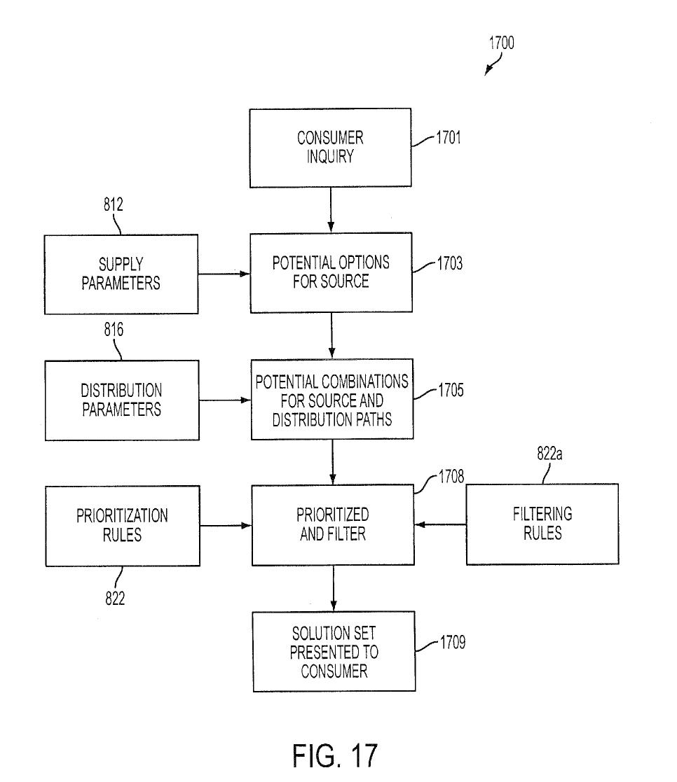

One method 1700 and system for conducting the analysis, e.g. in an analysis system 200, as described above is shown in FIG. 17 in a block flow form. In this example, a consumer inquiry 1701 may be compared with a set of supply parameters 812 to generate a set of potential options 1703 for the source of the product forming the basis of the consumer inquiry. In one example, a consumer may request a delivery of a product and supply parameters may be used to select potential sources of the product within a 100 mile radius of the consumer's location.

Distribution parameters 816 may be used to trace at least one distribution channel from each source of the product to the desired delivery location to generate a set of potential combinations for source and distribution channels 1705. This may include, for example, examining potential routes from each source to the consumer's location, potentially including multiple potential travel channels between a single source and the consumer.

Optionally, the potential combinations for source and distribution channels may be prioritized and filtered 1708 based on, at least in part, one or more prioritization rules 822 and/or filtering rules 822a. In one example, the prioritization rules 822 may be used to determine the lowest cost channel for each source, and then to choose a set of sources providing the lowest total delivered cost solutions. In another example, the prioritization rules 822 may be used to determine the shortest delivery time. The consumer inquiry 1701 may contain demand parameters 808 used prioritize or filter the responses as well, such as the consumer identifying his own priorities such as “lowest cost” or “fastest time”. In other cases, it may not be necessary to prioritize or filter results at all, and advisable merely to present all options to the consumer.

The system and method according to the present disclosure may then generate 1709 a solution set including options for purchasing product through a plurality of at least partially separate distribution channels in a multi-channel distribution network for presentation to the consumer. This presentation may be a visual display on a web interface, or in some cases may be an electronic transfer of information to a prospective or committed buyer. In one embodiment, the solution set options presented to the consumer may be issued as an e-mail including an actionable purchase button allowing the consumer to make a purchase associated with one of the options

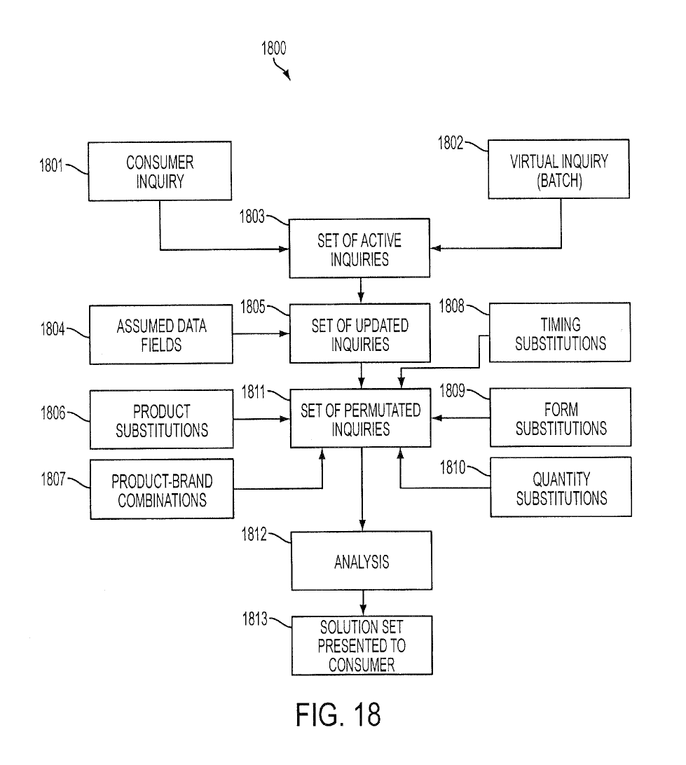

Referring to FIG. 18, one embodiment of an analysis system consistent with the present disclosure is illustrated in block flow form in which a set of options may be presented to a consumer is based on, at least in part, information that is not input directly by a potential consumer. For example, a consumer inquiry may be generated by an actual consumer inquiry 1801, or a virtual inquiry 1802 may be created as part of a batch of inquiries generated by an autonomous process. An example of such a batch input may include taking a mailing list with names and zip codes and creating an inquiry on behalf of potential consumers who have not submitted an inquiry themselves, e.g. using their names and zip codes. Real and virtual inquiries may be combined into one set of active inquiries 1803. Optionally, a data set including assumed data fields 1804 may be combined with the set of active inquiries 1803 to generate a set of updated inquiries 1805. For example, to continue with the batch mailing list example above, in generating a set of updated inquiries 18055, a quantity or type of product that is desired may be assumed. For example, if the mailing list was based on buyers of wood stoves, the type of product assumed could be assumed to be wood, and the quantity could be assumed to be one cord of wood.

The set of updated inquiries 1805 may be permutated to generate a set of permutated inquiries 1811, which may then be submitted for analysis as if each were an individual consumer inquiry. For example, the permutated inquiries 1811 may be generated based on a variety of factors depending on the specific application including, but not limited to, product substitutions 1806, product-brand combinations 1807, timing substitutions 1808, form substitutions 1809, or quantity substitutions 1810. By way of example, the set of permutated inquires 1811 may be generated based on a product substitution 1806 by submitting a request for at least one other product type in response to a consumer requesting a specific type of product. For example, if a consumer requested premium wood pellets for a heating application, the distribution system and method may be configured to also submit a request for standard wood pellets. Such a request may be configured to convert all premium wood pellet inquiries to requests for standard wood pellets, to initiate quotes on both types any time either is requested, or generally to suggest another product in response to a given goods request.

An example of a product-brand combination 1807 which may be utilized to generate the set of permutated inquires 1811 may include generating requests for three different brands of product in response to a request for one or more specific types or brands of product. An example of a timing substitution 1808 which may be utilized to generate the set of permutated inquires 1811 may include offering more than one option for the timing of delivery, such as “Expedited”, “1-2 weeks”, “2-4 weeks” and so on. An example of a form substitution 1809 which may be utilized to generate the set of permutated inquires 1811 may include offering bulk product in response to a request for bagged product. An example of a quantity substitution 10 which may be utilized to generate the set of permutated inquires 1811 may include “upsize” requests, e.g., creating a request for 4 tons of product simultaneously with each request for 2 tons of product. It should be understood that pricing of different combinations of these parameters may be varied. Specifically with reference to timing options, the pricing offered to a producer or a consumer may be varied according to a fixed schedule, or with reference to an external index, such as a Consumer Price Index or publicly available commodities index.

The examples of how the set of permutated inquires 1811 may be generated based on the various factors discussed above are not intended to be limiting and other factors may be utilized depending on the intended application. For example, any number of parameters associated with the consumer inquiry may also be used. In addition, it may also be advisable to limit certain types of permutation to acceptable combinations of parameters. For example, one may limit the list of brands associated with a particular product to an appropriate set. It may also be beneficial to permutate customer preference relating to distribution parameters, to generate requests for product delivered by various modes, such as by truck, railcar or other means, or to generate requests for product delivered using a specific class of vehicle or specific affiliated delivery service provider.

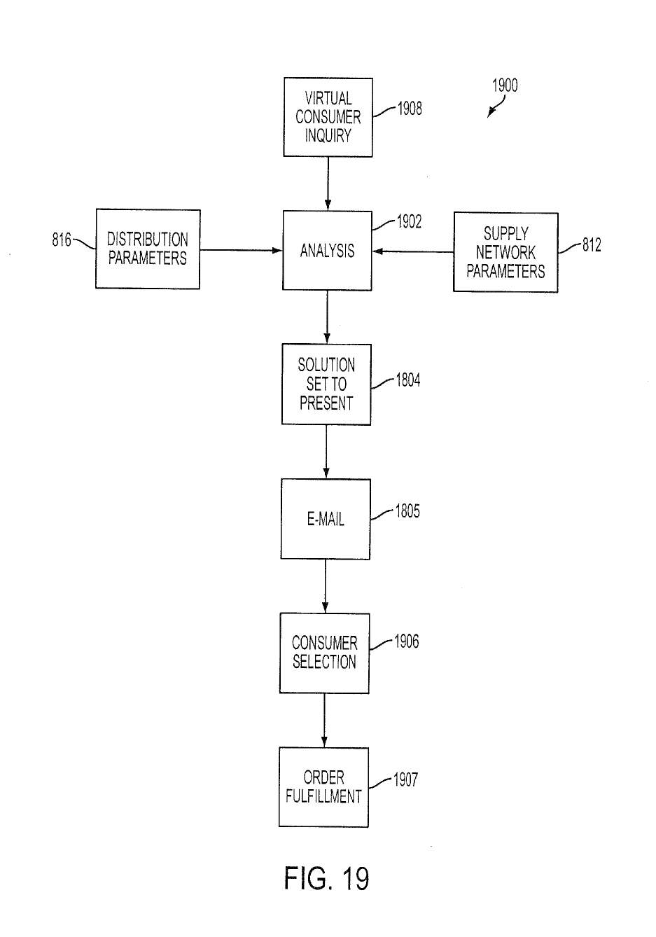

Referring now to FIG. 19, one embodiment 1900 of an analysis system and method consistent with the present disclosure is shown in block flow form wherein a consumer inquiry is not prompted by a consumer's action or presented via a web interface (if no request has been made through such an interface). Instead, a virtual inquiry 1908 may be generated as described above, for example, based on a mailing list with other assumed data fields provided. At least one solution set may be generated 1902, based on, at least in part, distribution parameters 816 and supply parameters 812, and the set of options may be presented to the consumer. For example, these options may be presented to the consumer via an e-mail to the consumer 1905. The e-mail sent to the consumer may include a link back into the web application to facilitate order processing. The options may also or alternatively be presented to the consumer via mail and/or communicated to the consumer via phone or by other methods. After selection of an option by the consumer 1906, the system and method may optionally proceed to order fulfillment 1907.

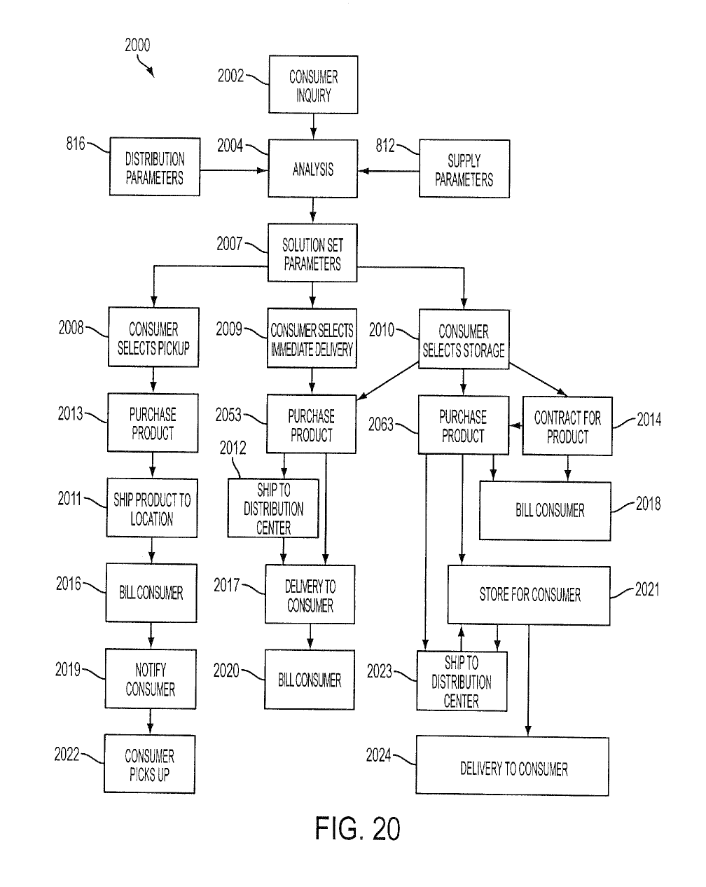

FIG. 20 illustrates one embodiment 2000 of an analysis method consistent with the present disclosure. In the illustrated exemplary embodiment, product may be delivered to the consumer via consumer pickup, via immediate delivery, or after storage on behalf of the consumer. Information on the storage location price and delivery may be included in distribution network parameters 816, along with information on the pickup location price and availability. In response to a consumer inquiry 2002 these are analyzed 2004 along with supply parameters 812 and a solution set is presented 2007.

The consumer may then select pickup 2008, immediate delivery 2009 or storage 2010. If the consumer selects a pick-up option 2008, the consumer may make a purchase 2013, the product may be shipped to the pick-up location 2011, the consumer may be billed 2019 and notified 2019 of the delivery. The consumer may then pick-up 2022 the product at the designated location. If the consumer selects immediate delivery 2009, the consumer may make a purchase from the solution set 2053, the product may be shipped to the consumer 2017, optionally through a distribution center 2012, and the consumer may be billed 2020.

If the consumer selects a storage option 2010, the consumer may make a purchase 2053 and the product may be shipped to a distribution center 2012 before being shipped the consumer 2017. Alternatively, the consumer may purchase the product, the product may be stored for the consumer, e.g. at a distribution center, and the consumer may be billed before delivery of the product to the consumer. Alternatively, the consumer may make a contract for future purchase of the product 2014, before purchase 2063 and billing 2018. The analysis may encompass these various options, along with other potential options and present them to the consumer.

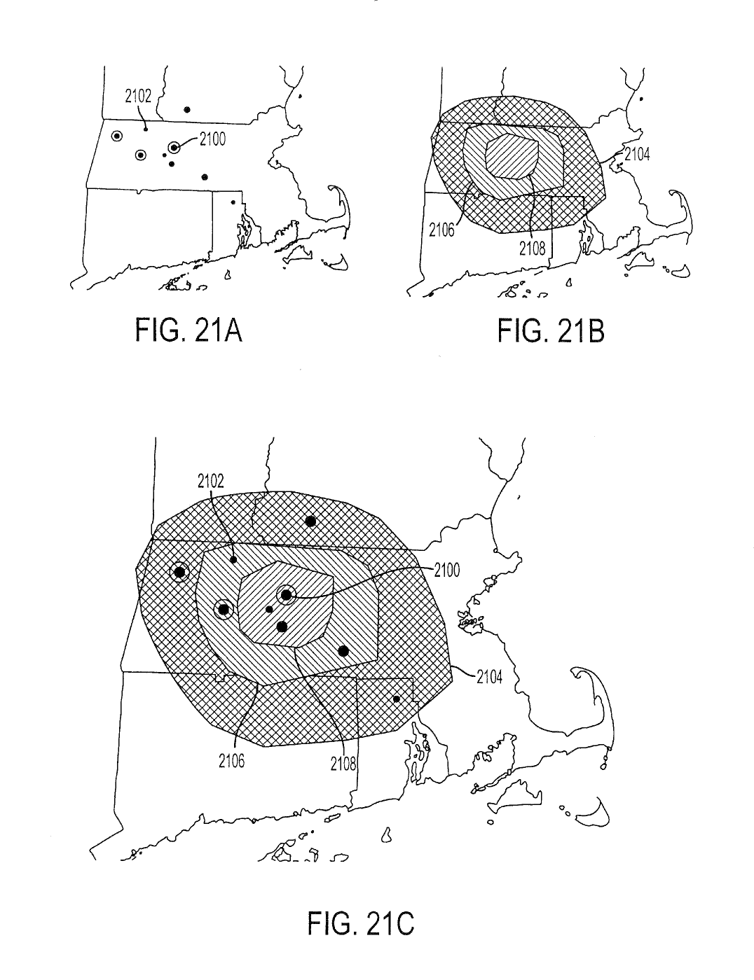

FIGS. 21A, 21B and 21C diagrammatically illustrate one example of how quantity presented to the consumer may be a function of the quantity requested and other distribution parameters 816. In the illustrated exemplary embodiment, the distribution parameters may be designed to set regional minimum and auto-acceptance quantities based on a request's location. Requests coming in for product may be at various quantity levels, as shown in FIG. 21A. Large circles 2100 may indicate requests for truckloads of product; small circles 2102 may represent requests for individual bags of product, as an example. FIG. 21B illustrate how regional minimum and auto-acceptance quantities may be implemented. Various regions 2104, 2106, 2108 on the map have associated minimum and auto-acceptance quantities For example, for a source with location within region 2104 single bags of product may be delivered, but for a request within region 2016 only full truckloads may be delivered.

FIG. 21C illustrates quantity requests from FIG. 21A overlaid on the regions of FIG. 21B. It should be understood that the minimum and auto-acceptance quantities described here may be generated on a dynamic basis. Patterns of demand dynamics may be used to update these minimum and auto-acceptance quantities, which may be driven in part by actual pending orders in the system, trends in ordering patterns or forecasted ordering patterns based on a variety of factors such as population density, seasonal factors or weather patterns. It should also be understood that as an alternative to setting minimums and auto-acceptance quantities by region to filter orders being accepted in a given area, pricing mechanisms may also be employed. For example, in areas of high demand density, pricing to a consumer for product and delivery may be lower than in areas of low demand density. In this manner, the system maintains the ability of the producer or distributor to avoid unprofitable distribution, without setting hard minimum delivery quantities.

The auto-acceptance criteria for each region 2104, 2106, 2108 may be different from minimums. For example, a minimum quantity may represent the smallest quantity that may be delivered to a location within a region under any circumstances whereas an auto-acceptance quantity may represent a quantity above which any orders received by the system will be automatically accepted. There may be a gap or difference between the auto-acceptance quantity and the minimums in which other factors may be used to determine if a request is quoted or an order is accepted as discussed below. For example, if the minimum delivery to an region is one ton of product and the auto-acceptance level is five tons, a request for 3 tons may not be automatically rejected or accepted by the system, and may be considered on the basis of other orders in the area or after review by an appropriate team member.

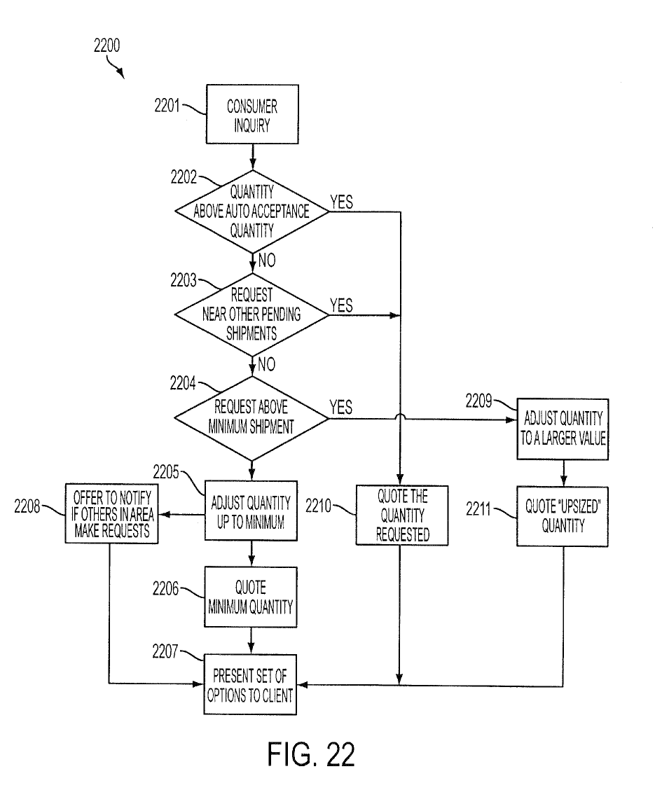

Referring now to FIG. 22, one embodiment 2200 method consistent with the present disclosure is shown in block flow form utilizing the minimum quantity and auto-acceptance quantity parameters. A consumer inquiry 2201 may be received and compared 2202 against and auto acceptance quantity. If the consumer inquiry is above the auto acceptance quantity, then the system may quote the quantity requested 2210. If not, the consumer inquiry may be analyzed 2203 to determine if the consumer inquiry is geographically near other pending shipments. If the consumer inquiry is geographically near other pending shipments, then the system may still quote the quantity requested 2210.

If the consumer inquiry is not above the auto-acceptance quantity and is not geographically near other pending shipments, the consumer inquiry may be compared 2204 against a minimum quantity parameter to determine if the consumer inquiry is above the minimum quantity. If the consumer inquiry is above the minimum quantity, the system may adjust quantity to a larger value 2209, and the quote 2211 “Upsized” quantity. If the consumer inquiry is not above the minimum quantity, the system may adjust 2205 the quantity up to the minimum quantity, quote the minimum quantity 2206, and present a solution set of options 2207 to the consumer based on the minimum quantity. Optionally, if consumer inquiry is below the minimum, the system may offer to notify 2208 the consumer if others in the area make similar requests, and the economics of delivering to that location may thereby improve. Combinations of these channels may also be appropriate in some instances. For example, the system may offer notification if others in the area also request product allowing a smaller delivery, while simultaneously quoting a larger quantity.

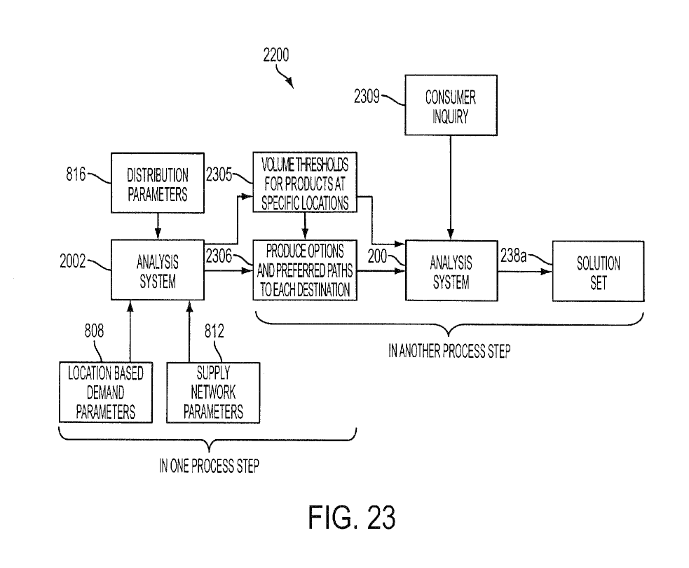

FIG. 23 shows one embodiment 2300 of how the timing of the development of volume thresholds may differ from the timing of response to consumer inquiries. For example, location-based demand parameters 808 may be received as an input at analysis system 200, along with distribution parameters 816 and supply parameters 812. The output of the analysis may include volume thresholds for goods at specific locations 2305 and/or producer options and preferred distribution channels to each destination 2306. These preferred distribution channels may be the channels in the multi-channel distribution network providing the lowest cost route or the shortest time route between a given producer and a specific destination, and may include information on that channel such as the route, the time required, the distribution costs, distribution intermediaries that may be involved and so on. These analyses may be conducted in a single process step, for example in an off-line analysis conducted once a week. Analysis system 200 may generate a solution set 238a based on the consumer inquiry 2309, the volume thresholds 2305 and preferred channels 2306

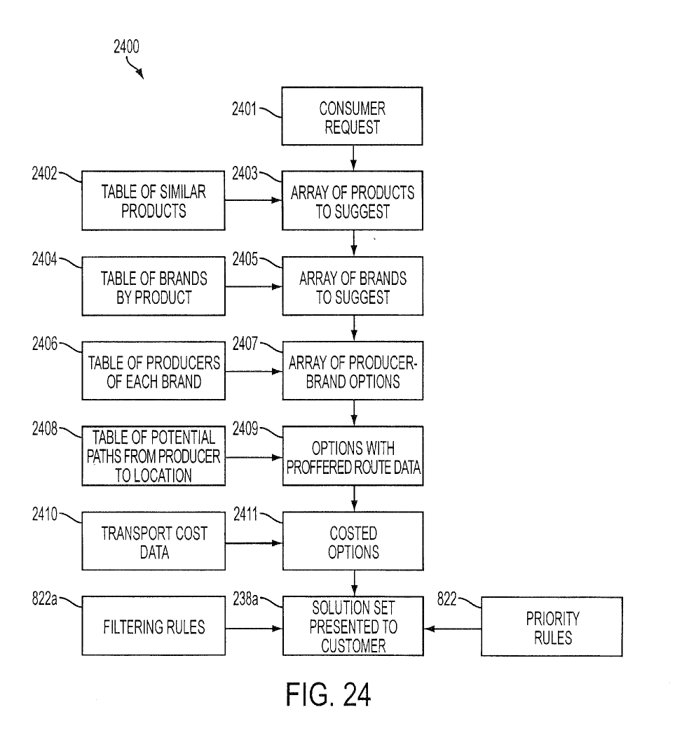

FIG. 24 is a block flow sequence of generating a solution set in response to a consumer inquiry 2401. A table of similar goods 2402 based on the product requested by the consumer may be used to create an array of goods to suggest 2403. A table of brands by product 2404 may then be used to generate an array of brands to suggest 2405. A table of producers for each brand 2406 may be used to generate an array of producer-brand options 2407, which contains combinations of goods, sources and brands that may be associated with the original request, or some subset. Then a table of potential channels for source to location 2408, or other geographic reference data, such as accessing or querying external geographic or mapping databases, may be used to create a set of options with preferred route data 2409. Transportation cost data 2410 may be used to develop a set of costed options 2411, which may also use product cost data obtained from the product sources, or through the supply parameters. Finally, a set of filtering rules 822a and/or priority rules 822 may be used to refine the a solution set 238a presented to consumer.

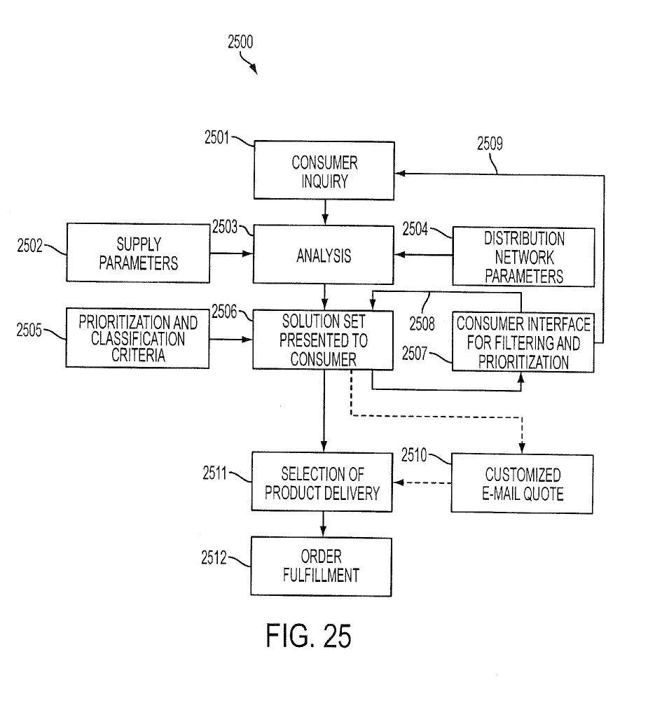

A method consistent with the present disclosure may also or alternatively include an iterative process for generating a solution set or set of options. One embodiment 2500 of such a method is shown in FIG. 25. A solution set or set of options 2506 a solution set including options for purchasing product through a plurality of at least partially separate distribution channels in a multi-channel distribution network may be generated in accordance with any of the embodiments described herein. For example, a consumer inquiry 2501 may be generated and entered into the system, for example, through a consumer interface 802. The analysis system 200 may perform an analysis 2503 of that inquiry, based on, at least in part, one or more of a set of supply parameters 812 and distribution parameters 816.

The consumer interface 802 may be configured to allow the user to input his or her own sorting and/or filtering criteria and to further refine the solution set 2506 using demand parameters 808 According to another embodiment, consumer interface 802 may be configured to generate a new consumer inquiry as (illustrated by arrow 2509) which may be used to generate a new solution set. The sorting and/or filtering may continue until the consumer is satisfied and proceeds to selection of product and delivery 2511 and order fulfillment 2512, or a quote may be sent without being requested (e.g., a confirming e-mail showing a customized e-mail quote 2510 which may contain elements of the solution set presented to the consumer).

While the embodiments described above may be directed to the benefit of a consumer, the present disclosure may also be used by a producer for the benefit of a producer, or by a distributor for the benefit of a distributor. While some of the embodiments described herein may continue to use a consumer inquiry as an example, such systems and methods may also be equally applied for the benefit of a producer or distributor. Also, while the embodiments described herein may be described in the context of a transaction between a user and a producer, the present disclosure may also be used in the context of an auction. For example, a consumer or a group of consumers could use this analysis system to conduct an auction whereby producers and/or distribution intermediaries are bidding competitively for the right to supply to that consumer. Similarly, a producer or group of producers could use this analysis system to conduct an auction whereby consumers and/or distribution intermediaries are competitively bidding for the opportunity to buy product and/or services. Finally, a distribution intermediary may conduct auctions whereby consumers and/or producers are competitively bidding for product contracts and distribution services. It should be understood that such auctions may be conducted as forward auctions, reverse auctions, dutch auctions and other auction formats.

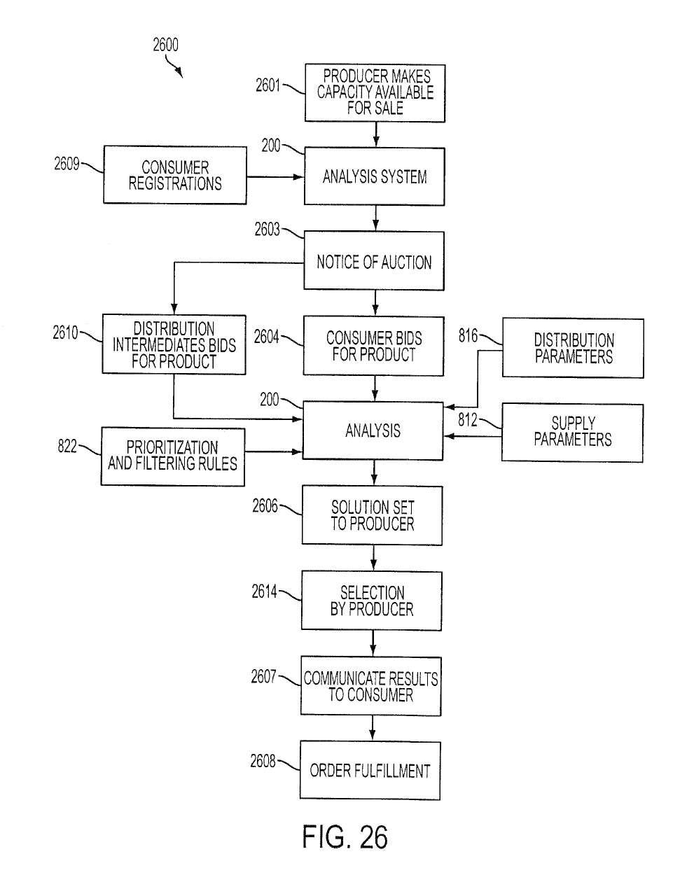

FIG. 26 illustrates one embodiment 2600 of method in block flow form for the benefit of a producer. In the illustrated embodiment, the producer may provide supply data regarding its capacity available for sale 2601 and analysis system 200 that may have access to stored pre-existing consumer registrations 2609 or that may then solicit consumer registrations. The system may issue a notice of auction 2603 to registered consumers and solicit redistributor bids for product 2610 and consumer bids for product 2604. The consumer bids 2604 may then be combined with distribution parameters 816 and supply parameters 812 by analysis system 200 to generate an initial solution set of options that may be filtered according to prioritization and filtering rules 822 to generate a solution set 238b for presentation to producer. The producer may select 2614 from at least one of the options within the solution set and the supplier's selection may be communicated 2607 to the consumers and the order may be processed 2608.

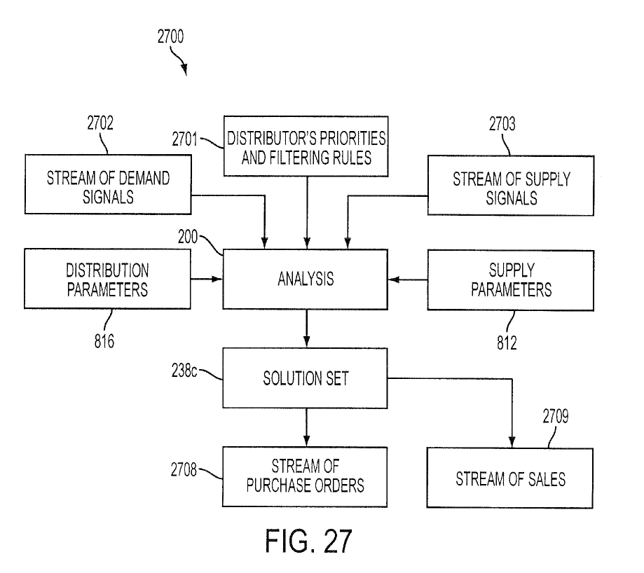

FIG. 27 illustrates one embodiment 2700 of an analysis system and method consistent with the present disclosure for the benefit of a distributor. For example, a distributor's priorities and filtering rules 2701, e.g. as presented as distribution parameters 816 in a distributor interface 804 may be combined with a stream of demand signals 2702 and a stream of supply signals 27033, along with a set of distribution parameters 816 and supply parameters 812 by the analysis system 200 to generate a solution set 238c. The solution set 238c may be presented to the distributor which may then generate a stream of purchase orders 2708 and a separate or associated stream of sales orders 2709.

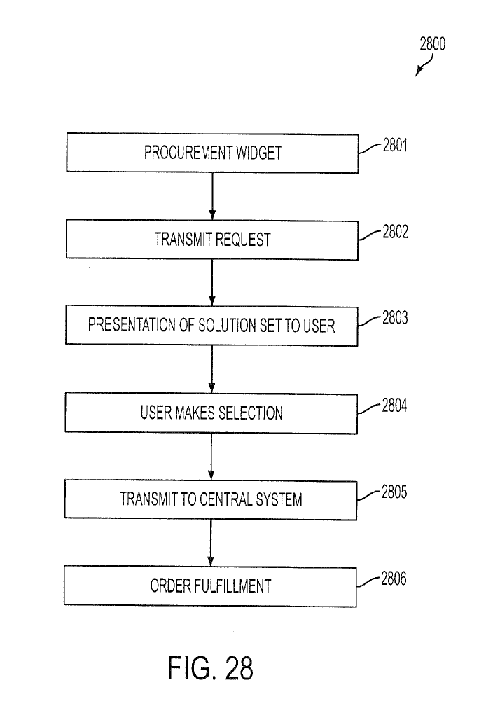

Referring now to FIG. 28, one embodiment 2800 of a distribution system and method according to the present disclosure may include a procurement widget which may be freely shared among users of computer systems. For example, the widget may comprise an application that is readily shared by e-mail, by dragging between application pages, by downloading from another source or being propagated by any number of conventional means of disseminating software code and may also include the code necessary to interact with a central web application. According to one embodiment, the widget may be a file that may appear to a user as an icon that can be readily shared with other users by cutting and pasting or dragging and dropping between application windows. This widget may be e-mailed to other users as a web link or copied and pasted from one user's customizable webpage in a particular application to another user's customizable webpage.

In the illustrated exemplary embodiment, the widget 2801 on a given user's machine may then transmit 2802 a request, which may represent a consumer inquiry as previously described, to a central system. The central system may include an analysis system 200 configured to generate a solution set of options which may be transmitted back to the widget 2801 for presentation to the user 2803. The user may make a selection 2804, which may be transmitted to the central system 2805. Optionally, upon receipt of the selection 2804, the order may be processed 2806. According to one embodiment, the procurement widget 2501 may comprise location based information on the consumer that may be entered by the consumer, or may be autonomously developed, such as by sensing the consumer's location from his IP address.

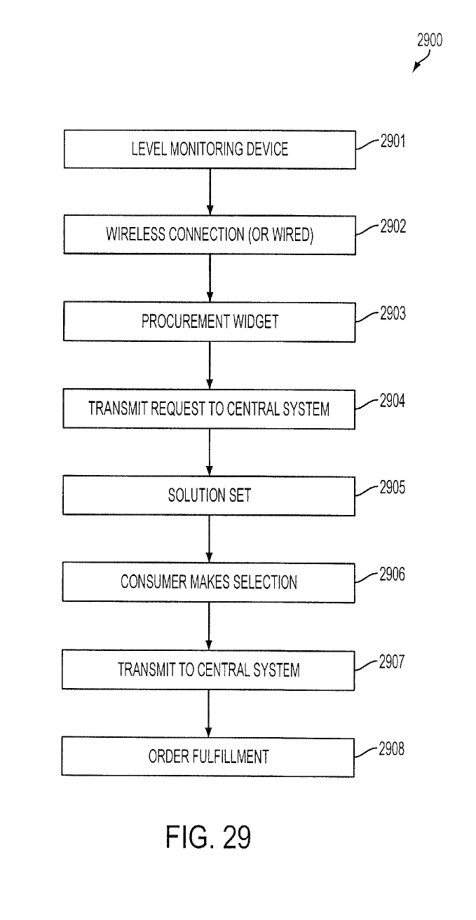

According to a further embodiment 2900, a method consistent with the present disclosure may be configured to automatically monitor a product level and generate a consumer inquiry upon meeting or exceeding a minimum threshold level. Referring to FIG. 29, a consumer's location may include a storage system configured to store a quantity of a product. The storage system may include a level monitoring device configured to monitor a quantity of product contained within the storage system and may be configured to receive consumer definable parameters such as, but not limited to, a minimum quantity storage threshold. The monitoring device may be configured to generate 2901 and/or transmit a signal across a wireless or wired connection 2902 configured to notify a procurement widget 2903 that a minimum quantity storage threshold has been reached and/or exceeded. Upon receipt of the notification, the procurement widget may transmit 2904 a signal to the central system to initiating the process of generating a consumer inquiry as discussed above with respect to FIG. 28.

The level monitoring device and/or the central system may generate a signal to notify the consumer that the minimum quantity storage threshold has been reached and/or exceeded. The central system may also present the consumer with a solution set 2905 for selection 2906 by the consumer. The selection may be transmitted 2907 to the central system and the order may be filled 2908. In one embodiment, the consumer may provide the central system with demand parameters (e.g., price parameters, delivery time parameters, etc.) that the central system may utilize to automatically generate a purchase order, for example, to refill the storage system with the lowest delivered cost option according to pre-established criteria.

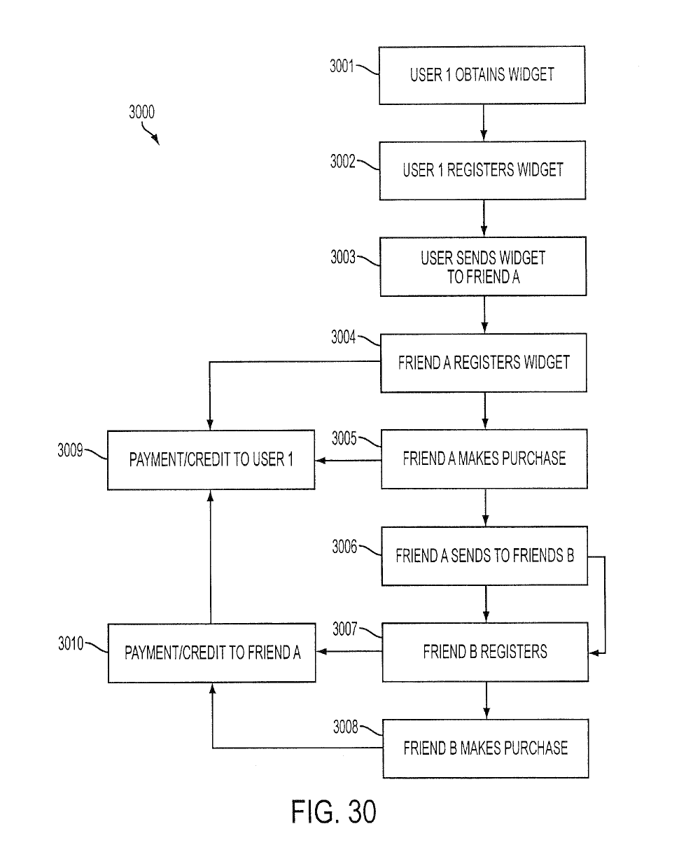

One embodiment 3000 of a multi-layer marketing widget consistent with the present disclosure is shown in FIG. 30. For example, a user may obtain 3001a multi-layer marketing widget and may register it 3002. A variety of ways of registering the widget are possible. For example, the user may act upon the widget to register it, or the widget may automatically register itself upon installation on the user's machine. The user may send 3003 the multi-layer marketing widget to Friend A, and Friend A may register 3004 the widget. When Friend A makes a purchase 3005, value, e.g. a payment or credit, may be issued to the user in response to Friend A's registration of the widget and/or purchase of goods or services. Moreover, Friend A may transmit 3006 the multi-layer marketing widget to Friend B, whereupon Friend B may register 3007 the multi-layer marketing widget. A payment and/or credit may be issued 3009, 3010 to Friend A and B when Friend B makes a purchase 3008. Registration may occur autonomously with the purchase of a product according with the principles described above.

A multi-layer marketing widget consistent with the present disclosure may be used in a successive sequence of referrals, for example from an original user or recipient of the widget to Friend A, to Friend B, to Friend C . . . Friend N, where each person or entity in the referral chain receives some form of compensation. For example, users of the system may be compensated for referring a friend, and also for the referrals generated by that friend, within a multi-layer marketing compensation arrangement.

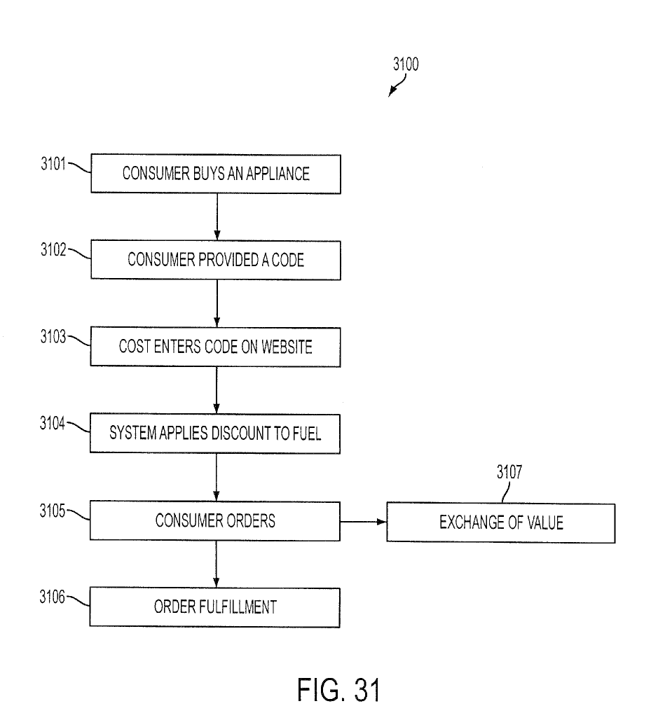

FIG. 31 shows one embodiment 3100 of method consistent with the present disclosure for linking a specific, delivered type of distributed product (for example, but not limited to, a fuel) to an associated product consuming device, e.g. a heating appliance, at a consumer's location. For example, a consumer may buy 3101 an product consuming device, and may be provided 3102 with a code. The code may be entered on a website 3, e.g. using analysis tool 130, which may then apply 3104 a discount to a fuel purchase from one or more vendor associated with the code. If the consumer orders 3205 the fuel from a vendor associated with the code, then an exchange of value 3017 may occur between the seller of the product consuming device and the seller of the fuel and the order may be fulfilled 3106. For example, the fuel seller may pay the seller of the product consuming device a commission, or the seller of the product consuming device may credit the fuel seller for a portion of the fuel. The system and method may also be applied to delivery of more than one product to a particular location. For example, in FIG. 31 it may be advantageous to concurrently deliver both the product and the fuel, and the previously described distribution parameters may include information on the distribution of both elements of the system. The passing of value to a client should be understood to be possible in any form, such as a discount, a credit, a rebate or credit towards other products or services.

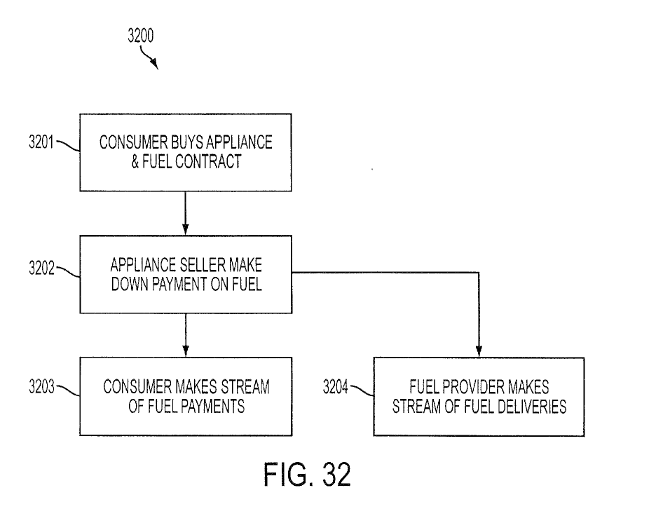

Another embodiment 3200 a method for linking a specific, delivered type of distributed product (for example, but not limited to, a fuel) to an associated product consuming device is shown in FIG. 32. For example, a consumer may buy 3201 both a product consuming device and a fuel contract substantially concurrently. The product consuming device provider may make a down payment on the fuel 3202, after which the consumer may make a stream of payments 3203 to the product consuming device provider, while the fuel provider makes a stream of deliveries 3204. The product consuming device provider and fuel provider may be the same or different parties, and the exchange of value between product consuming device provider and fuel provider (if any) may take several forms such as, but not limited to, a cash exchange, credit exchange, or the like.

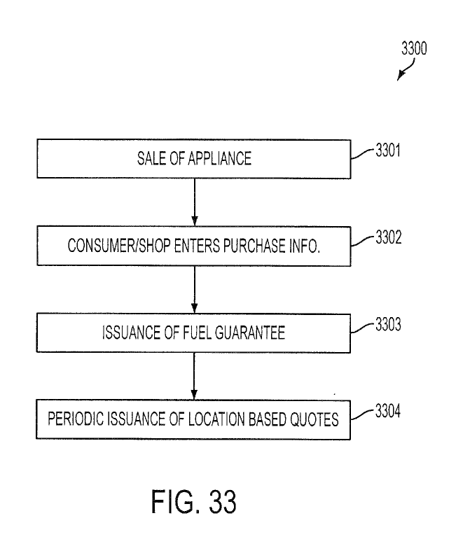

FIG. 33 illustrates another embodiment 3300 of a method consistent with the present disclosure. Upon sale 3301 of a product consuming device requiring a stream of fuel, a consumer or shop that sold the product consuming device may enter 3302 information relating to the purchase (such as, but not limited to, the serial number of the product consuming device, the location of the product consuming device, the purchase date of the product consuming device, or the like) into a website which may prompt issuance of a fuel guarantee 3303 from a fuel supplier. A user who has such a guarantee may then be issued a stream of location based quotes 3304 consistent with any embodiment described herein.

Another embodiment consistent with the present disclosure may also or alternatively include a capability for aggregating delivery of goods and/or services purchased by one or more users. Such a pooling activity may allow one or more users to pool delivery of their purchases to achieve savings in delivery costs and/or service costs. For example, biomass heating fuels may be delivered by weight, e.g., ton and/or volume, e.g., cord. Delivery of bulk quantities of such biomass heating fuels on a truck may present unique distribution challenges. Optimizing trucking parameters, for example, loading a truck for delivery of a truckload to one or a few geographically close delivery locations, may decrease the delivery costs of the biomass heating fuels. Achieving a truckload may be accomplished by pooling shipments of one or more consumers. Pooling consumer goods is not limited to biomass fuels. A biomass fuel is only one illustrative embodiment of goods that may be shipped to a user and may therefore benefit from pooling shipments.

A system and method for aggregating delivery of goods or services may be implemented using an aggregated delivery coordination system accessed through a computer network by users interested in participating in pooling activities. Similar to the analysis system 200 described above and shown in FIG. 2, the aggregated delivery coordination system may reside on and may be executed by a computer 240 that is connected to computer network 242. The instruction sets and subroutines of the analysis system 200 may be stored on a storage device 248 coupled to the computer 240 and may be executed by one or more processors and one or more memory architectures incorporated into the computer 240. Data and information received and/or generated by the aggregated delivery coordination system may be stored on a storage device 248 coupled to the computer 240. The system and method for aggregating delivery of goods or services may also be implemented using other computerized implementations as described herein and/or as known to those skilled in the art.

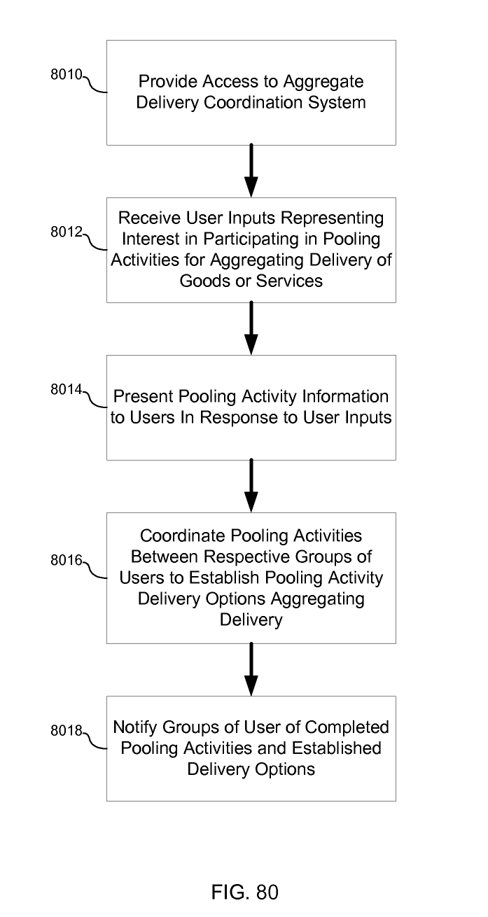

One embodiment of the method for aggregating delivery of goods or services is illustrated generally in FIG. 80. According to this embodiment, access is provided 8010 to the aggregate delivery coordination system on the computer network, for example, using web pages as described in greater detail below. The aggregate delivery coordination system receives 8012 user inputs representing interest in participating in pooling activities for aggregating delivery of goods or services. The user inputs may include, for example, requests to join existing pooling activities, requests to view a status of existing pooling activities, and requests to start new pooling activities.

The aggregate delivery coordination system presents 8014 pooling activity information to the users in response to the user inputs representing interest. The pooling activity information may include lists of existing pooling activities that a user may join as well as the goods or services associated with those existing pooling activities and the cost and available quantity of those goods or services. The pooling activity information may also include information for starting a new pooling activity, such as available goods/services, cost and delivery locations. The pooling activity information may further include maps representing user locations, delivery locations, and existing pooling activities associated with those users and/or delivery locations.

The coordination system also coordinates 8016 pooling activities between respective groups of the users to establish pooling activity delivery options aggregating delivery of goods or services for the respective groups. Coordinating pooling activities may include facilitating communications between users within a group of users interested in one of the pooling activities, for example, between a user wishing to join a pooling activity and a pooling activity coordinator. Coordinating pooling activities may also include providing information for determining if users should join certain pooling activities, for example, based on the type of goods or services, an available quantity, a delivery location, and/or a cost.

The coordination system further notifies 8018 the respective groups of users of completed pooling activities and the delivery options established for those groups. After a delivery option has been established by a pooling activity, the pooling activity may be completed or closed, for example, by the pooling activity coordinator. Notifying users of completed pooling activities may include requests for confirmation of participation, requests for payment, or notices of delivery.

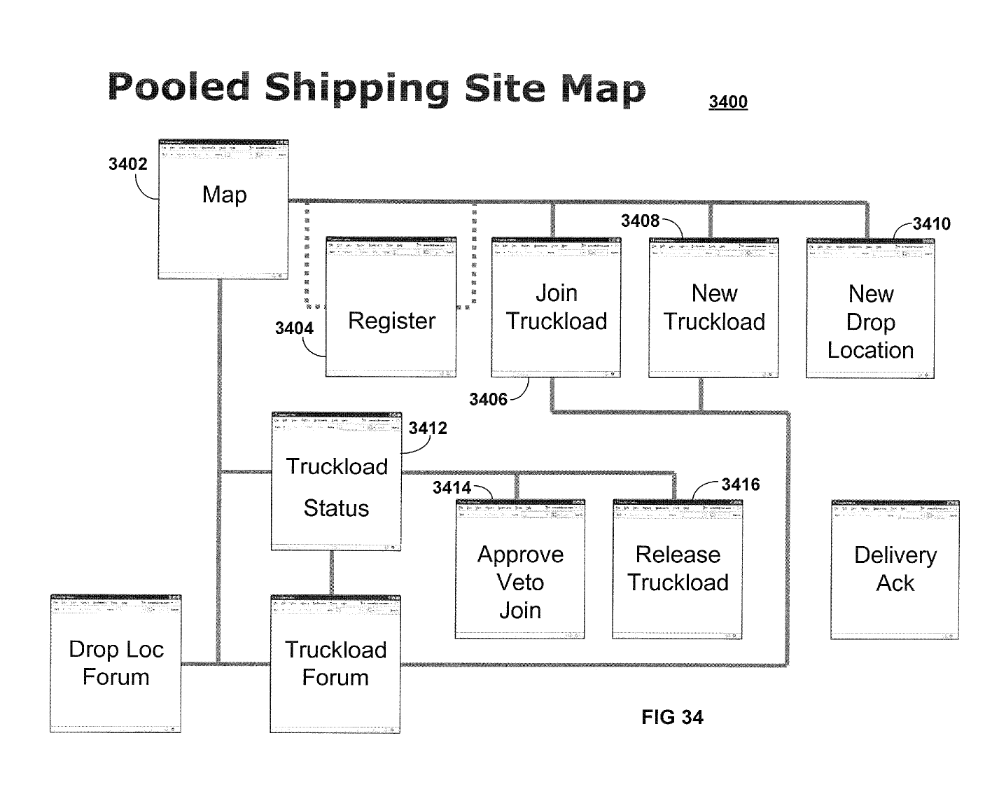

In one embodiment described in greater detail below, the aggregate delivery coordination system receives user inputs, presents pooling activity information, and coordinates pooling activities via a web-based interface. FIG. 34 illustrates an example of a site map 3400 for a pooling activity, e.g., pooling shipping. The site map 3400 may include a Map page 3402. The Map page 3402 may be the first page that a user will encounter. A user may be a consumer, e.g., a previously registered customer or an anonymous user and/or a coordinator, and/or may represent a drop location and/or a distribution center. If an anonymous user initiates a transaction, registration information may be requested from the anonymous user. A transaction may include joining a truckload, starting a truckload, etc. Registration information may include name, screen name, password, email address, geographic location signifier, e.g., Zip Code, etc.

As used herein, a coordinator may be responsible for coordinating a pooling activity, e.g., a pooling of goods for a truckload and/or an aggregation of services. A coordinator may initiate a truckload and/or may coordinate contents of a truckload. A coordinator may take action to allow a user to participate in a delivery or route. A coordinator may take action to disallow a user from participating in a delivery or route. In an embodiment, a coordinator may be a consumer. A coordinator may have financial responsibility for a truckload and may be provided consideration for the coordination services. In another embodiment, a coordinator may be responsible for coordinating at least a portion of a shipment or at least a portion of a route.

As used herein, a drop location, i.e., a delivery location, may be any location where a truck may unload or be unloaded. For example, a drop location may include a church, a parking lot, a school, a business or the like. A drop location may be a distribution center. A drop location may be used once or may be used multiple times. A drop location may be qualified based on equipment and/or services available. Equipment and/or services may include loading docks, forklifts, pallet jacks, ability to accommodate trucks of a particular size, etc.

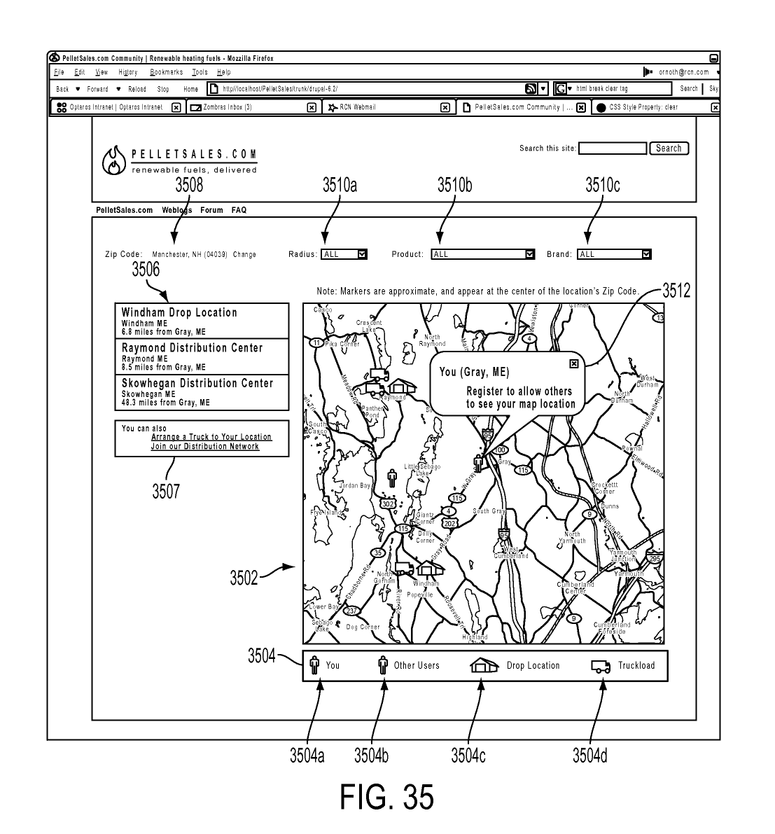

FIGS. 35 through 41 depict illustrative embodiments of a Map page corresponding to Map page 3402. Each Map page may include a map 3502. The map 3502 may include roadways, towns and cities and/or bodies of water. The map 3502 may include details generally available in a road atlas.

The Map page may further include a legend 3504. The legend 3504 may include icons for a user (“You”) 3504a, Other Users 3504b, Drop Locations 3504c and Truckloads 3504d. The You 3504a and Other Users 3504b icons may be further differentiated by color. Any one or more icons may be positioned on the map 3502. The position of each icon may indicate its approximate geographic location. For example, the Map page shown in FIG. 35 includes an icon for You, positioned in or near Gray, Me., an icon for one or more Other Users, positioned between Little Sebago Lake and Jordan Bay, icons for Drop Locations (including Distribution centers) in or near Windham and Raymond, and icons for a Truckload in or near Windham and two Truckloads in or near Raymond. A Truckload icon may be configured to indicate a load status of a truck, e.g., partially full, full or happy.

In an embodiment, the Map Page 3402 that the user first encounters may include the map 3502 without icons positioned on the map. The user may be provided user-selectable options. User-selectable options may include creating a person icon, e.g., You, becoming a drop location, finding a drop location, emailing to friends and/or going to a forum. In this manner, a user may initiate a pooling activity.

The Map page may further include a listing 3506 of distribution centers and/or drop locations. The listing 3506 may include menus, as will be discussed in more detail below. The Map page may include a list of user-selectable options 3507 related to drop locations and distribution centers. For example, a user may join a distribution network, e.g., add a drop location and/or distribution center, and/or arrange a truck to a delivery location.

The Map page may include a user-selectable geographic location signifier 3508 such as a Zip Code. The geographic location signifier 3508 may be used to define an approximate center of the map 3502 illustrated on the Map page. The geographic location signifier 3508 may correspond to a location of the user. The Truckload and Drop location and/or Distribution Center icons, if any, that are closest, geographically, to the user-selected geographic signifier may be highlighted. The Map page may further include one or more user-selectable menus, e.g., menus 3510a, b and c.

In an embodiment, the menus 3510a, b, c, may be pull-down menus. A first menu 3510a may include distances, e.g., radii about the geographic location signifier 3508. These distances may provide a scale and a range for the map 3502 displayed on the Map page. The distance menu 3510a may include a selection of predefined distances and may have, as a default value, ALL distances.

A second menu 3510b may include a list or lists of products, for example, heating fuels such as biomass. The list is not limited and may include any products and/or services that may be available. The products and/or services may be grouped in categories. A user may select a category for display of products and services within that category. The menu may have, as a default value, ALL categories and/or all products and/or services. A third menu 3510c may include a list of brand names and/or trade names related to the products and/or services available. This menu 3510c may likewise default to ALL names.

FIG. 35 illustrates an example of a Map page for an anonymous user. A popup balloon 3512 may be displayed on the Map page. The balloon 3512 may be anchored to a location corresponding to the user's user-selectable geographic location signifier 3508. For example, the location may be an approximate center of an area corresponding to a Zip Code. For the anonymous user, the balloon 3512 may include an invitation to register. The balloon may be collapsible by the user.

The exemplary pooled shipping site map depicted in FIG. 34 may include a Register page 3404. An anonymous user who selects Register from a popup balloon, e.g., popup balloon 3512, may be requested to provide registration information at the Registration page 3404. Registration information may include: name, screen name, password, email address and geographic location identifier such as Zip Code. A default screen name may be provided. For example, a user's default screen name may be the user's first name and first initial of the user's last name. The dotted lines connecting the Register page 3404 to a branch from the Map page 3402 indicate a conditional path between the Map page 3402 and the Register page 3404. The condition may be that a user is an anonymous user. After a user has registered, the user may choose to display the user's screen name, positioned on the Map page, relative to the user's geographic location identifier.

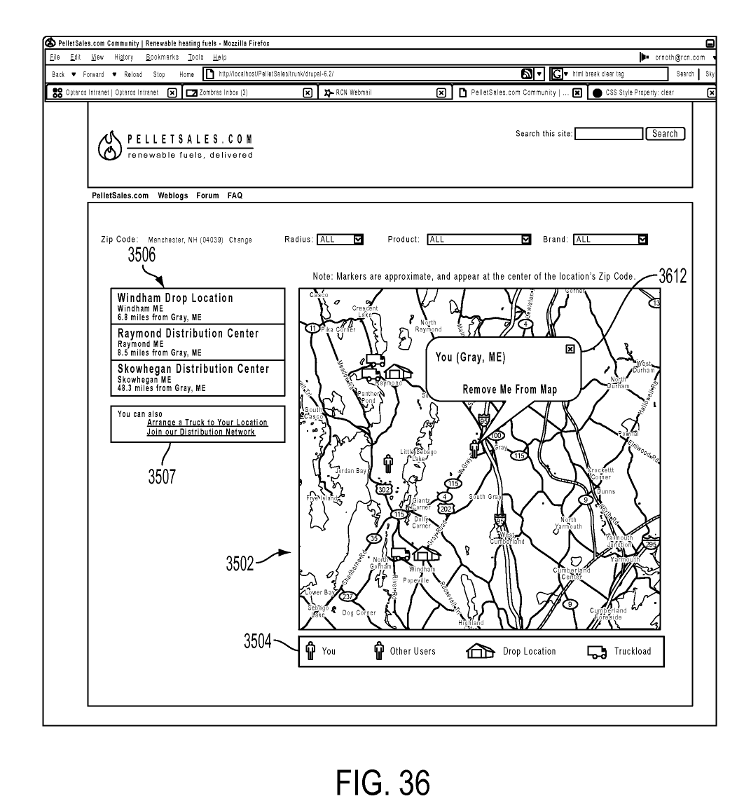

FIG. 36 illustrates an example of a Map page for a registered user. A popup balloon 3612 corresponding to the registered user may be displayed. The popup balloon 3612 may be anchored to a location corresponding to the registered user's geographic location, e.g., Zip Code. The popup balloon 3612 may include an option allowing the registered user to remove himself or herself from the Map page. A system administrator may also remove a registered user from the Map page. The system administrator may remove a registered user by modifying a database. The popup balloon may further include a link to the registered user's email address. The registered user may be provided an option of removing the link to the registered user's email address.

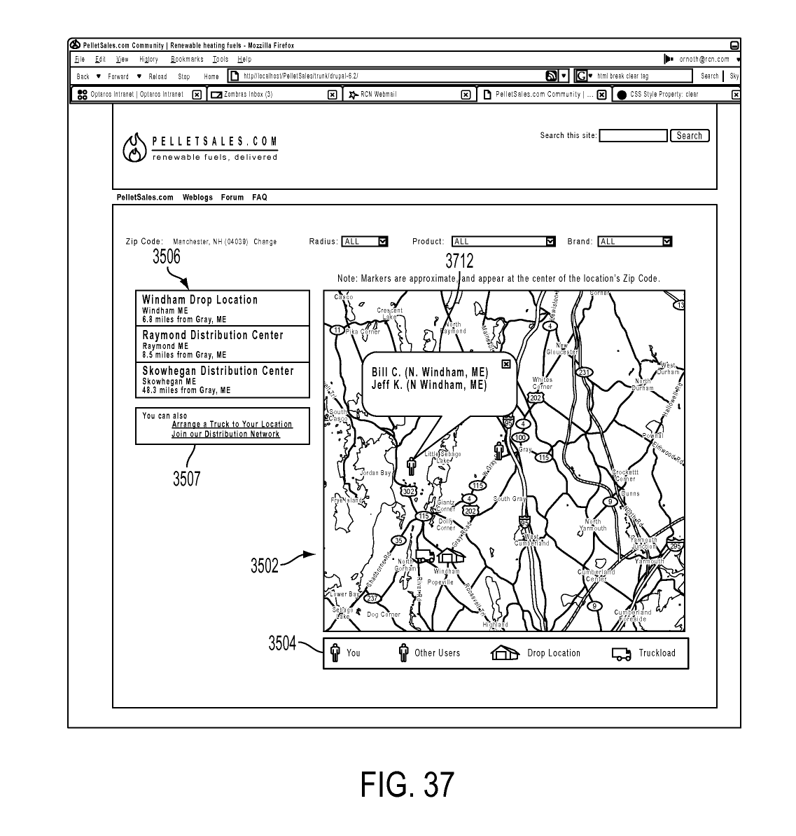

FIG. 37 illustrates an example of a Map page showing a popup balloon 3712 for Other Users within a radius of You. One popup balloon may include one or more other users that may have a common geographic location signifier. For example, the popup balloon shown 3712 includes two other users. Each Other User's screen name may be displayed in the popup balloon 3712. A location of each Other User, e.g., town or city and state, may be displayed. The popup balloon 3712 may be configured to link to an Other User's email address when the Other User's name is selected. The popup balloon 3712 may be collapsible by a user.

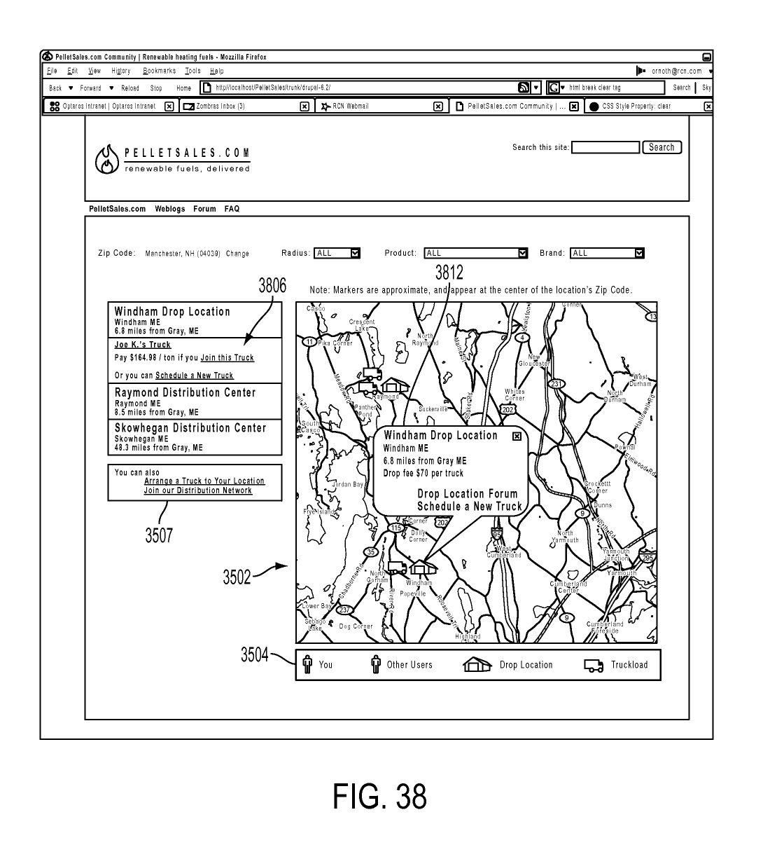

FIG. 38 illustrates an example of a Map page showing a popup balloon 3812 for a drop location. The popup balloon 3812 may be anchored to the geographic location of the drop location. The Map page may also include an accordion menu item 3806 relative to a truck associated with the drop location. This menu item 3806 may be displayed in the listing of drop locations and distribution centers 3506. The menu item 3806 may include a listing of trucks associated with the drop location. For each truck, the listing may include an identifier for the truck, e.g., Joe K.'s Truck, and a cost per unit, e.g., price per ton, for products shipped on this truck. The listing may further include links for joining this truck and/or scheduling a new truck.

The popup balloon 3812 may include an identifier for the drop location, e.g., “Windham Drop Location.” The popup balloon 3812 may further include geographic information such as a town and state for the drop location and/or a distance from the user-selectable geographic location. The popup balloon 3812 may include a per truck drop fee associated with the drop location. The per truck drop fee may be dynamically updated, e.g., as users join and/or leave a truck. The popup balloon 3812 may include other information such as a drop location rating. The drop location rating may include ratings and/or comments from one or more users. The popup balloon 3812 may include a user-selectable link to a drop location rating entry page, a Drop Location Forum and a link to other functions such as scheduling a new truck.

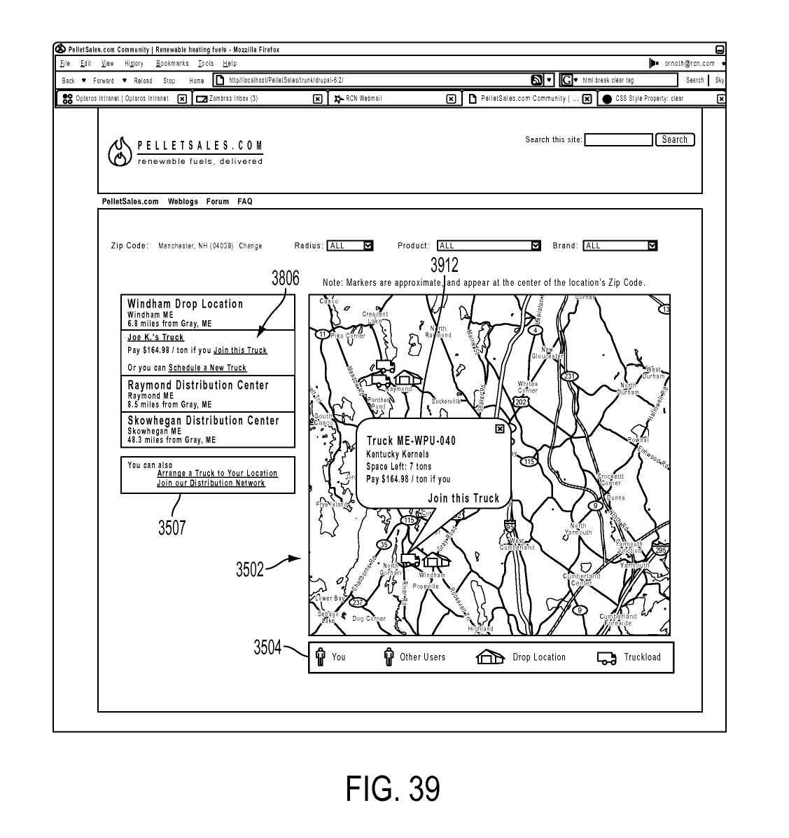

FIG. 39 illustrates an example of a Map page showing a popup balloon 3912 for a truck associated with a drop location, e.g., the drop location associated with popup balloon 3812. The popup balloon 3912 may include a unique truck identifier that identifies that truck. The popup balloon 3912 may further include information regarding products that may be on the truck, e.g., biomass fuels. The popup balloon 3912 may further include an indication of remaining space available on the truck, if any, e.g., by volume and/or by weight, and a cost per volume and/or weight for shipping products on the truck. The popup balloon 3912 may include a link to other functions such as joining the truck. An icon signifying a truck associated with a drop location may remain on the Map page until removed by a System Administrator. For example, a System Administrator may remove an associated truck icon after the truck has delivered a load.

A Join Truckload 3406 page may be reached from the Map page 3402 when Join this Truck is selected. Join this Truck may be selected from the listing 3506 of distribution centers and/or drop locations, e.g., menu item 3806, and/or a Truckload popup balloon, e.g., popup balloon 3912. At the Join Truckload page 3406, a user may join a truckload. The user may be required to specify a quantity to be shipped. The user may also be provided with any terms and conditions that relate to a transaction. For example, a user may be provided with purchase and/or shipping terms and conditions.

A Truckload Coordinator may coordinate a total quantity of goods to be shipped on a truck. A user may join a truck regardless of a quantity of goods currently committed to a truckload. The Truckload Coordinator may manage which goods are ultimately shipped on a particular truck. The number of users that may join a particular truck may be limited. For example, the number of users may be limited to five. From the Join Truckload page 3406, a user may send a personal message to the Truckload Coordinator. User entries via the Join Truckload page 3406 may be provided to the Truckload Coordinator, via email for example, and/or posted to a forum page for that truckload.

The Join Truckload page 3406 may include an acknowledgement page. The acknowledgement page may include a link to the forum page for that truckload. The acknowledgement page may further include an option for sending emails to friends. This option may facilitate filling a truck with goods for delivery local to the user and thereby increase the likelihood that a truck will be full.

A New Truckload page 3408 may be reached from the Map page 3402 when Schedule a New Truck is selected. Schedule a New Truck may be selected from the listing 3506 of distribution centers and/or drop locations. For example, selecting a drop location icon on the map 3502 may result in menu item 3806 being displayed in the listing 3506 of distribution centers and drop locations. This menu item 3806 may include a user-selectable option for scheduling a new truck.

The New Truckload page 3408 may include a list of options and price per unit for a product and/or service. The options and price per unit may be based on a brand, mode and/or geographic location of the user. Mode may include the type of truck, e.g., flat or box. The price per unit may be calculated and/or recalculated when the geographic location of the user differs from the geographic location of the Drop Location. The Drop Location fee may not be included in this calculation and may be indicated separately, as discussed above. The user may specify and/or select a product and/or service name, brand, destination, truck description and mode, e.g., flat or box truck, depending on Drop Location capability. Drop location capability may depend, for example, on whether the drop location has a loading dock and/or a forklift. The user may provide comments in the New Truckload page 3408.

The New Truckload page 3408 may provide terms and conditions to the user. A capacity of a truck, i.e., quantity available for a truckload may also be specified. Such capacity information may be provided to a Truckload Coordinator. Similar to the Join Truckload page 3406, the New Truckload page 3408 may include an acknowledgment page. The acknowledgement page may include a link to a forum page for the new truckload and an option for sending emails to friends.

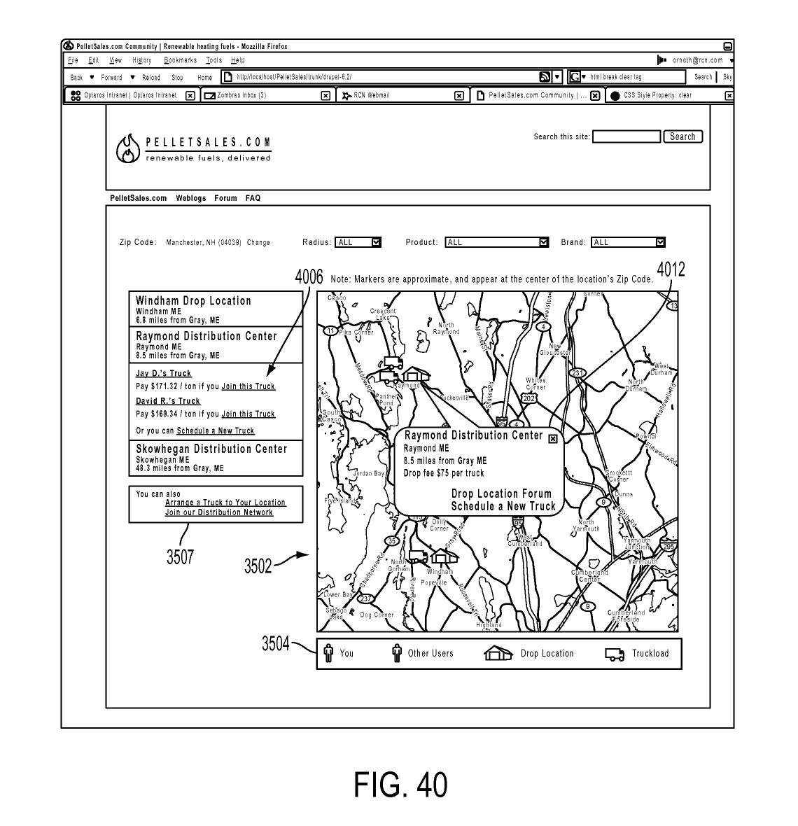

FIG. 40 illustrates an example of a Map page showing a popup balloon 4012 for a distribution center. The Map page may also include an accordion menu item 4006 relative to a truck associated with the distribution center. This menu item 4006 may be displayed in the listing of drop locations and distribution centers 3506. The menu item 4006 may include a listing of one or more trucks associated with the distribution center. For each truck, the listing may include an identifier for the truck, e.g., Jay D.'s Truck, and a cost per unit, e.g., price per ton, for products shipped on this truck. The listing may further include links for joining this truck and/or scheduling a new truck.

The popup balloon 4012 may include an identifier for the distribution center, e.g., “Raymond Distribution Center.” The popup balloon 4012 may further include geographic information such as a town and state for the distribution center and/or a distance from the user-selectable geographic location. The popup balloon 4012 may also include other information such as a per truck drop fee associated with the distribution center. The popup balloon 4012 may include a user-selectable link to a Drop Location Forum and a link to other functions such as scheduling a new truck.

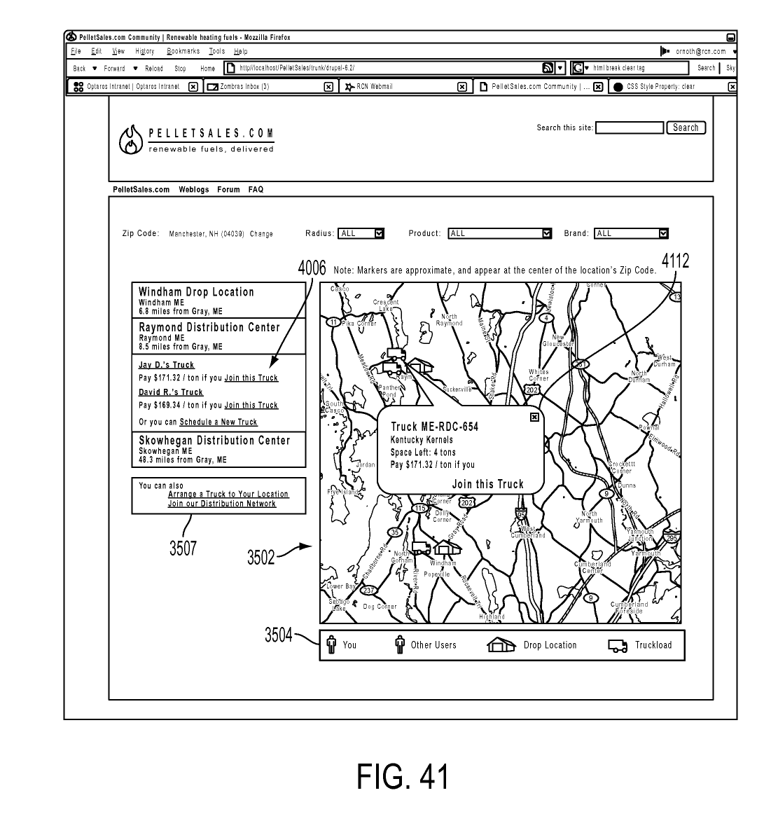

FIG. 41 illustrates an example of a Map page showing a popup balloon 4112 for a truck associated with a distribution center, e.g., the distribution center associated with popup balloon 4012. The popup balloon 4112 may include a unique truck identifier that identifies that truck. The popup balloon 4112 may further include information regarding products that may be on the truck, e.g., biomass fuels. The popup balloon 4112 may further include an indication of remaining space available on the truck, if any, e.g., by volume and/or by weight, and a cost per volume and/or weight for shipping products on the truck. The popup balloon 4112 may include a link to other functions such as joining the truck.

Continuing with FIG. 34, a New Drop Location page 3410 may be reached from the Map page 3402. For example, a user may arrive at the New Drop Location page 3410 by selecting Arrange a Truck to Your Location or Join Our Distribution Network from the menu of user-selectable options 3507 of the Map page. The New Drop Location page 3410 may include user instructions and Terms and Conditions relating to drop locations, for example. A user may provide information related to a proposed drop location. The information may include a name, address including Zip Code, a drop location coordinator, hours of operation, a description and/or comments related to the drop location and equipment available at the proposed drop location. Examples of equipment available may include forklift, loading dock, and/or pallet jack. The user may also indicate whether this drop location is available for a one time use or may persist. The user may further indicate fees associated with the drop location. Drop location fees may be divided across products by quantity shipped, e.g., by weight and/or by volume. A drop location may appear on the Map page 3402 when the user completes a new drop location transaction and a Drop Location Forum may be generated.

A Truckload Status page 3412 may be reached from the Map page 3402, for example, when a user selects a truck name from the drop location/distribution center menu, e.g., menu item 3806. The Truckload Status page 3412 may include a number of parameters related to the truckload. The parameters may include the truckload identifier, e.g., name; truckload status, e.g., full, partially full; a description and/or comment field; destination; brand or brands of product in the truckload; capacity remaining and name of the truckload coordinator. The Truckload Status page 3412 may further include a link to a Truckload Forum associated with that truckload. For each person with products associated with the truckload, name, product, quantity, approval and payment status may be indicated. When the truckload status becomes full, an email notification may be provided to the truckload coordinator.

An Approval page 3414 may be reached from and return to the Truckload Status page 3412. The Approval page 3414 may include an editable email to a customer. The editable email may include approval status, for example. The Truckload Coordinator may adjust user quantity values at the Approval page 3414. For example, a user quantity may be adjusted to conform to volume and/or weight requirements. For example, a product, such as biomass fuel, may be purchased in multiples of a weight value such as a ton. In another example, a product may be restricted to a particular physical dimension, e.g., skid and/or pallet size. Adjustments in user quantities may be communicated via the editable email to the customer. A customer may also be requested to invite friends to join, e.g., via the editable email.

A Release Truckload page 3416 may be reached from and return to the Truckload Status page 3412. The Release Truckload page 3416 may include an updated quote for each product in a truckload. For example, a quote may be received from an MS-SQL server that does not include the Drop Location fee. This quote may be updated to include the Drop Location fee. The Drop Location fee may be divided proportionally between truckload users according to a quantity of product associated with each user. The Release Truckload page 3416 may further include a description/comment field. A confirmation process, discussed in more detail below, may be initiated at the Release Truckload page 3416. An email may be sent to all users with final pricing information and a request for order confirmation. A user may change and/or cancel an order prior to release of a truckload.

The Truckload Coordinator may access the Truckload Release page 3416 after approval of the final customer for a truckload. The Truckload Release page 3416 may display final pricing and the Truckload Coordinator may then release the truck, i.e., truck is ready for dispatch for delivery. Confirmation emails may be provided to all customers associated with the truckload. Customers may access the Truckload Status page 3412 and confirm their orders. When the last customer confirms, payment request emails may be sent to all confirming customers. Customers may then return to site to make payment. The truckload may be dispatched when a last payment is received. Once delivery has been made, a supplier or suppliers may be notified that delivery has been made. For example, the Truckload Coordinator may provide a delivery acknowledgement to the supplier or suppliers. Upon receipt of the delivery acknowledgement, a Drop Location payment may be provided to a Distribution Center and/or Drop Location Coordinator. The Truckload Coordinator may receive compensation for coordinating the truckload.

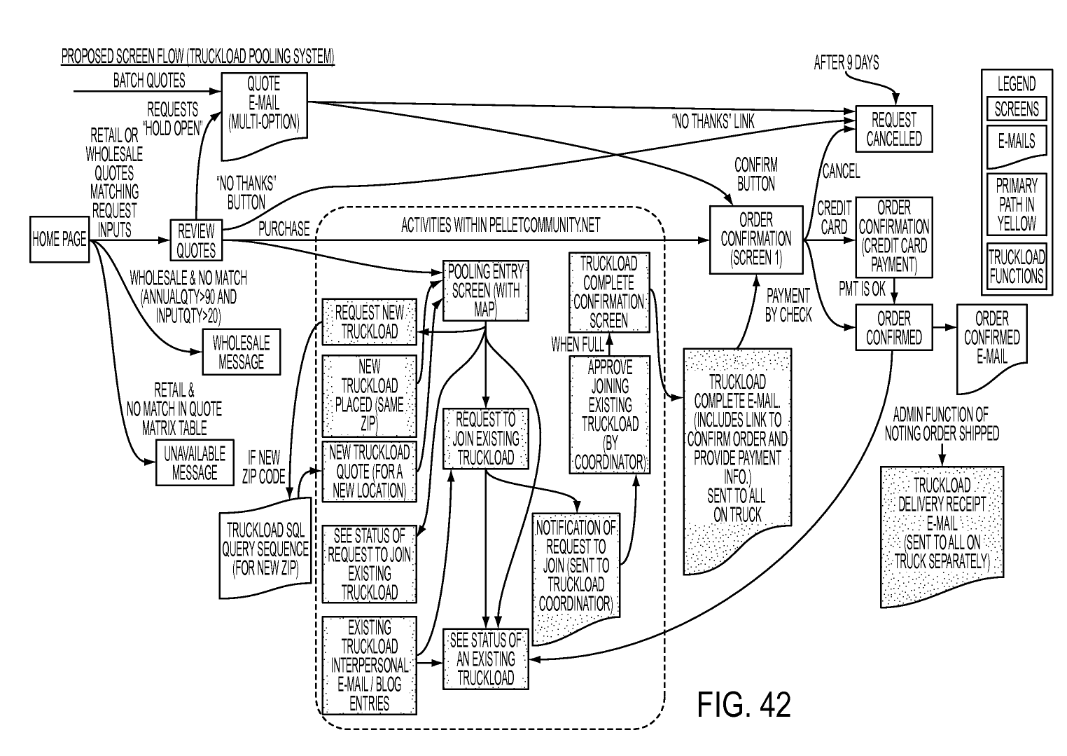

FIG. 42 illustrates an exemplary embodiment of activities and flow between the pages discussed above. FIG. 42 further illustrates an example of interconnections between quotations for products and/or services, the truckload pooling system and a payment system.

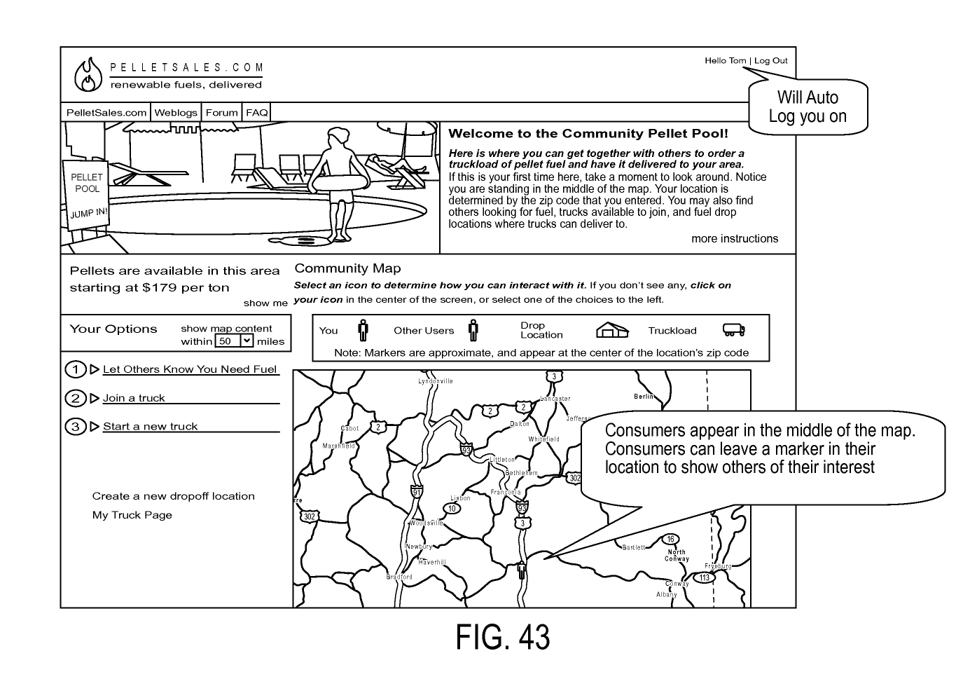

FIGS. 43 through 62 illustrate examples of screens that may displayed to facilitate a user's, e.g., consumer's, participation in a pooling activity. FIG. 43 depicts an illustrative map page that may allow a user to indicate interest in participating in a pooling activity. For example, the user may be provided an option for notifying others of the interest in participating. For example, the user may be provided an option for joining a truck and/or starting a new truck. For example, the user may be provided an option for creating a new delivery, i.e., drop-off, location. In FIG. 43, a biomass fuel product, e.g., pellet fuel, is shown as a good that may be pooled. The biomass fuel product is used for illustrative purposes only. Any goods and/or services that may be pooled is consistent with the present disclosure.

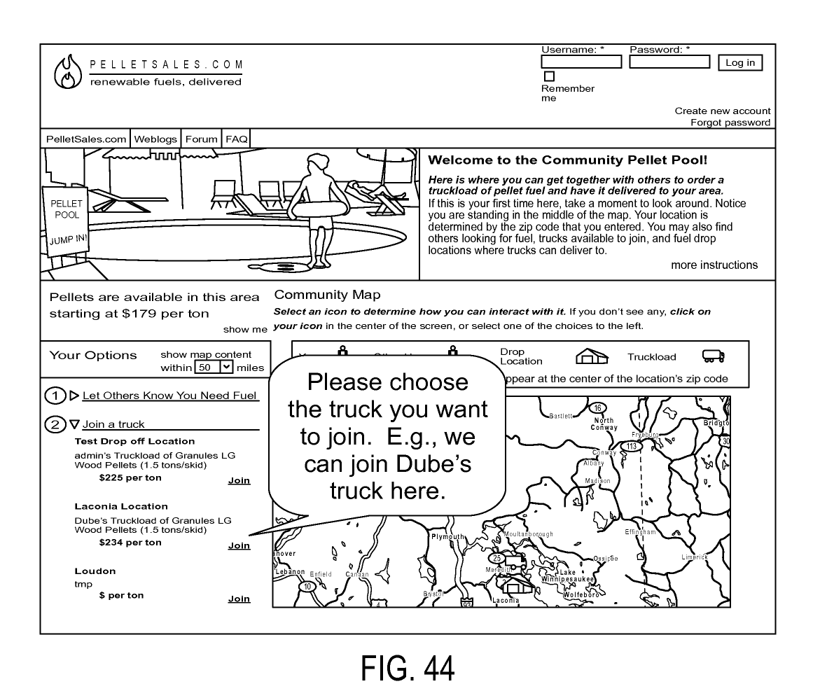

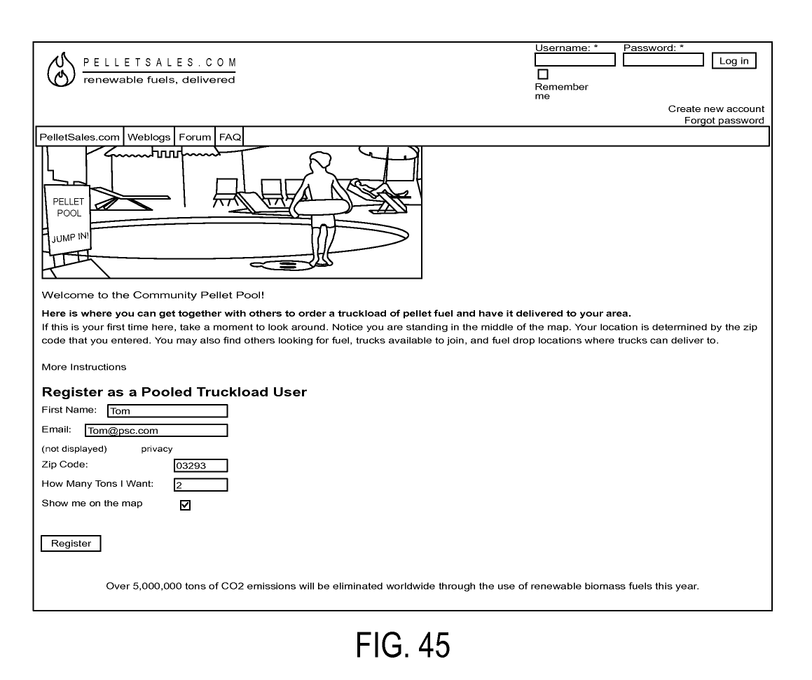

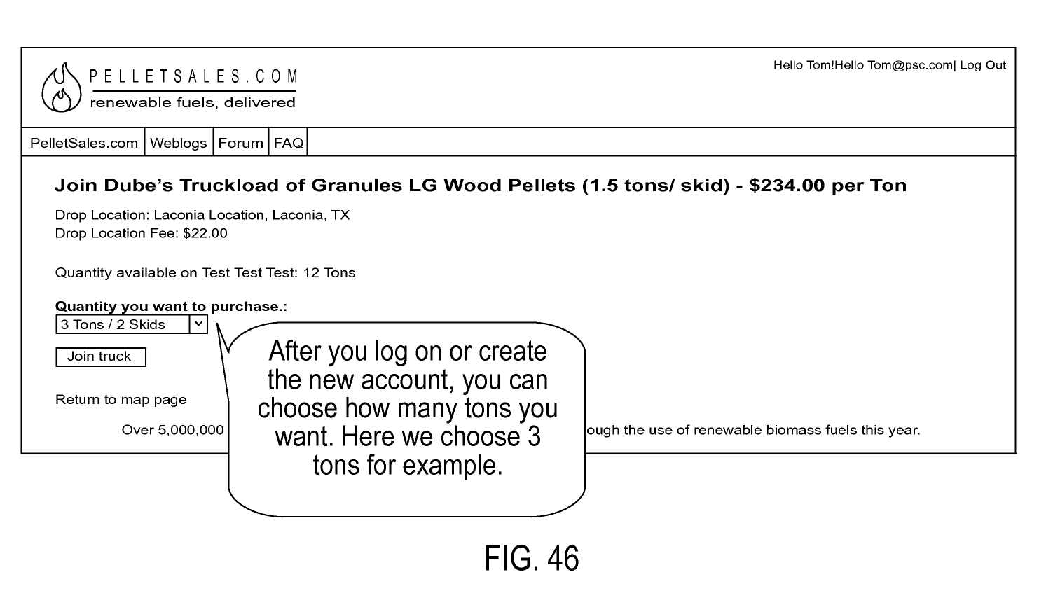

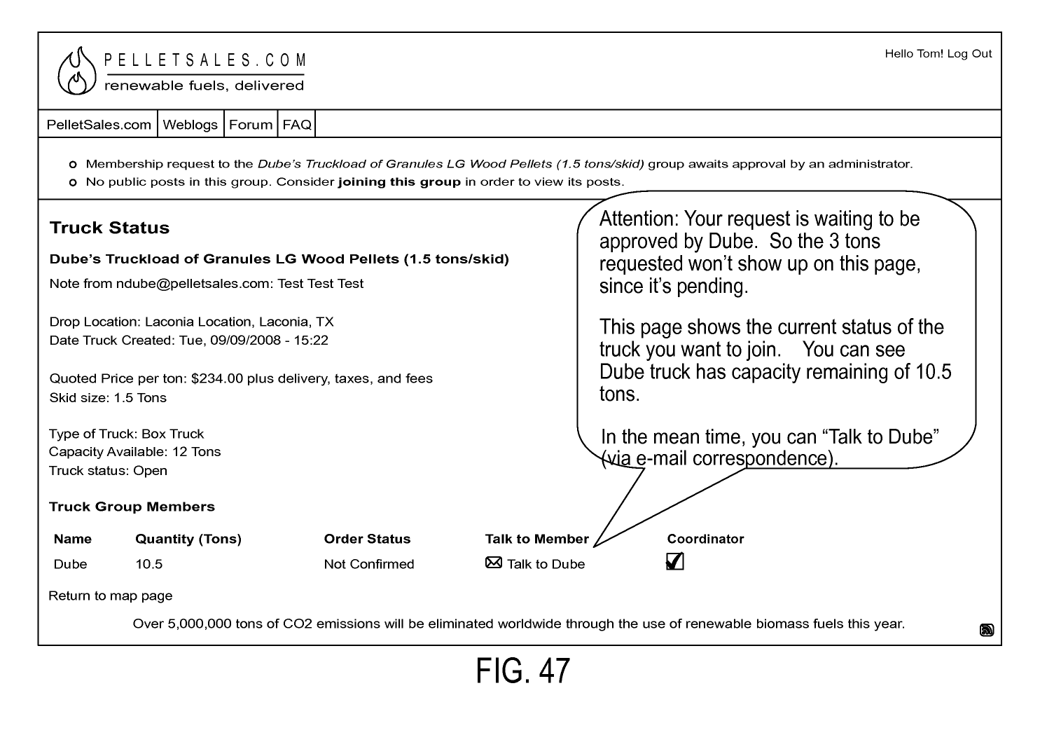

FIGS. 44 through 47 depict illustrative embodiments of screens that may be displayed to facilitate a user's joining a truckload. For example, as shown in FIG. 44, a user may be provided a list of existing truckloads and an option of joining a truckload. FIG. 45 depicts an example of a screen allowing a user to register as a pooled truckload user. FIG. 46 depicts an example of a screen allowing a user to select a desired quantity of goods that may be associated with an existing truckload. The screen may include a user-selectable option to join the existing truckload. FIG. 47 depicts an example of a truck status screen. The truck status screen may include a listing of truck group members, i.e., users who may have requested to join the truck. The listing may include an order status for each truck group member. The order status may indicate whether an order has been confirmed, i.e., whether a request to join has been approved. A user may contact, e.g., may send a message to, a truckload coordinator associated with the truck and/or the user may wait for contact by the truckload coordinator.

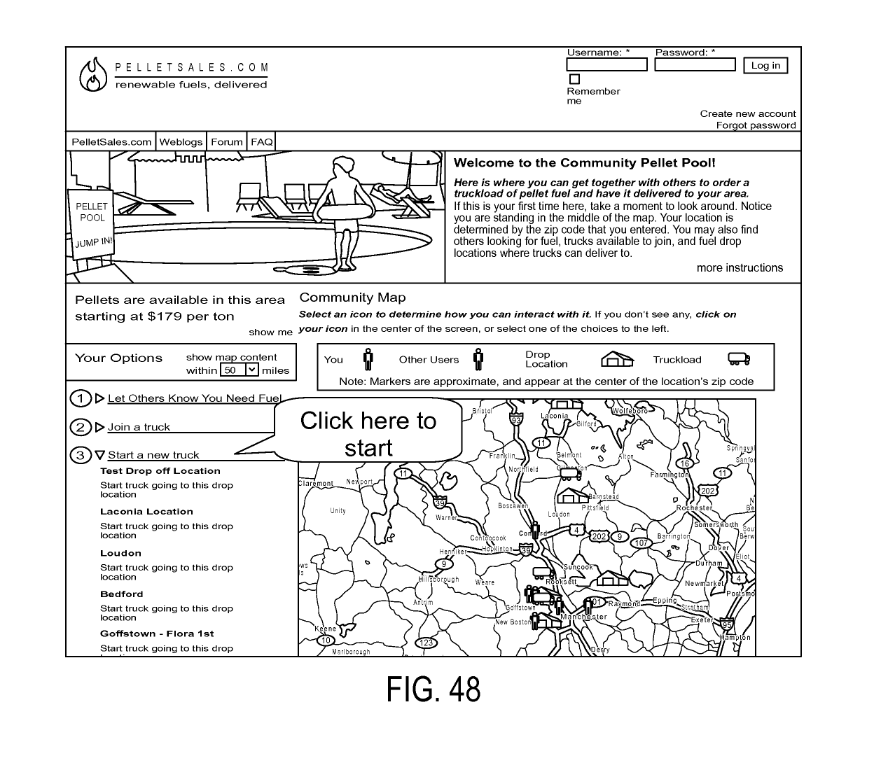

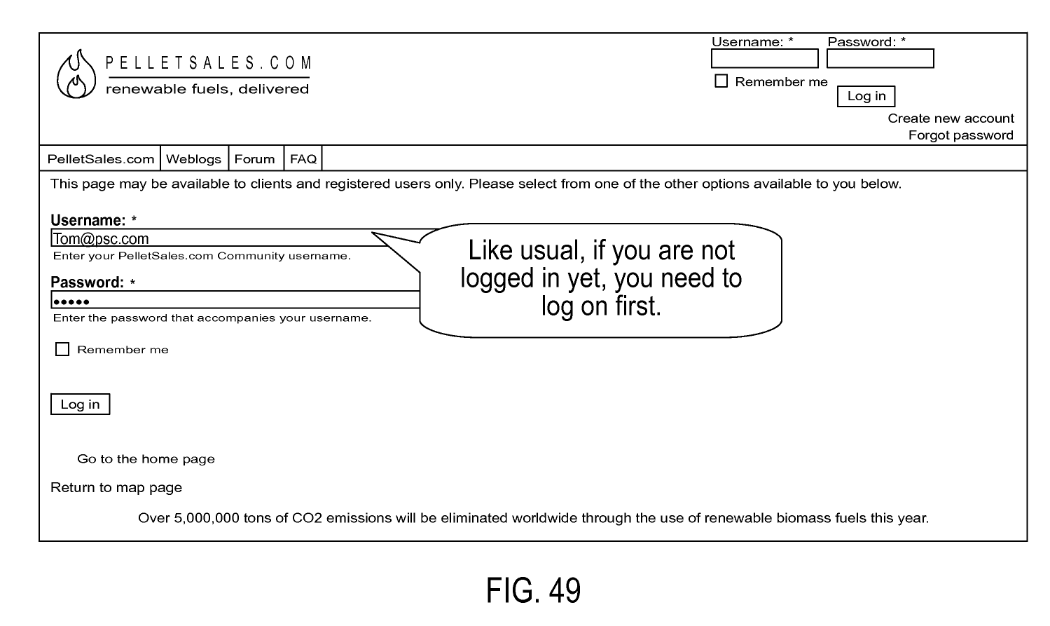

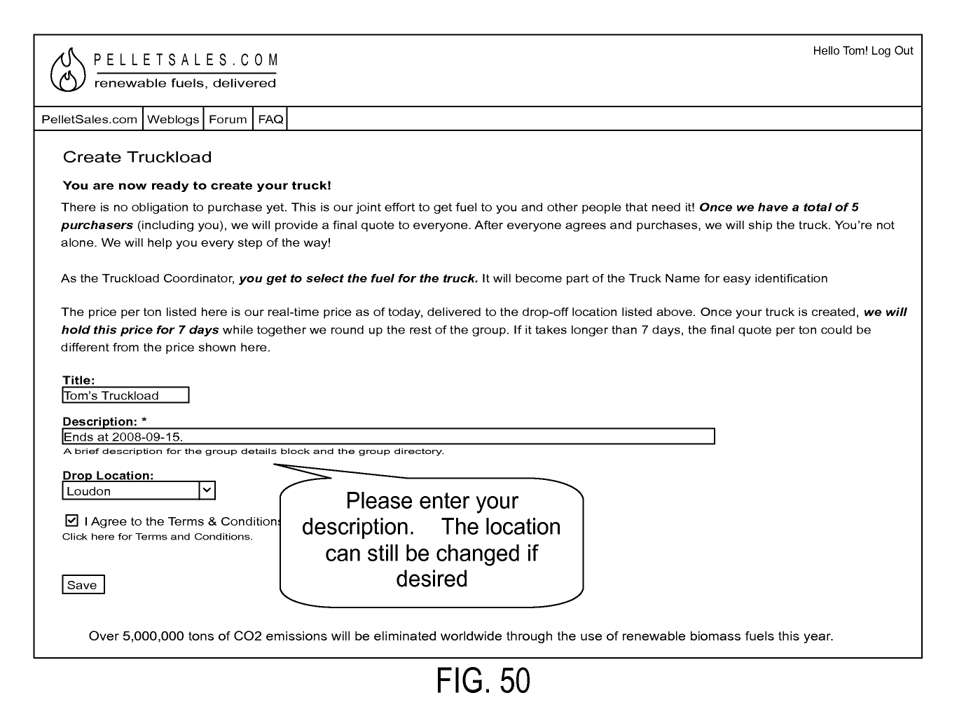

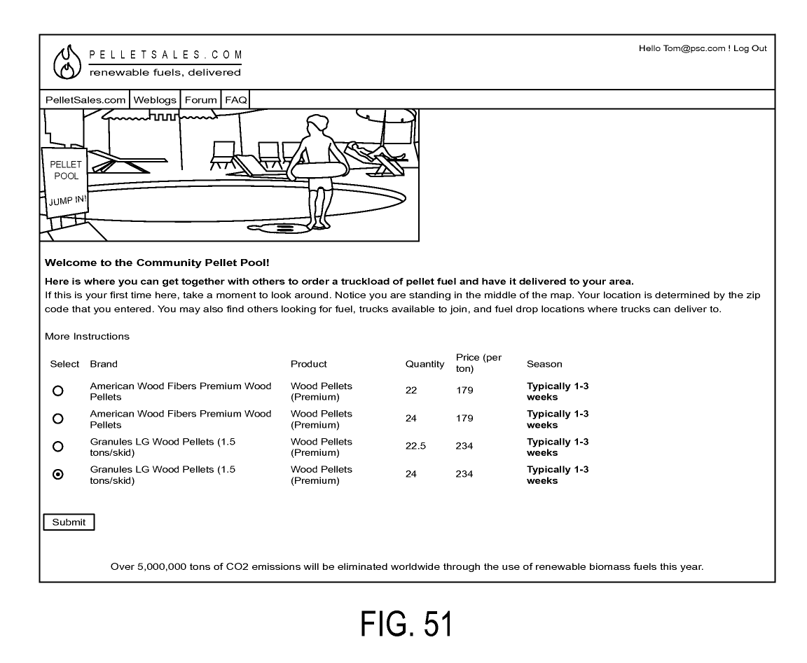

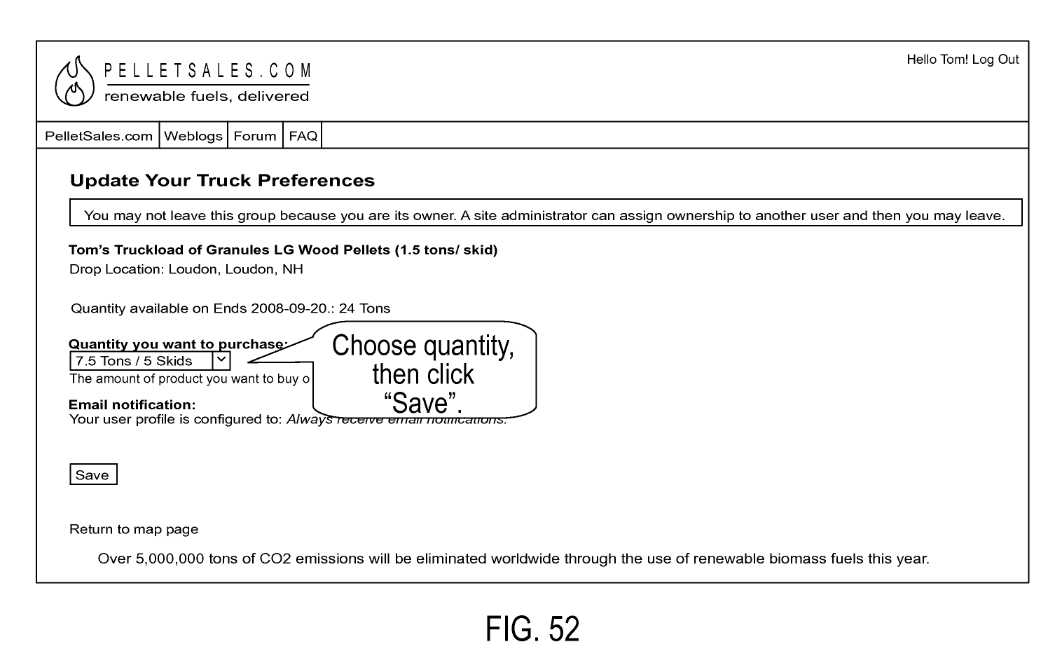

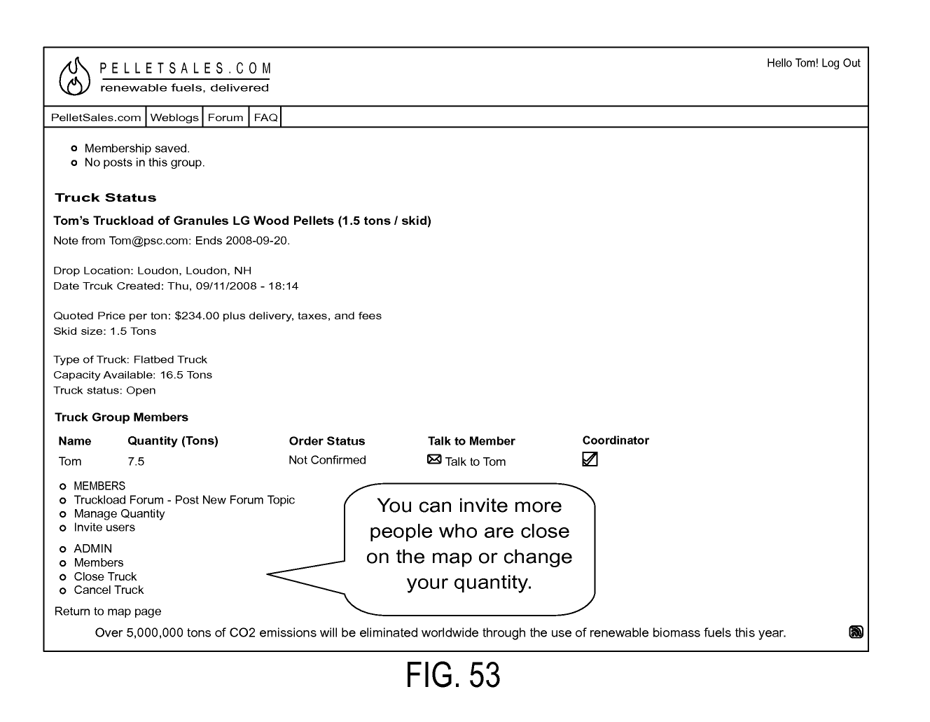

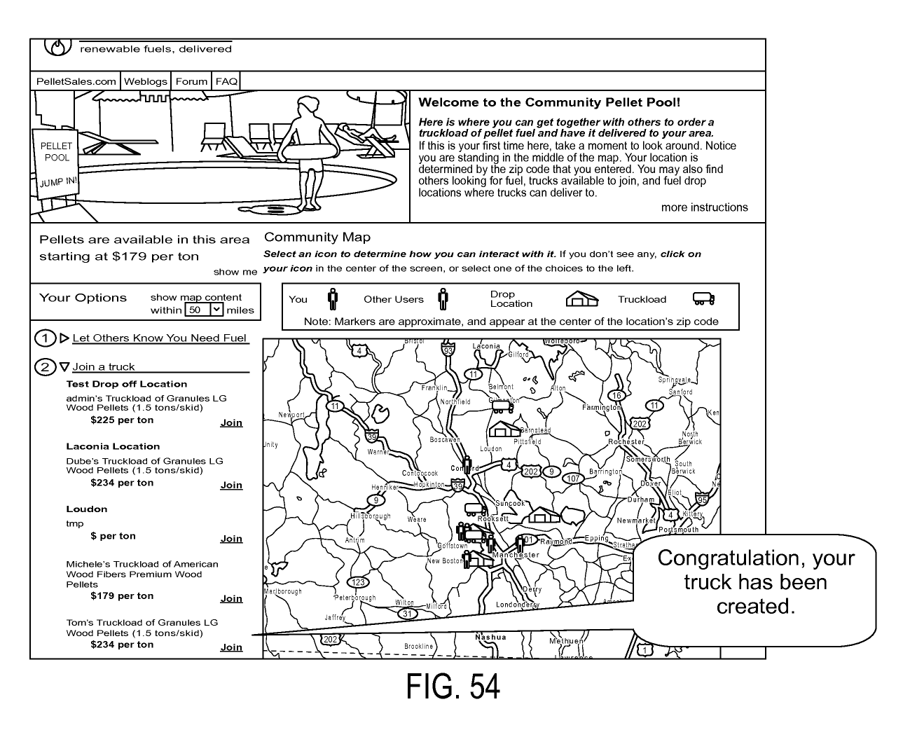

FIGS. 48 through 54 depict illustrative embodiments of screens that may be displayed to facilitate a user's starting a truckload. For example, as shown in FIG. 48, a user may be provided an option of starting a new truck. A listing, i.e., menu, of drop locations may be provided. FIG. 49 depicts an example of a screen where a user may log in, if the user is not already logged in. FIG. 50 depicts an example of a create truckload screen. At the create truckload screen, a user may enter an identifier, i.e., title, for the truckload. The user may enter a description that may be associated with the truckload. For example, the user may provide an end date associated with the truckload. The user may further choose a drop location for the truckload. FIG. 51 depicts an example of a listing of products that may be shipped on a truck. A user may select a product from this listing. The product listing may include information specific to a product such as brand, type, quantity, unit price and/or availability. FIG. 52 depicts an example of a screen allowing a user to update the user's truck preference. For example, the user may choose a quantity of product to be shipped. After a user has chosen a quantity of product, the user may then choose to save the selection. FIG. 53 depicts an example of a Truck Status screen. The truck status screen may include a listing of truck group members. A user may invite other users to join the truck and/or change a selected quantity of goods/products. A user who has successfully started a new truck may be that truck's truckload coordinator. FIG. 54 depicts an example of a map page illustrating a successful creation of a truckload. A successful truckload creation may be indicated by the title of the truckload and other data appearing in a listing of truckloads and drop locations associated with a Join a truck menu item.

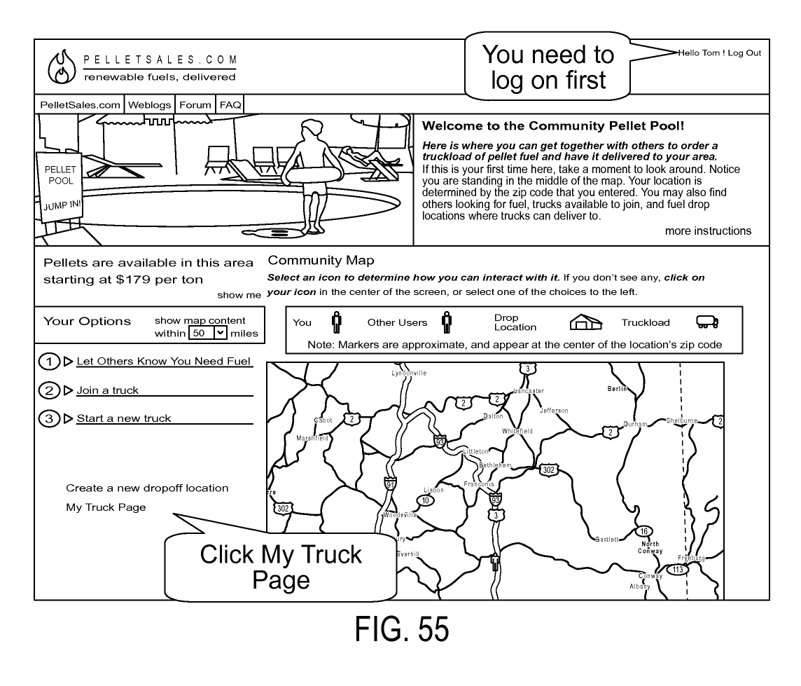

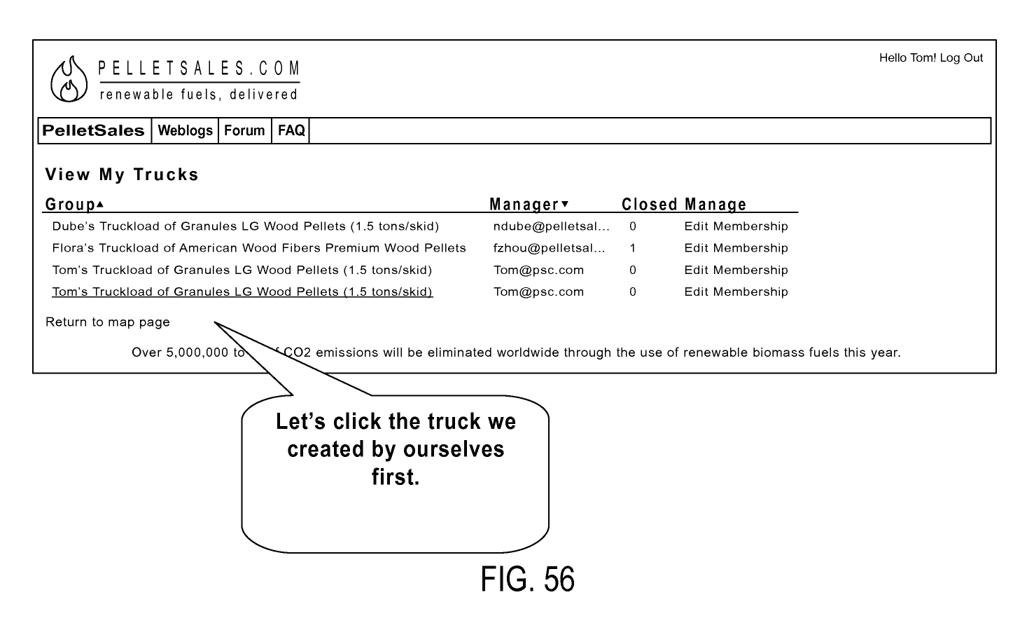

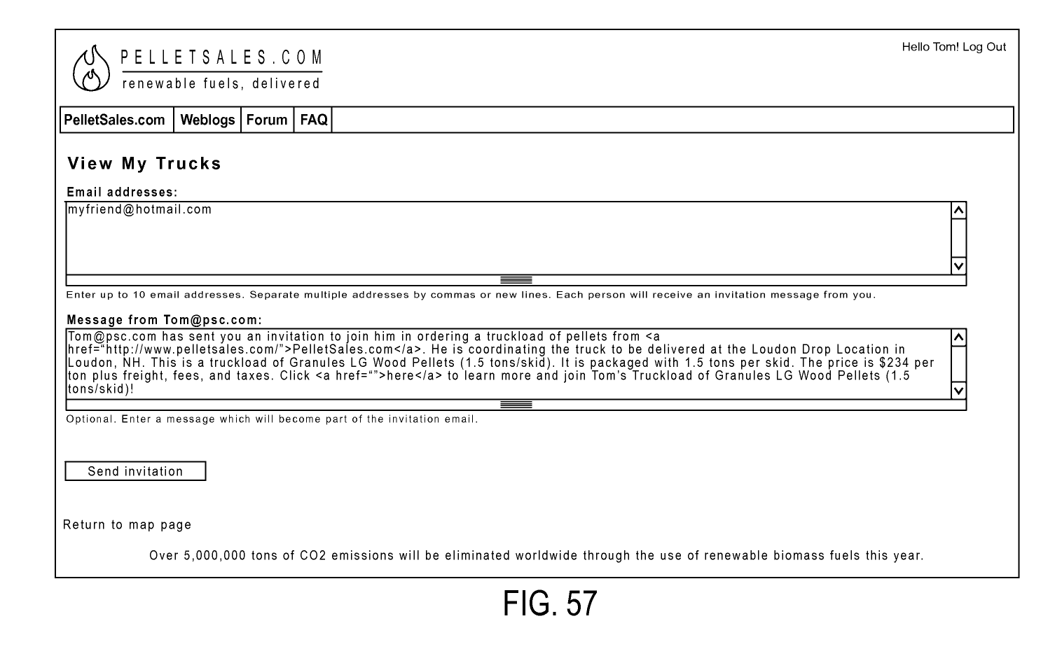

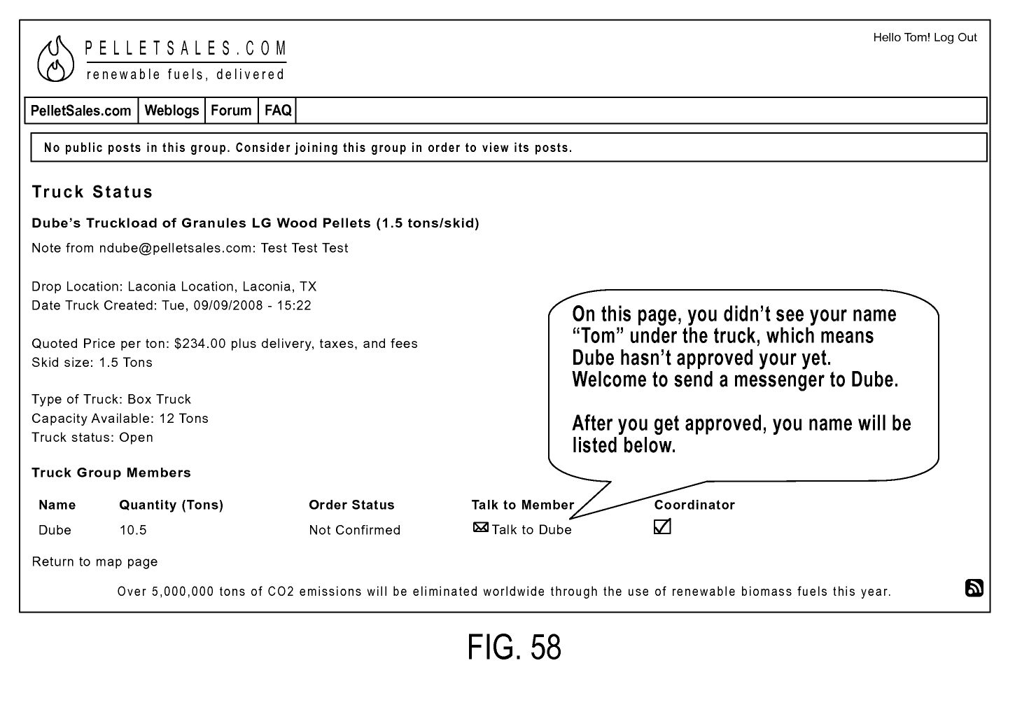

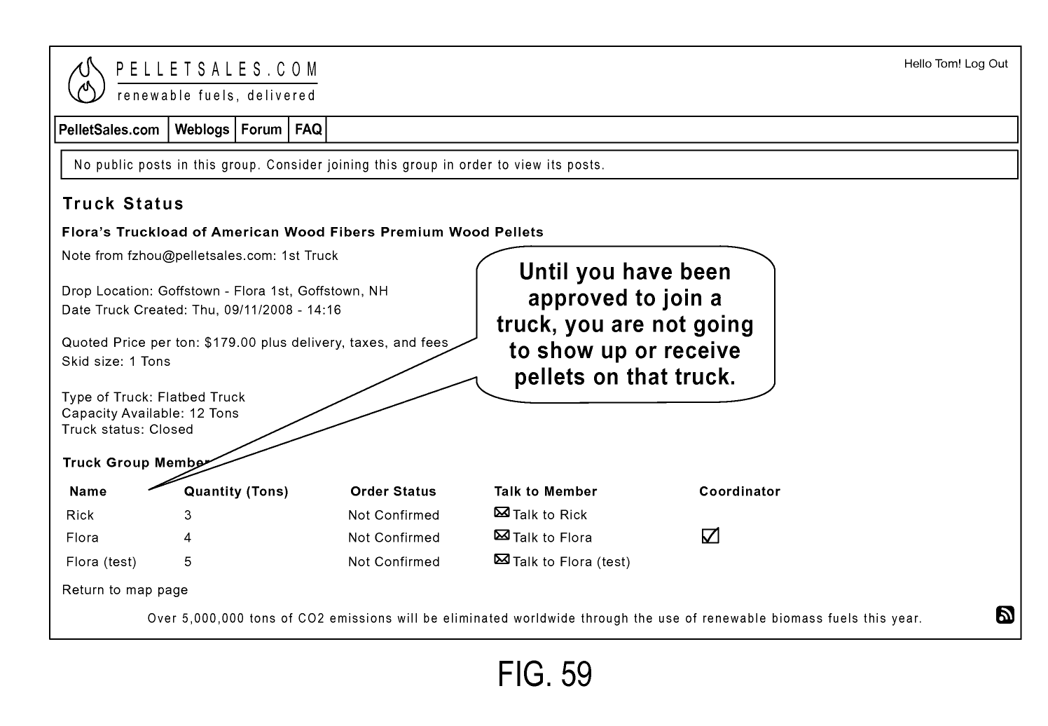

FIGS. 55 through 59 depict illustrative embodiments of screens associated with managing, i.e., coordinating, a truck. FIG. 55 depicts an example of a screen including a map and an option allowing a user to begin to manage a truck by selecting My Truck Page. In an embodiment, in order to manage a truck, a user may be logged in. FIG. 56 depicts an example of a View My Trucks screen that may allow a user to view trucks that may be associated with a group. A user may select a truck for managing. FIG. 57 depicts an example of a screen that may allow a user to enter email addresses, for example, that may receive an invitation to join a truck. The user may be provided an option of including a message with each invitation. FIG. 58 depicts an example of a Truck Status screen. The Truck Status screen may include a listing of truck group members. A user who has joined a truck may be included in this listing after approval. For example, a truckload coordinator may approve or not approve a user. A user may be provided an option of sending a message to the truckload coordinator. Other information about the truckload may be displayed on the Truck Status screen, e.g., truck title, drop location, unit price of products on the truck, type of truck and/or available capacity of the truck. FIG. 59 depicts another example of a Truck Status screen with a plurality of Truck Group Members. Only approved users may appear in the listing of truck group members. A truckload coordinator for this truck may be indicated in the Truck Group Members listing. The listing may include quantity ordered, order status and/or a link, e.g., email, to a member.

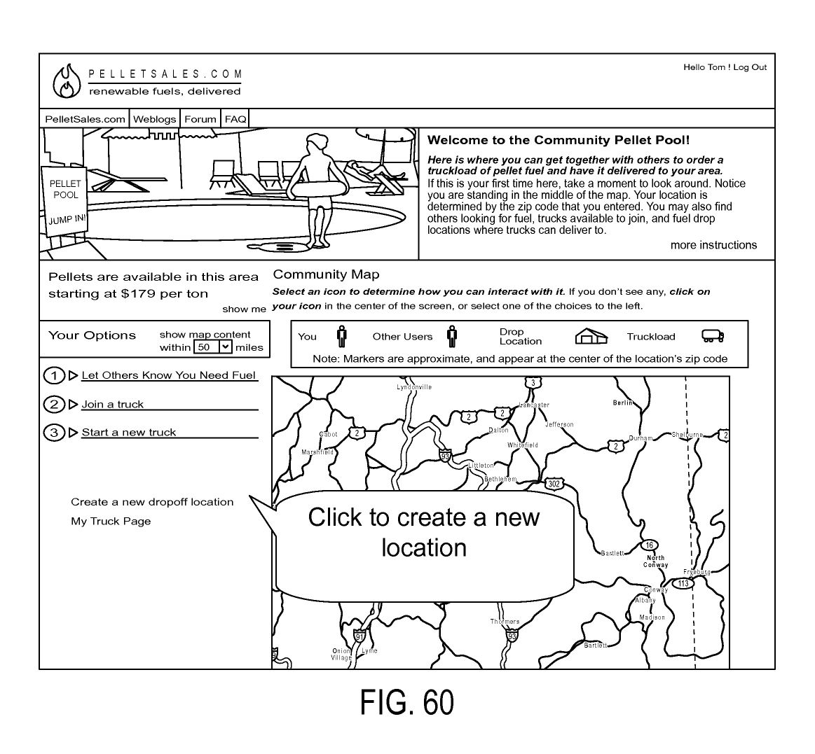

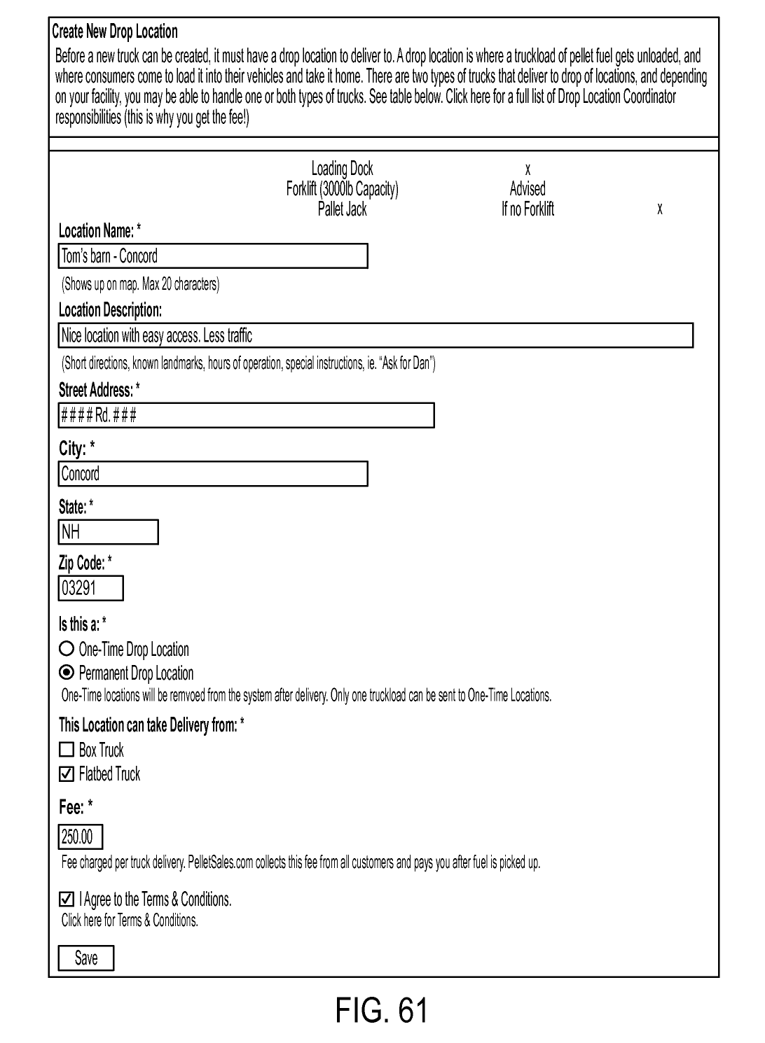

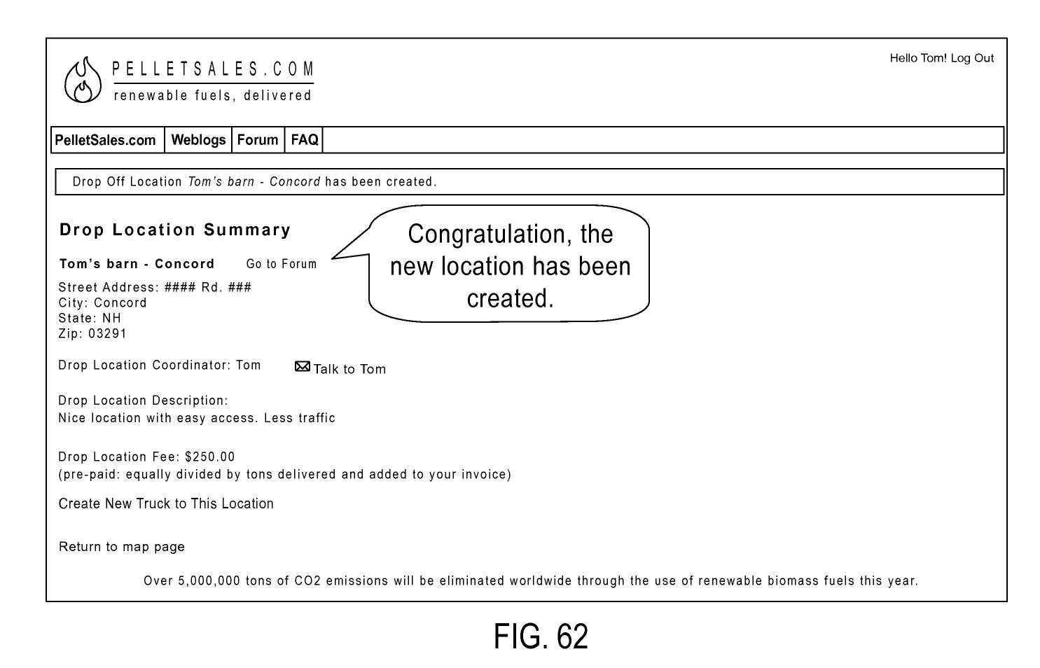

FIGS. 60 through 62 depict illustrative embodiments of screens that may be displayed to facilitate a user's establishing a new delivery, i.e., drop, location. FIG. 60 depicts an example of a map page that may provide a user a user-selectable option for creating a new drop off location. FIG. 61 depicts an example of a screen allowing a user to create a new drop location. A user may enter a location name, a location description and/or an address for the drop location. A user may provide properties of the drop location including available equipment at the drop location and/or type of truck that may deliver to the drop location. The user may select whether the drop location is a one-time drop location or permanent drop location. The user may indicate a drop fee associated with the drop location. Information associated with the drop location may be saved. A listing of drop location coordinator duties may be provided. FIG. 62 depicts an example of a drop location summary screen that may be displayed if a drop location is successfully created. This screen may include all or some of the drop location information. The Drop Location Summary screen may include an option for creating a new truck to this drop location.

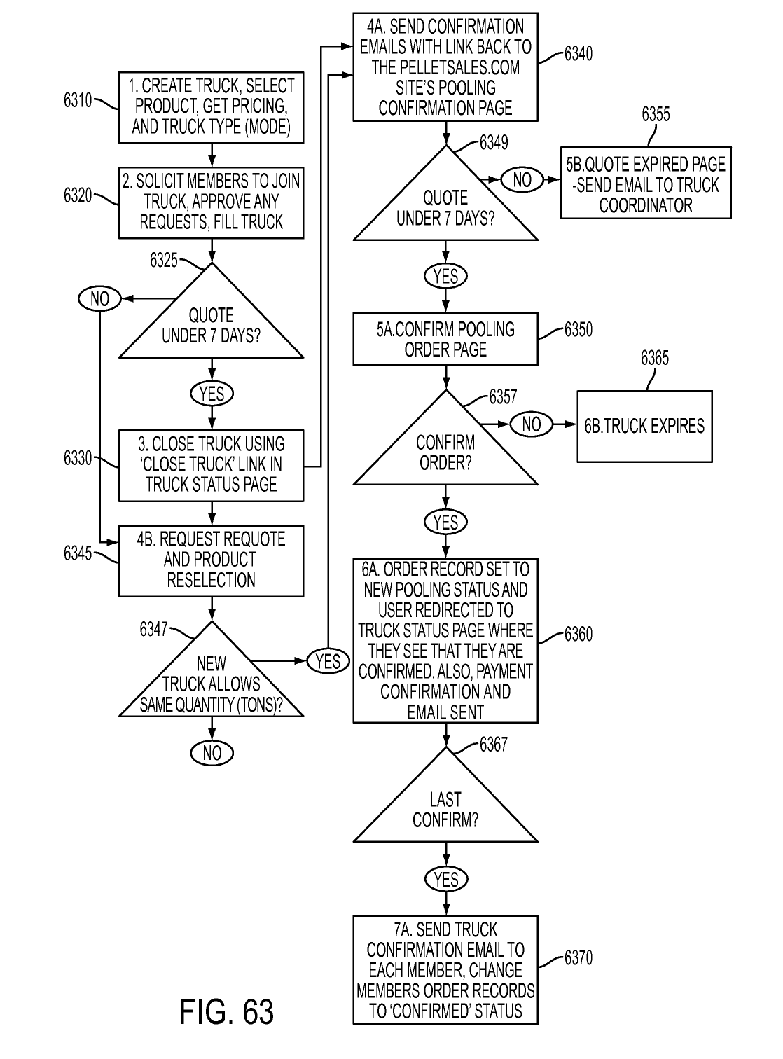

FIG. 63 is a flow chart corresponding to an exemplary embodiment consistent with the present disclosure. In the illustrated exemplary embodiment, a truck may be created, product may be selected, pricing may be requested and truck type (mode) may be determined 6310. Members may then be solicited to join the truck, requests may be approved and the truck may be filled 6320. Whether an expiration period (e.g., 7 days) has passed since a cost quote was made for that truck may then be determined 6325. If expiration period has passed (i.e., the quote is not under the number of days), a requote and a product reselection may be requested 6345. Whether a new truck may allow a quantity of product may then be determined 6347. If the new truck allows the quantity of product, a confirmation email may be sent and may include a link to a pooling confirmation page 6340.

If the expiration period has not passed (i.e., the quote is under the number of days), the truck may be closed using a Close Truck link in a truck status page 6330. A confirmation email may then be sent and may include a link to a pooling confirmation page 6340. Whether the quote is under the number of days may then be determined 6349. If the expiration period has passed, a quote expired page may be displayed and an email may be sent to a truck coordinator 6355. If the expiration period has not passed, flow may proceed to a confirm pooling order page 6350. Whether an order is confirmed may then be determined 6357. If an order is not confirmed, the truck may expire 6365. If the order is confirmed, an order record may be set to a new pooling status and a user may be redirected to a truck status page that may indicate that the user is confirmed 6360. A payment confirmation email may then be sent 6360. Whether a last confirmation occurred may be determined 6367. If the last confirmation occurred, a truck confirmation email may be sent to each member 6370. A member's order record may then be changed to confirmed status 6370.

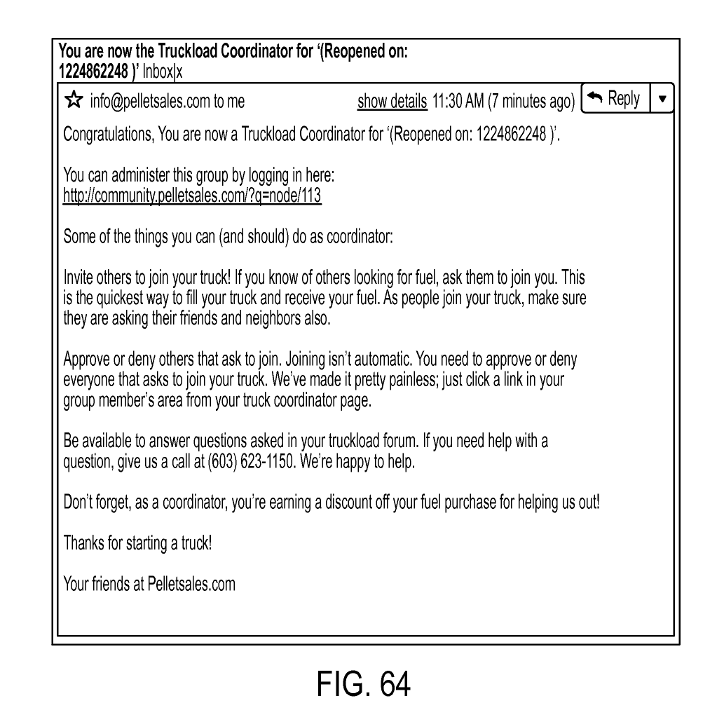

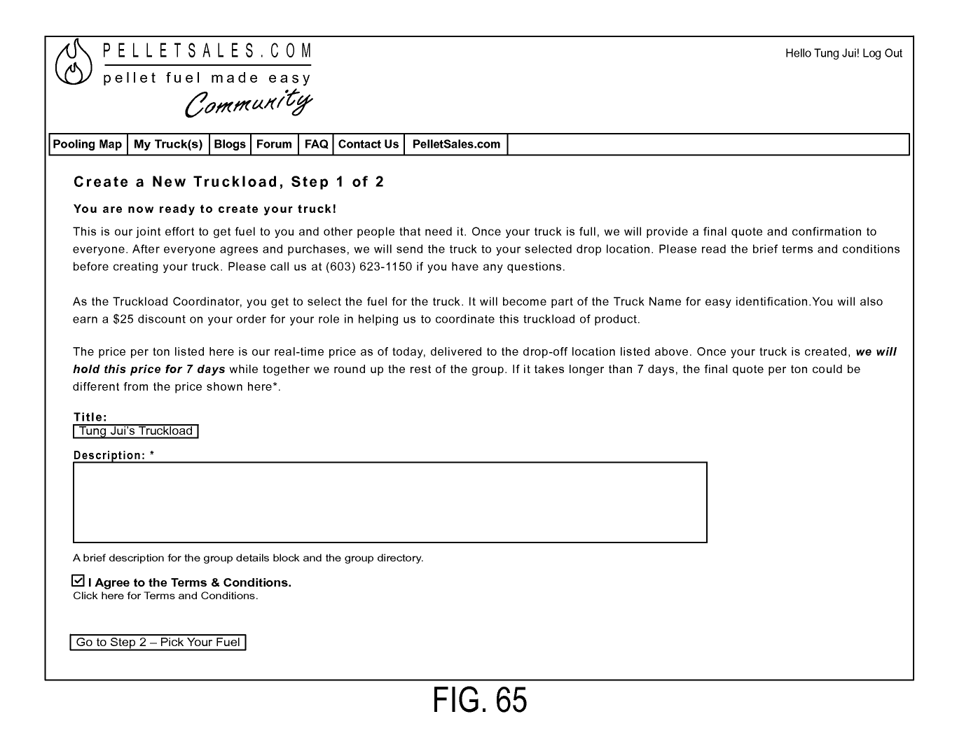

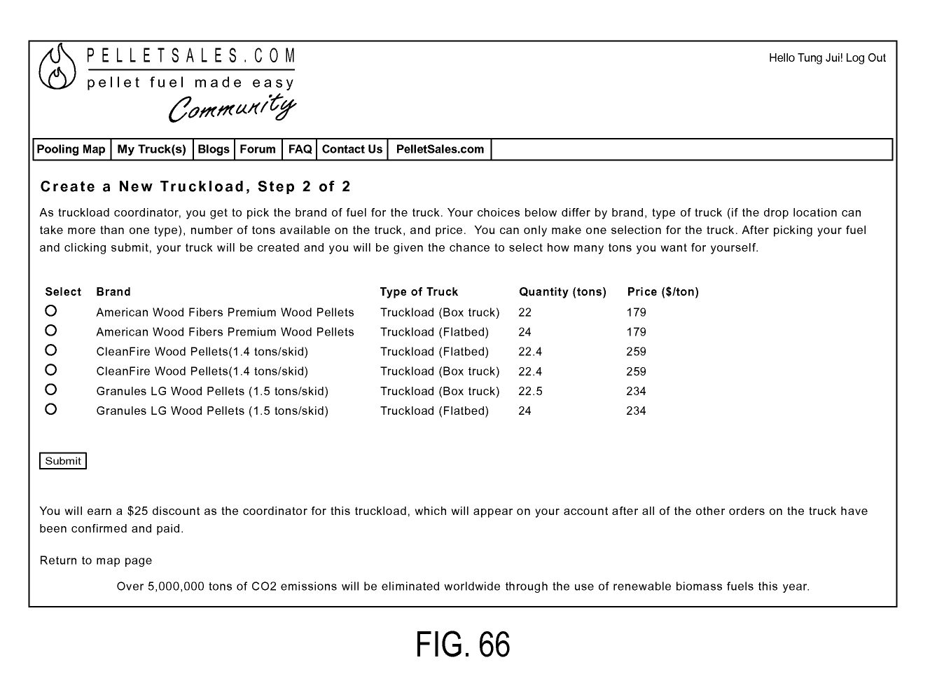

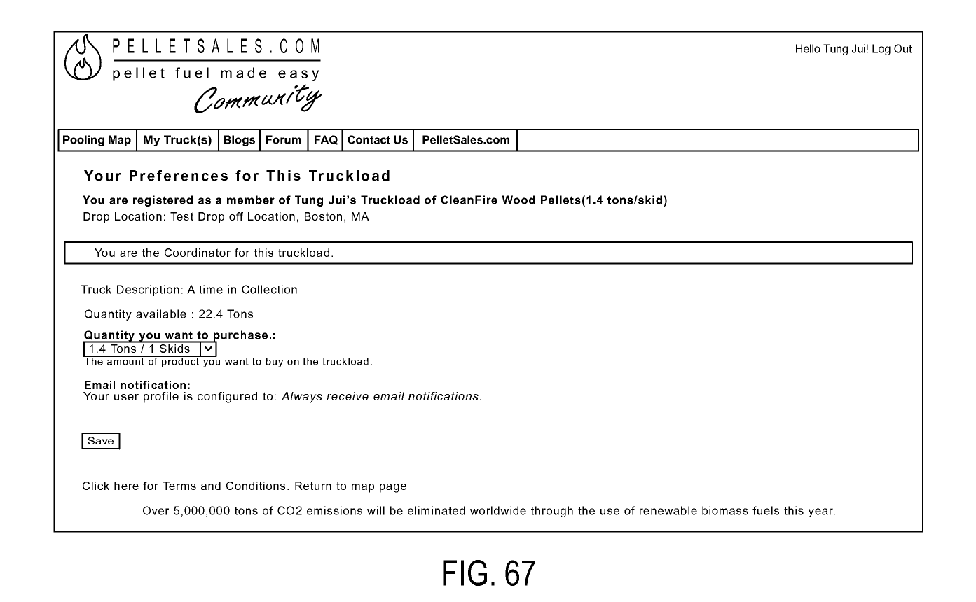

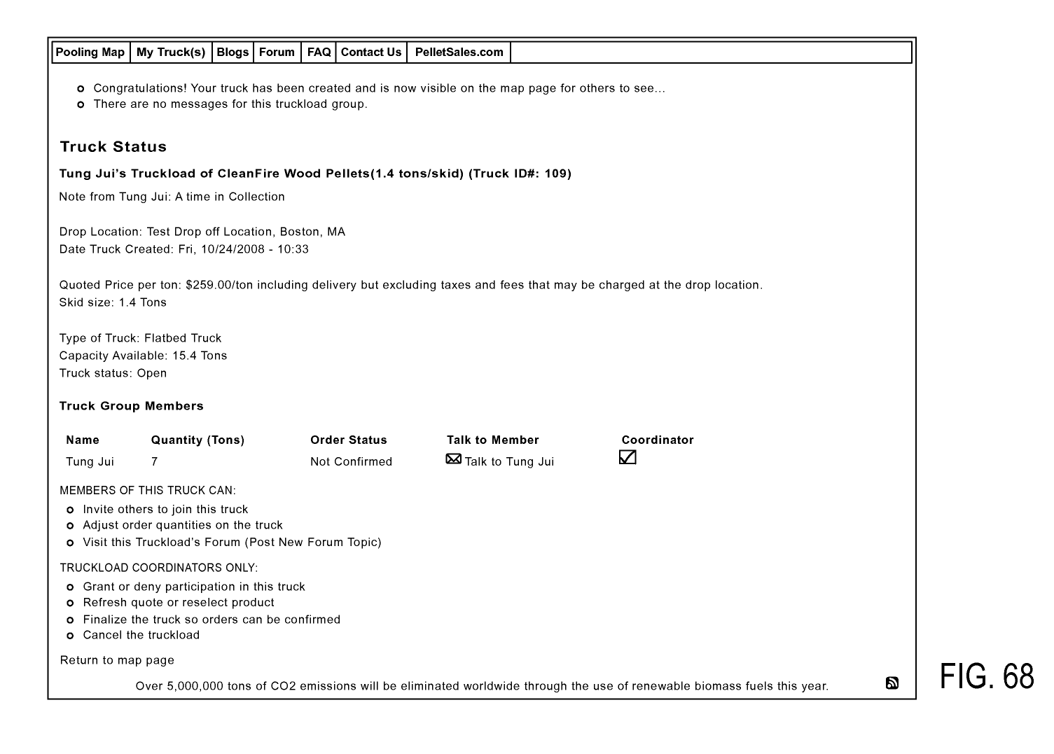

Exemplary screen shots that may be useful for facilitating flow of step 6310 are shown in FIGS. 64 through 68. For example, becoming a Truckload Coordinator may be confirmed, a truckload may be created, preferences may be selected and/or displayed and/or a truck status may be displayed. Helpful information and/or suggestions may be displayed.

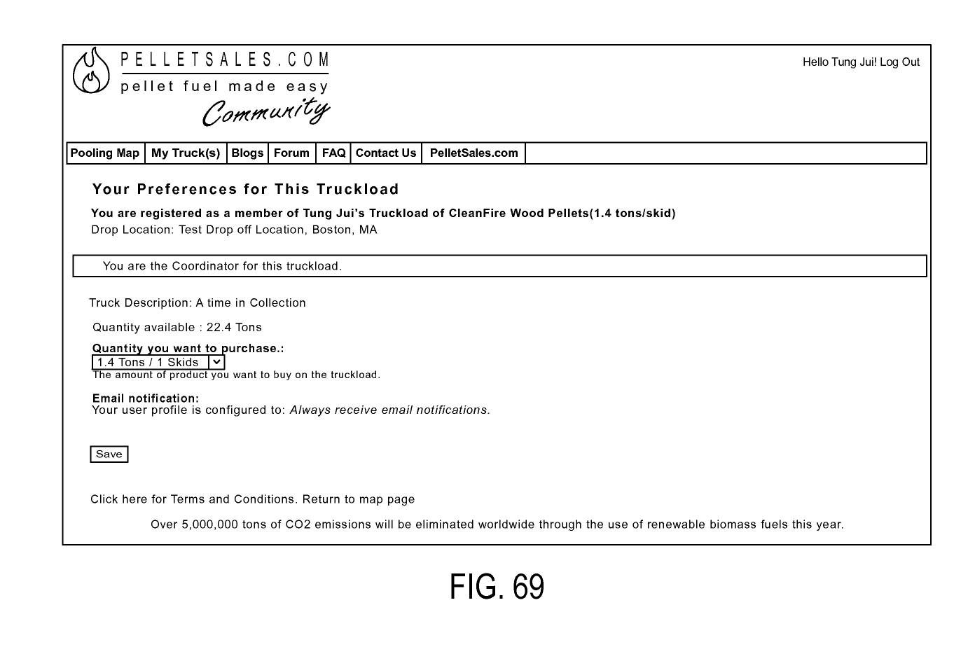

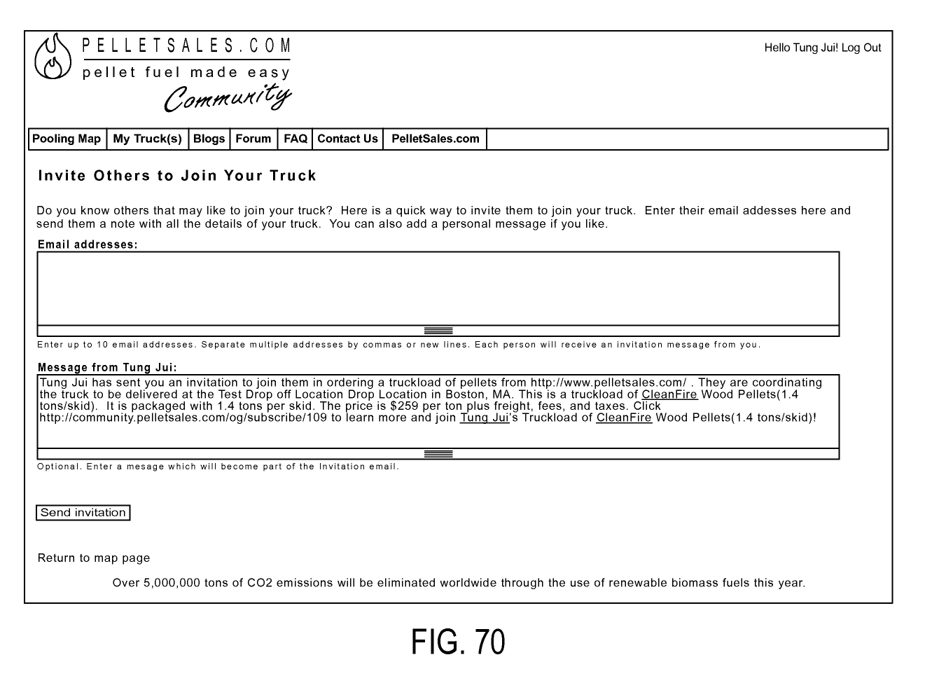

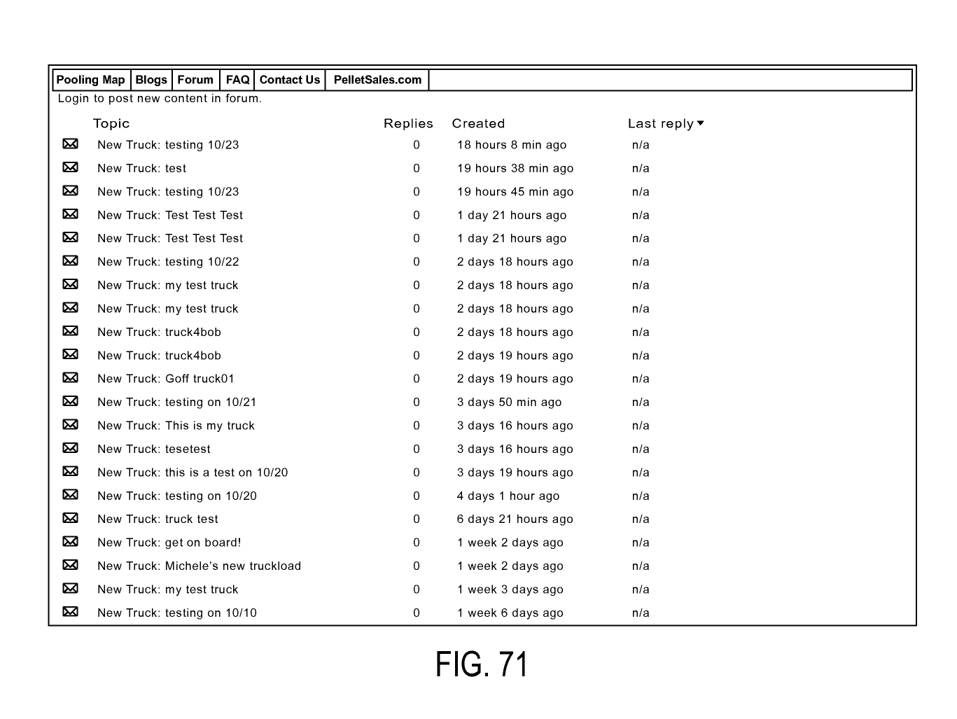

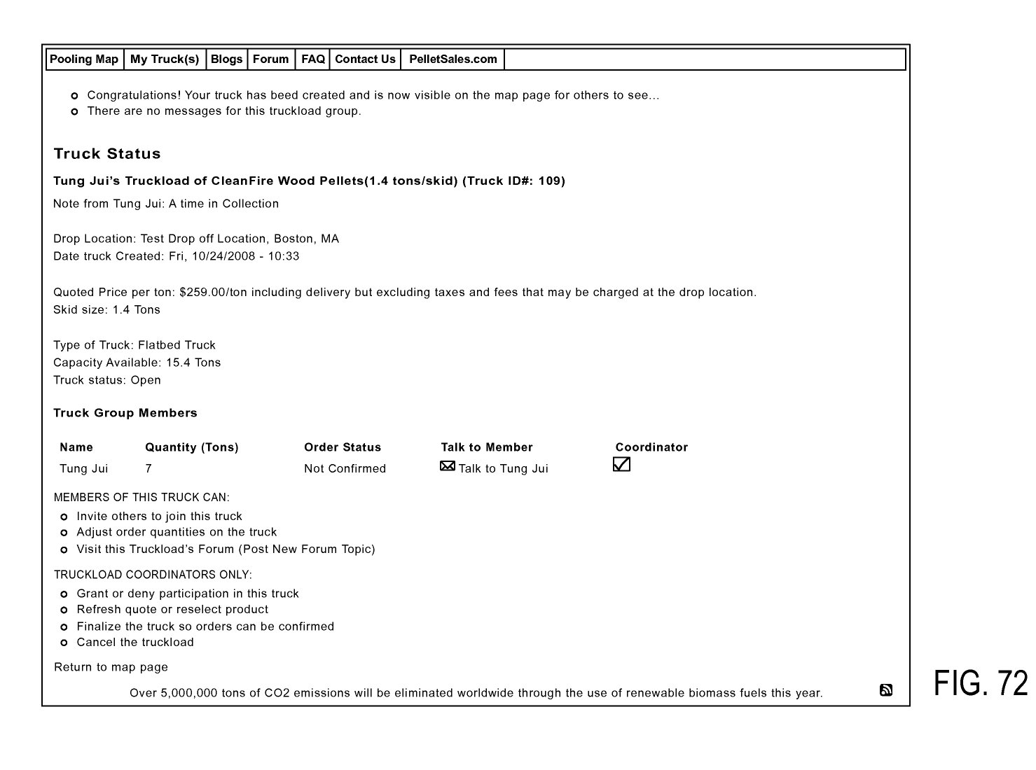

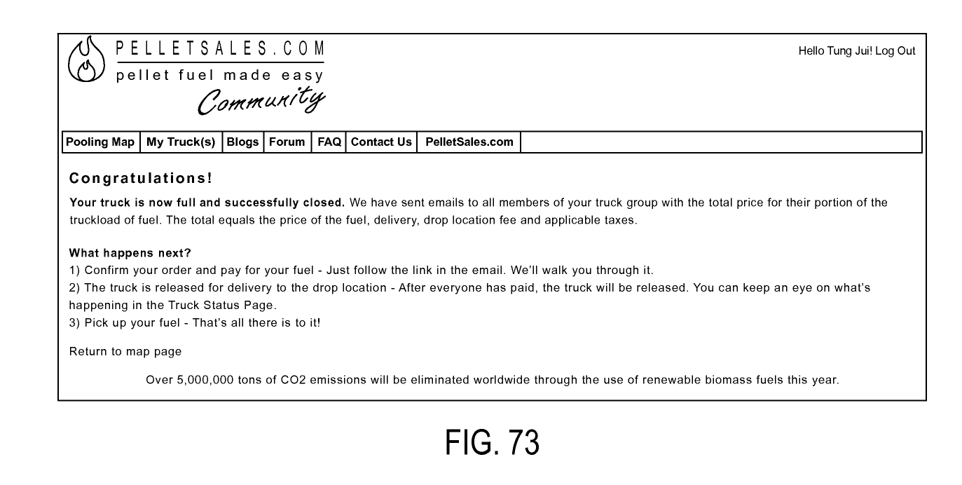

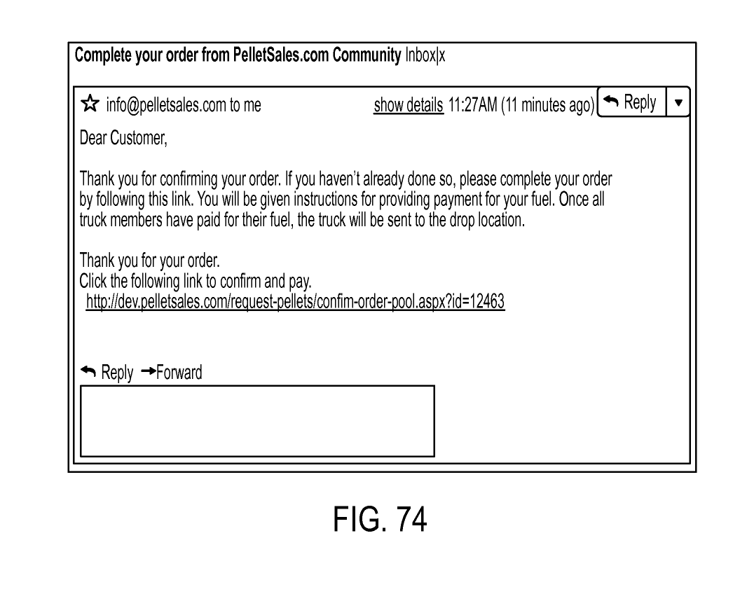

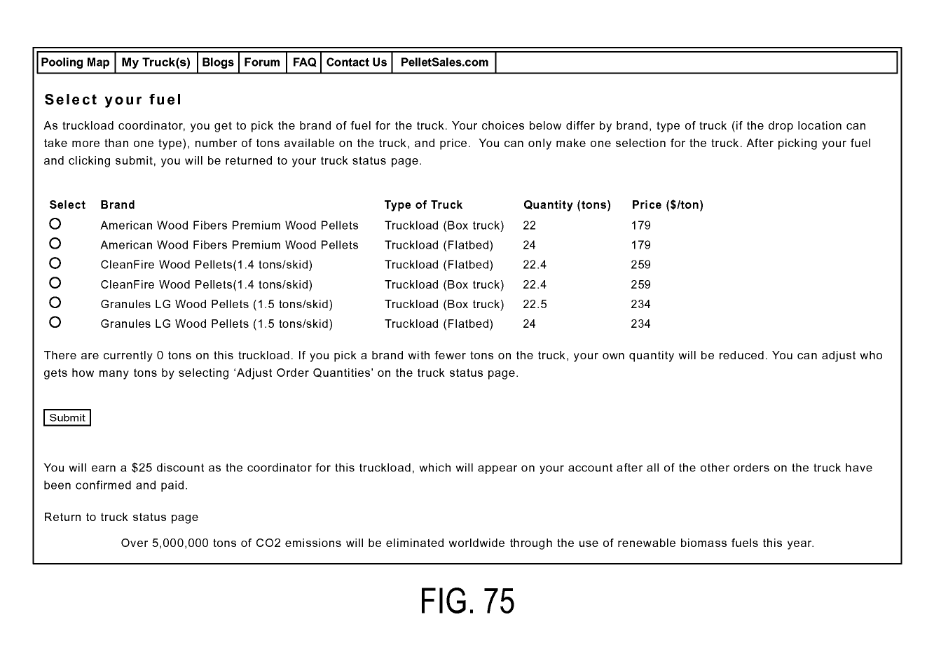

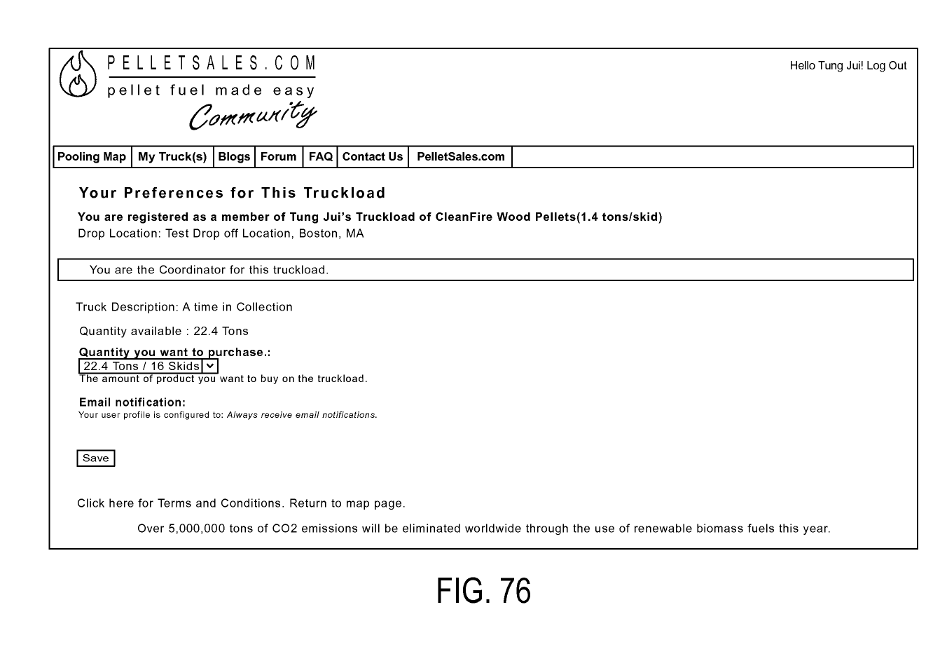

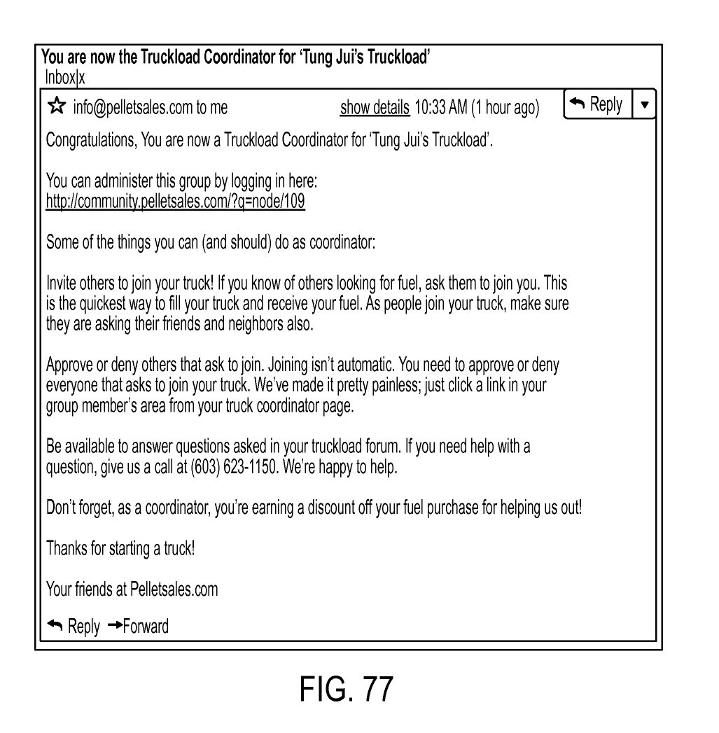

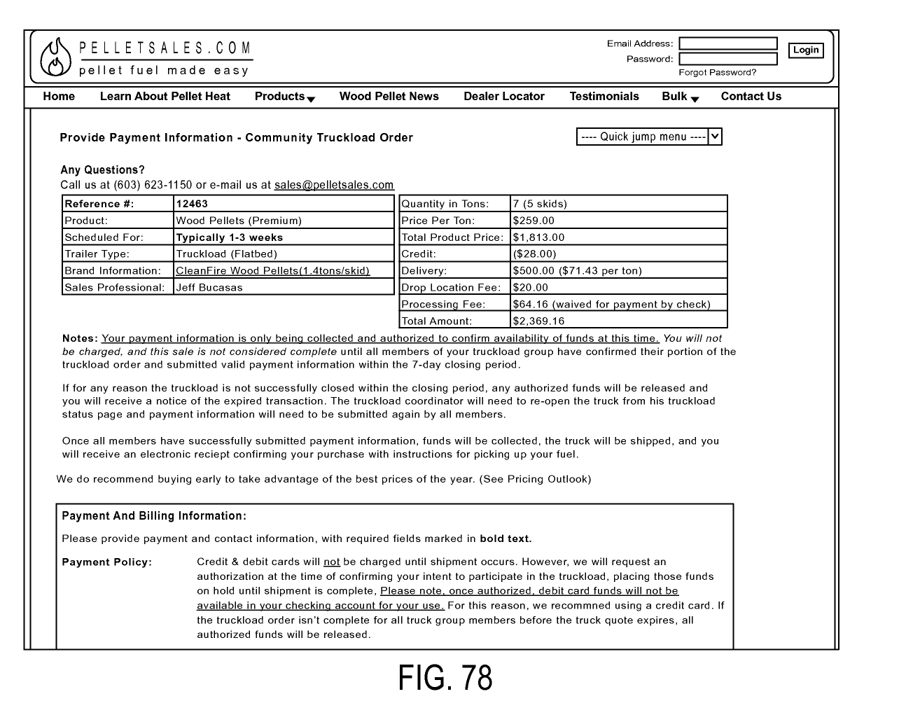

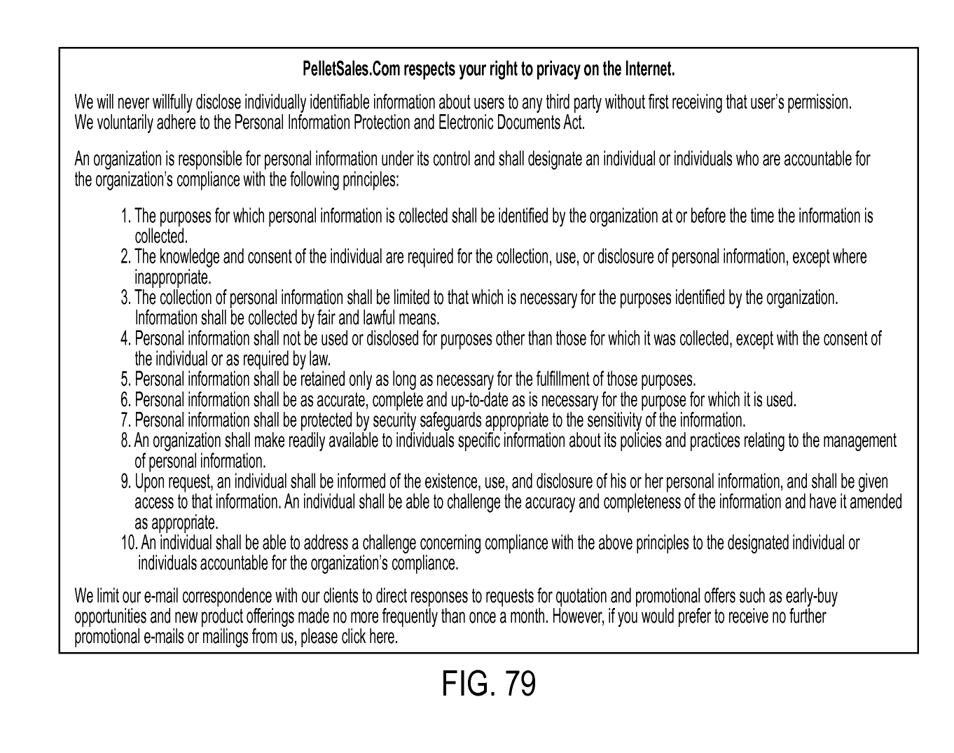

Exemplary screen shots that may be useful for facilitating flow of step 6320 are shown in FIGS. 69 through 72. For example, FIG. 71 is an exemplary screen shot showing content in a forum that may be associated with step 6320. FIG. 73 is an exemplary screen shot that may be useful for facilitating the close truck step 6330. FIG. 74 is an exemplary screen shot that may be useful for facilitating step 6340. Exemplary screen shots that may be useful for facilitating flow of the request requote and product reselection step 6345 are shown in FIGS. 75 through 77. Exemplary screen shots that may be useful in facilitating flow of the confirm pooling order step 6350 are shown in FIGS. 78 and 79.

In an embodiment, each forum may include a method for prohibiting spamming of the forum. For example, each forum may include a spam filter.

In another embodiment, a coordinator, drop location and/or distribution center may be provided an associated rating. The rating may include feedback from one or more users. Each rating may be linked to the associated coordinator, drop location and/or distribution center. Each rating may be accessible by a user for view and/or comment.

In yet another embodiment, pooling a truckload may be an iterative process. A coordinator may be selected. A drop location may be selected. The coordinator may sign on. One or more users may sign on. A user may be accepted or rejected. When a truckload is complete, a confirmation request may be provided to each accepted user. Each accepted user may confirm. When all accepted users have confirmed or after a time period, a payment request may be made to each confirmed user. When all confirming users have made payment, the truckload may be dispatched.

In another embodiment, all emails may be BCC'd to a System administrator logging ID.

In an embodiment, a truckload pooling system may interface with an application service provider, as discussed above. Costs of goods and/or services may be updated dynamically. Delivery costs, including drop location fees, may be updated dynamically and may be based on the goods, quantities of goods, suppliers of the goods and the drop location. In this way, real time quotes including costs of goods and delivery may be provided.

In another embodiment, a process for qualifying drop locations may be provided. Factors may include equipment available at the drop location, accessibility and ease of truck movement at the location.

Embodiments of the methods described above may be implemented as software or a computer program product for use with a processing system or computer. Such implementation may include, without limitation, a series of computer instructions that embody all or part of the functionality described herein. The series of computer instructions may be stored in any machine-readable medium, such as semiconductor, magnetic, optical or other memory devices, and may be transmitted using any communications technology, such as optical, infrared, microwave, or other transmission technologies. Such a computer program product may be distributed as a removable machine-readable medium (e.g., a diskette, CD-ROM), preloaded with a computer system (e.g., on system ROM or fixed disk), or distributed from a server or electronic bulletin board over the network (e.g., the Internet or World Wide Web). Alternative embodiments of the invention may be implemented as pre-programmed hardware elements or as a combination of hardware, software and/or firmware.

According to one aspect of the disclosure, a computerized method is provided for aggregating delivery of goods or services. The method comprises: providing access to an aggregate delivery coordination system on a computer network; receiving user inputs to the aggregate delivery coordination system from a plurality of users, wherein at least some of the user inputs represent interest in participating in pooling activities for aggregating delivery of the goods or services; presenting pooling activity information, using the aggregate delivery coordination system, to at least some of the users in response to the user inputs representing the notification of interest in participation in pooling activities; coordinating pooling activities between respective groups of the users to establish pooling activity delivery options aggregating delivery of goods or services for the respective groups of the users, the delivery options including a specified good or service, cost and at least one delivery location; and notifying the groups of the users of completed pooling activities and the delivery options established for the completed pooling activities.

According to other aspects of the disclosure, a computer program product and computerized system are provided for performing the operations of the method for aggregating delivery of goods or services.

While the principles of the invention have been described herein, it is to be understood by those skilled in the art that this description is made only by way of example and not as a limitation as to the scope of the invention. The features and aspects described with reference to particular embodiments disclosed herein are susceptible to combination and/or application with various other embodiments described herein. Such combinations and/or applications of such described features and aspects to such other embodiments are contemplated herein. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A computerized method for aggregating delivery of goods or services, said method comprising:
providing access to an aggregate delivery coordination system on a computer network;
receiving user inputs to said aggregate delivery coordination system from a plurality of users, wherein at least some of said user inputs represent interest in participating in pooling activities for aggregating delivery of said goods or services;
presenting pooling activity information, using said aggregate delivery coordination system, to at least some of said users in response to said user inputs representing the notification of interest in participation in pooling activities;
coordinating pooling activities between respective groups of said users to establish pooling activity delivery options aggregating delivery of goods or services for said respective groups of said users, said delivery options including a specified good or service, cost and at least one delivery location; and
notifying said groups of said users of completed pooling activities and said delivery options established for said completed pooling activities.

2. A method according to claim 1, wherein said user inputs include requests to join an existing pooling activity or start a new pooling activity.

3. A method according to claim 1, wherein presenting pooling activity information comprises:
providing a list of one or more existing pooling activities; and
providing a list of goods or services associated with each of the one or more existing pooling activities and a cost and available quantity of said goods or service.

4. A method according to claim 3, wherein said user inputs include a request from at least one of said users to join one of said existing pooling activities, said request including a quantity of said goods or services to be delivered for said at least one of said users.

5. A method according to claim 4, wherein coordinating said pooling activities comprises:
presenting said request to join said one of said existing pooling activities to one of said users designated as a pooling activity coordinator responsible for coordinating said one of said existing pooling activities;
receiving a decision from said pooling activity coordinator; and
communicating said decision to said at least one of said users providing said request to join.

6. A method according to claim 5, wherein coordinating said pooling activities further comprises:
receiving a request from said pooling activity coordinator to complete said one of said existing pooling activities.

7. A method according to claim 1, wherein presenting pooling activity information comprises:
providing a list of one or more delivery locations; and
providing a list of goods or services available for delivery and a cost of said goods or services.

8. A method according to claim 7, wherein said user inputs include a request from at least one of said users to start a new pooling activity, said request including a total quantity of said goods or services to be delivered at one of said delivery locations.

9. A method according to claim 8, wherein coordinating said pooling activities further comprises:
adding said new pooling activity to a list of existing pooling activities.

10. A method according to claim 1, wherein said user inputs include at least one request for creating a new delivery location, said request including a name corresponding to said new delivery location, a description corresponding to said new delivery location, and at least one delivery location property associated with said new delivery location.

11. A method according to claim 10 wherein said at least one delivery location property comprises equipment available, a type of delivery vehicle or a drop fee.

12. A method according to claim 1, wherein coordinating said pooling activities further comprises:
designating at least one of said users as a pooling activity coordinator responsible for coordinating at least one of said pooling activities; and
receiving a request from said pooling activity coordinator to complete said one of said pooling activities.

13. A method according to claim 12, wherein coordinating said pooling activities further comprises:
requesting confirmation from a group of users joined to said one of said pooling activities, and wherein, in response to receiving confirmation from each user in said group of users, said group of users is notified of said completed pooling activity and said delivery option established for said completed pooling activity.

14. A method according to claim 12, wherein coordinating said pooling activities further comprises:
determining if an expiration period has passed since a cost quote was made for said one of said pooling activities; and
if said expiration period has passed, notifying said group of users of an expiration of said cost quote and requesting a re-quote.

15. A method according to claim 1, wherein at least some of said user inputs include registration information from said users.

16. A method according to claim 15, wherein said registration information comprises name, screen name, password, email address, or geographic location signifier.

17. A method according to claim 1 further comprising:
requesting ratings associated with pooling activities from users participating in said pooling activities, wherein presenting said pooling activity information includes presenting said ratings.

18. A method according to claim 17, wherein said ratings comprise a rating of a delivery location or a pooling activity coordinator.

19. A method according to claim 1 further comprising providing a forum for communication between a plurality of users.

20. A method according to claim 1, wherein said goods or services comprise a biomass fuel, and wherein said pooling activities include arranging truckloads of said biomass fuel for delivery.

21. A computer-readable medium whose contents, when executed by a computer system, cause the computer system to perform the operations comprising:
receiving user inputs from a plurality of users, wherein at least some of said user inputs represent interest in participating in pooling activities for aggregating delivery of said goods or services;
presenting pooling activity information to at least some of said users in response to said user inputs representing the notification of interest in participation in pooling activities;
coordinating pooling activities between respective groups of said users to establish pooling activity delivery options aggregating delivery of goods or services for said respective groups of said users, said delivery options including a specified good or service, cost and at least one delivery location; and
notifying said groups of said users of completed pooling activities and said delivery options established for said completed pooling activities.

22. A computerized system for aggregating delivery of goods or services, comprising:
an aggregate delivery coordination system accessible on a computer network, said aggregate delivery coordination system being configured to:
receive user inputs to said aggregate delivery coordination system from a plurality of users, wherein at least some of said user inputs represent notification of interest in participating in pooling activities for aggregating delivery of said goods or services;
present pooling activity information, using said aggregate delivery coordination system, to at least some of said users in response to said user inputs representing the notification of interest in participation in pooling activities;
coordinate pooling activities between respective groups of said users to establish pooling activity delivery options aggregating delivery of goods or services for said respective groups of said users, said delivery options including a specified good or service, cost and at least one delivery location; and
notify said groups of said users of completed pooling activities and said delivery options established for said completed pooling activities.
